(19) United States
(12) Patent Application Publication
(10) Pub. No.: US 2026/0127207 A1
(43) Pub. Date: May 7, 2026

(54) TECHNIQUES FOR DISCOVERING PROCESSES USING NATURAL LANGUAGE INPUT

(71) Applicant: Soroco India Private Limited, Bengaluru (IN)

(72) Inventors: George Peter Nychis, Somerville, MA (US); Rohan Narayana Murty, London (GB); Kevin Segundo Bello Medina, Arlington, MA (US)

(21) Appl. No.: 19/379,172

(22) Filed: Nov. 4, 2025

Related U.S. Application Data
(60) Provisional application No. 63/716,163, filed on Nov. 4, 2024.
(60) Provisional application No. 63/782,478, filed on Apr. 2, 2025.

(51) Int. Cl. G06F 16/334; G06F 40/279; G06F 40/30

(52) U.S. Cl. CPC G06F 16/3347; G06F 40/279; G06F 40/30

(57) ABSTRACT

Techniques for using natural language to identify instances of a process in multiple streams of event data, each particular stream of event data, from among the multiple streams, corresponding to a series of interactions between one or more application programs executing on particular computing device and a particular user performing the process using the one or more application programs, the method comprising: receiving natural language input describing the process; generating a process representation at least in part by using a language model to process the natural language input; identifying, using the process representation and from among the multiple streams of event data, multiple candidate instances of the process; selecting, based on user input, at least one of the multiple candidate instances; and (E) storing the selected at least one candidate instance as at least one confirmed instance of the process.

### RELATED APPLICATIONS

This application claims the benefit of U.S. Provisional Patent Application Ser. No. 63/716,163, filed Nov. 4, 2024, titled “DISCOVERY TECHNIQUES, SEGMENTATION, AND COLLABORATION FROM INTERACTION DATA,” and of U.S. Provisional Patent Application Ser. No. 63/782,478, filed Apr. 2, 2025, titled “ASSISTING PROCESS DISCOVERY WITH ENCODER AND DECODER MODELS,” each of which is incorporated by reference herein in its entirety.

### BACKGROUND

Employees at many companies spend much of their time working on computers. An employer may monitor an employee's computer activity by installing a monitoring application program on the employee's work computer to monitor the employee's actions. For example, an employer may install a keystroke logger application on the employee's work computer. The keystroke logger application may be used to capture the employee's keystrokes and store the captured keystrokes in a text file for subsequent analysis.

### SUMMARY

Some embodiments provide for a method of using natural language to identify instances of a process in multiple streams of event data, each particular stream of event data, from among the multiple streams, corresponding to a series of interactions between one or more application programs executing on particular computing device and a particular user performing the process using the one or more application programs, the method comprising using at least one computer hardware processor to perform: (A) receiving natural language input describing the process; (B) generating a process representation at least in part by using a language model to process the natural language input; (C) identifying, using the process representation and from among the multiple streams of event data, multiple candidate instances of the process; (D) selecting, based on user input, at least one of the multiple candidate instances; and (E) storing the selected at least one candidate instance as at least one confirmed instance of the process.

In some embodiments, receiving the natural language input comprises receiving the natural language input from a user via a graphical user interface.

In some embodiments, the natural language input describes the process in part by identifying one or more application programs used to perform the process and one or more activities performed using the one or more applications programs in furtherance of the process.

In some embodiments, the process representation is an activity-level process representation.

In some embodiments, the process representation indicates a set of activities and relationships among activities in the set of activities, the relationships indicating an order in which at least some of the activities in the activities are to be performed as part of the process.

In some embodiments, the process representation, further indicates, for each particular activity in the set of activities: an identifier, a natural language description of the activity, and a set of one or more application programs used to perform the activity.

In some embodiments, the method further comprises: generating a workflow graph visualization of the process representation, the workflow graph visualization comprising a graph with nodes representing activities in the set of activities and edges representing the relationships among the activities in the set of activities; and displaying the workflow graph visualization of the process representation in a graphical user interface (GUI).

In some embodiments, the GUI comprises a chatbot interface, the method further comprising: receiving, via the chatbot interface, further natural language input from the user indicating one or more modifications to make to the process representation; modifying the process representation in accordance with the further natural language input from the user to obtain an updated process representation; generating an updated workflow graph visualization of the updated process representation; and displaying the updated workflow graph visualization in the GUI.

In some embodiments, the language model is a large language model.

In some embodiments, identifying, using the process representation and from among the multiple streams of event data, the multiple candidate instances of the process, comprises: generating weighted finite-state automaton (WFSA) from the process representation, the WFSA comprising states, edges between pairs of states, and weights associated with the edges, the states comprising a respective state for each of the activities in the process representation; and identifying the multiple candidate instances of the process using the WFSA.

In some embodiments, each particular stream of the multiple streams of event data comprises a respective sequence of interaction steps performed by a respective particular user, and identifying the multiple candidate instances of the process using the WFSA, comprises: determining step-activity scores, the determining comprising, for each particular sequence of interaction steps among at least some of the sequences of interaction steps in the multiple streams of event data: determining a step-activity score for each pair of an interaction step from the particular sequence of interaction steps and an activity represented by a state in the WFSA; and identifying, using dynamic programming, the multiple candidate instances using the step-activity scores and the weights associated with the edges of the WFSA.

In some embodiments, the at least some sequences of interaction steps comprises a first sequence of interaction steps, the first sequence of interaction steps comprising a first interaction step, the WFSA comprises a first state associated with a first activity, and determining the step-activity scores comprises determining a first step-activity score for the first interaction step and the first activity at least in part by: determining a semantic similarity score for the first interaction step and the first activity; determining a symbolic score for the first interaction step and the first activity; optionally, determining a cross-encoder similarity score for the first interaction step and the first activity; and determining the first step-activity score as a weighted combination of the semantic similarity score, the symbolic score, and, optionally, the cross-encoder similarity score.

In some embodiments, determining the semantic similarity score comprises: generating a textual description for the first interaction step by: generating interaction text data by aggregating textual labels and metadata associated with: (i) the first interaction step, and (ii) interaction steps related to the first interaction step; and providing the interaction text data as input to an LLM to obtain the textual description for the first interaction step; embedding the textual description for the first interaction step using a trained text embedding model to obtain a first embedded vector; embedding a textual description of the first activity using the trained text embedding model to obtain a second embedded vector; and determining the semantic similarity score using the first embedded vector and the second embedded vector.

In some embodiments, determining the symbolic score comprises determining the symbolic score using a measure of similarity between an application associated with the first interaction step and one or more applications associated with the first activity.

In some embodiments, identifying the multiple candidate instances of the process using the WFSA, further comprises: after identifying, using dynamic programming, the multiple candidate instances using the step-activity scores and the weights associated with the edges of the WFSA, ranking the multiple candidate instances based on their respective average step-activity scores; and selecting a number of candidate instances based on their ranking.

In some embodiments, identifying the multiple candidate instances of the process using the WFSA further comprises: after identifying, using dynamic programming, the multiple candidate instances using the step-activity scores and the weights associated with the edges of the WFSA, generating a measure of confidence and textual workflow summary for at least some of the multiple candidate instances.

In some embodiments, the process representation is an interaction step-level process representation.

In some embodiments, the language model is a large language model (LLM), and generating the process representation comprises prompting the LLM with the natural language input to obtain an output indicating a sequence of interaction steps, the output indicating for each interaction step in the sequence: a description of an interaction, an application used to perform the interaction, a screen name, an element name, and/or an indication of time spent during the interaction.

In some embodiments, prompting the LLM with the natural language input comprises: generating a prompt using the natural language input and a schema specifying format of output to be generated by the LLM; and providing the prompt as input to the LLM.

In some embodiments, the method further comprises training the LLM at least in part by: accessing a baseline LLM model; generating training data comprising pairs of natural language input and corresponding outputs, the generating comprising: selecting, at random, interaction sequences part of the multiple streams of event data; using the baseline LLM model to generate, as inputs, natural language prompts from the selected interaction sequences; and using the selected interaction sequences as outputs in the training data corresponding to the natural language prompts; and fine-tuning the baseline LLM model using the generated training data to obtain the LLM model.

In some embodiments, the fine-tuning is performed using group relative policy optimization (GRPO) and low-rank adaptors (LORA).

In some embodiments, reward during GRPO fine-tuning includes a format compliance reward component, an application consistency rewards component, and a redundancy penalty reward component.

In some embodiments, the method further comprises generating a visualization of the at least one confirmed instance of the process.

In some embodiments, the method further comprises identifying, using the at least one confirmed instance of the process and from among the multiple streams of event data, multiple further candidate instances of the process.

Some embodiments provide for a method of guiding a user in performing a process based on historical digital interaction data of one or more users performing the process, the historical digital interaction data comprising multiple streams of event data, each particular stream of event data, from among the multiple streams, corresponding to interactions between one or more application programs executing on particular computing device and a particular user performing the process using the one or more application programs, the method comprising: using at least one computer hardware processor to perform: (A) obtaining a stream of event data corresponding to a series of interactions between at least one application program executing on the user's computing device and the user performing the process using the at least one application program; (B) identifying, within the historical digital interaction data and using the stream of event data, at least one instance of the process previously performed by at least one user; (C) generating guidance for the user performing the process using the at least one instance of the process, the guidance indicating one or more suggested acts for the user in furtherance of performing the process; and (D) providing the generated guidance to the user.

In some embodiments, the at least one instance of the process previously performed by at least one user is performed by at least one user different from the user.

In some embodiments, the method further comprises determining that guidance is to be generated for the user performing the process.

In some embodiments, determining that the guidance is to be generated for the user performing the process comprises: determining that the guidance is to be generated in response to the user requesting assistance in performing the process, or automatically determining that the guidance is to be generated in response to detecting that at least one guidance generation criterion is met.

In some embodiments, the method further comprises: performing (B) and (C), in response to determining that the guidance is to be generated for the user performing the process, or performing (C), in response to determining that the guidance is to be generated for the user performing the process.

In some embodiments, the method further comprises: after identifying the at least one instance of the process at act (B), determining that the guidance is to be generated for the user, optionally, wherein the determining is based on a measure of confidence that the at least one instance of the process is an instance of the process being performed by the user.

In some embodiments, the method further comprises: continuously capturing event data while the user is interacting with the user's computing device, wherein (A) comprises obtaining event data captured within a threshold amount of time.

In some embodiments, the stream of event data contains event data for each event in a stream of events, wherein (B) comprises: organizing events in the stream of events into at least one window of events, each of the at least one window of events comprising one or multiple events in the stream of events; generating, using at least one trained embedding ML model, at least one numeric representation corresponding to the at least one window of events; determining a measure of similarity between the at least one numeric representation and each of multiple stored and previously-determined numeric representations of respective windows of events in the multiple streams of event data in the historical digital interaction data to obtain a plurality of measures of similarity; and identifying, using the determined plurality of measures of similarity, the at least one instance of the process in the stream of events.

In some embodiments, the at least one window of events comprises a first window comprising a first plurality of events, generating the at least one numeric representation corresponding to the at least one window of events comprises generating a first numeric representation of the first window, and generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

In some embodiments, the combining comprises: normalizing each of the numeric representations to obtain normalized numeric representations; and generating the first numeric representation of the first window as a weighted average of the normalized numeric representations, optionally, wherein generating the first numeric representation of the first window as a weighted average comprises weighting the normalized numeric representations based on durations and/or recency of events from which the normalized numeric representations were derived.

In some embodiments, the first plurality of events comprises a first event corresponding to an interaction between a user and an application program, the event data for the first event comprises attribute-value pairs derived from information about the interaction between the user and a GUI of the application program, and processing the event data for first event comprises: generating a textual event representation of the first event using the attribute-value pairs in the event data for the first event; tokenizing the textual event representation to obtain a tokenized event representation; determining an initial numeric encoding of the tokenized event representation; and processing the initial numeric encoding with the trained embedding ML model to obtain a numeric representation of the first event.

In some embodiments, the attribute-value pairs comprise values for one or more attributes selected from the group consisting of: a name of the application program, a title of an application program screen of the application program with which the user interacted during the first event, an identifier of the user interface element of the application program screen with which the user interacted, a type of the user interface element of the application program screen with which the user interacted, one or more identifiers for one or more user interface elements of the application program screen with which the user did not interact, a duration of the interaction, and one or more textual phrases and/or sentences appearing on the application program screen.

In some embodiments, the trained embedding ML model comprises a trained neural network having a transformer-based architecture, optionally, wherein the trained neural network has a BERT model architecture or a RoBERTa model architecture.

In some embodiments, the measure of similarity comprises a cosine similarity.

In some embodiments, generating the guidance for the user performing the process comprises presenting the user with a textual or graphical description of the at least one instance of the process.

Some embodiments provide for a method of guiding a user in performing a process based on historical digital interaction data of one or more users performing the process, the historical digital interaction data comprising multiple streams of event data, each particular stream of event data, from among the multiple streams, corresponding to interactions between one or more application programs executing on particular computing device and a particular user performing the process using the one or more application programs, the method comprising using at least one computer hardware processor to perform: (A) obtaining a stream of event data corresponding to a series of interactions between at least one application program executing on the user's computing device and the user performing the process using the at least one application program; (B) identifying, using the historical digital interaction data, the stream of event data, and a trained large language model (LLM), one or more suggested acts for the user to perform in furtherance of performing the process; and (C) generating guidance for the user performing the process using the identified one or more suggested acts.

In some embodiments, the method further comprises: generating a prompt from the stream of event data; prompting the trained large language model with the prompt generated from the stream of event data to obtain an output indicating one or more acts that the user could perform as part of performing the process, wherein the trained LLM was trained by fine-tuning a baseline LLM with the historical digital interaction data.

In some embodiments, the method further comprises: accessing the baseline LLM; and fine-tuning the baseline LLM with the historical digital interaction data using low-rank adaptors (LORA).

In some embodiments, (C) further comprises presenting the user with the one more acts that the user could perform as part of the performing the process, wherein the presenting comprises provided the user with a textual or graphical description of the one more acts that the user could perform.

In some embodiments, a system is provided, the system comprising: at least one computer hardware processor; and at least one non-transitory computer-readable storage medium storing instructions that, when executed by the at least one computer hardware processor cause the at least one computer hardware processor to perform the method of any one of the foregoing embodiments.

In some embodiments, at least one non-transitory computer-readable storage medium is provided, the at least one-non-transitory computer-readable storage medium storing instructions that, when executed by at least one computer hardware processor cause the at least one computer hardware processor to perform the method of any one of the foregoing embodiments.

### BRIEF DESCRIPTION OF DRAWINGS

Various non-limiting embodiments of the technology will be described with reference to the following figures. It should be appreciated that the figures are not necessarily drawn to scale.

FIG. 1A is a block diagram including components of a process tracking system, according to some embodiments of the technology described herein;

FIG. 1B is a diagram depicting identification of attributes by a process discovery process, according to some embodiments of the technology described herein;

FIG. 1C describes an example of process discovery, according to some embodiments of the technology described herein;

FIG. 1D illustrates an example user interface configured to display information regarding discovered instances of processes, according to some embodiments of the technology described herein;

FIG. 2 illustrates an example user interface screen that a user may interact with, according to some embodiments of the technology described herein;

FIG. 3 is a flowchart of acts for using natural language to identify instances of a process in multiple streams of event data, according to some embodiments of the technology described herein;

FIG. 4 is a block diagram depicting components implemented as part of the process tracking system of FIG. 1A that are used to generate a process representation and identify instances of the process in multiple streams of event data using the process representation, according to some embodiments of the technology described herein;

FIG. 5 is a screenshot of a graphical user interface (GUI) through which natural language input is received, according to some embodiments of the technology described herein;

FIG. 6 is a screenshot of a GUI including a chatbot interface through which a parser is invoked to generate a process representation, according to some embodiments of the technology described herein;

FIGS. 7 and 8 are screenshots of GUIs showing a workflow graph visualization of a process representation, according to some embodiments of the technology described herein;

FIG. 9 is a screenshot of a GUI showing one of the nodes in the workflow graph visualization in an expanded form, according to some embodiments of the technology described herein;

FIG. 10 is a screenshot of a GUI showing an expanded view of a process summary, according to some embodiments of the technology described herein;

FIG. 11 is a screenshot of a GUI including a chatbot interface for receiving further natural language input in the form of user feedback, according to some embodiments of the technology described herein;

FIG. 12 is a screenshot of a GUI showing an updater reasoning through the further natural language input, according to some embodiments of the technology described herein;

FIG. 13 is a screenshot of a GUI showing the updater's reasoning, according to some embodiments of the technology described herein;

FIG. 14 is a screenshot of a GUI showing an updated workflow graph visualization, according to some embodiments of the technology described herein;

FIG. 15 is an example weighted finite state automaton (WFSA) generated from a process representation, according to some embodiments of the technology described herein;

FIG. 16 shows a graph depicting step-activity scores for a process having four activities spanning seventeen interaction steps, according to some embodiments of the technology described herein;

FIG. 17 is a screenshot of a GUI shown to the user while the aligning pipeline runs, according to some embodiments of the technology described herein;

FIG. 18 is a screenshot of a GUI showing a list of candidate instances of a process, according to some embodiments of the technology described herein;

FIG. 19 is a screenshot of a GUI that shows interaction data associated with a node of a candidate instance visualization, according to some embodiments of the technology described herein;

FIG. 20 is a screenshot of a GUI that shows an insight for a candidate instance, according to some embodiments of the technology described herein;

FIG. 21 is a screenshot of a GUI that allows a user to select a candidate instance, according to some embodiments of the technology described herein;

FIG. 22 is a screenshot of a GUI that shows a dialog box for receiving a process name for a selected candidate instance, according to some embodiments of the technology described herein;

FIG. 23 is a diagram showing components implemented as part of the process tracking system of FIG. 1A that are used to generate a process representation and identify instances of the process in multiple streams of event data using the process representation, according to some embodiments of the technology described herein;

FIG. 24A shows an example of the natural language input provided as input to a language model, according to some embodiments of the technology described herein;

FIG. 24B shows an example of the output provided by the language model indicating a sequence of interaction steps, according to some embodiments of the technology described herein;

FIG. 25 is a screenshot of a GUI through which a user can initiate describing a process, according to some embodiments of the technology described herein;

FIG. 26 is a screenshot of a GUI that allows a user to add information about the process, according to some embodiments of the technology described herein;

FIG. 27 is a screenshot of a GUI showing user input for a process name and team, according to some embodiments of the technology described herein;

FIG. 28 is a screenshot of a GUI that shows the added process, according to some embodiments of the technology described herein;

FIG. 29 is a screenshot of a GUI that allows the user to provide natural language input describing a particular process, according to some embodiments of the technology described herein;

FIG. 30 is a screenshot of a GUI through which the user provides the natural language input describing a particular process, according to some embodiments of the technology described herein;

FIG. 31 is a screenshot of a GUI that shows the natural language input describing the process as provided by the user, according to some embodiments of the technology described herein;

FIG. 32 is a screenshot of a GUI showing a list of candidate instances presented to a user, according to some embodiments of the technology described herein;

FIG. 33 is a screenshot of a GUI through which user selection of a candidate instance is received, according to some embodiments of the technology described herein;

FIG. 34 is a screenshot of a GUI through which user input to store the selected candidate instance is received, according to some embodiments of the technology described herein;

FIG. 35 is a screenshot of a GUI that allows a user to edit the natural language input describing the process, according to some embodiments of the technology described herein;

FIGS. 36A-36B are screenshots of GUIs for receiving natural language input describing a process, according to some embodiments of the technology described herein;

FIG. 36C is a screenshot of a GUI showing various metrics associated with discovered instances of a process, according to some embodiments of the technology described herein;

FIG. 37 is a flowchart of acts for guiding a user in performing a process based on historical digital interaction data of one or more users performing the process, according to some embodiments of the technology described herein;

FIG. 38 is a flowchart of acts for guiding a user in performing a process based on historical digital interaction data of one or more users performing the process, according to some embodiments of the technology described herein;

FIG. 39 is a screenshot of a GUI where a dialog box is presented to prompt the user to confirm whether the user is performing a particular process, according to some embodiments of the technology described herein;

FIG. 40 is a screenshot of a GUI that shows a dialog box indicating that a more efficient way of performing a particular process has been found, according to some embodiments of the technology described herein;

FIG. 41 is a screenshot of a GUI presenting a side-by-side view of different ways of performing a particular process, according to some embodiments of the technology described herein;

FIGS. 42, 43, 44, and 45 are screenshots of GUIs showing examples of guidance provided to a user, according to some embodiments of the technology described herein;

FIG. 46 is a screenshot of a GUI showing an error message regarding a technology issue, according to some embodiments of the technology described herein;

FIG. 47 is a screenshot of a GUI showing steps a teammate took to resolve the technology issue, according to some embodiments of the technology described herein;

FIGS. 48, 49, 50, and 51 are screenshots of GUIs showing various ways in which guidance is provided to a user to help navigate a technology issue, according to some embodiments of the technology described herein;

FIGS. 52, 53, 54, 55, and 56 show an illustrative architecture for generating guidance for a user performing a process, according to some embodiments of the technology described herein;

FIG. 57 schematically illustrates components of a computer that may be used to implement some embodiments described herein.

### DETAILED DESCRIPTION

Aspects of the technology described herein relate to novel methods for process discovery and for guiding users using discovered process instances. The process discovery techniques described herein involve receiving natural language input from a user describing a process, generating a process representation from the natural language input using a language model, and identifying, within historical digital interaction data, at least one candidate instance of the process using the natural language input. User guidance techniques involve obtaining a stream of event data corresponding to a series of interactions between at least one application program and a user; identifying, within historical digital interaction data and using the stream of event data, at least one instance of the process previously performed by at least one user; generating guidance for the user performing the process using the at least one instance of the process, the guidance indicating one or more suggested acts for the user in furtherance of performing the process; and providing the user with generated guidance.

A “process” refers to a plurality of user actions that are collectively performed using one or more application programs to perform a task. The task may be any suitable task that could be performed by a user (or multiple users) by interacting with one or more computing devices. The task may be any suitable task that one or more users perform in a business such as, for example, one or more accounting, finance, IT, human resources, purchasing, and/or any other types of tasks. For example, a process may refer to a plurality of user actions that a user takes to perform the task of approving a purchase order (which may involve multiple activities such as receiving the purchase order, reviewing the purchase order, and approving it). As another example, a process may refer to a plurality of user actions that a user takes to perform the task of resolving an IT ticket (which may involve multiple activities such as opening an IT ticket for an issue (e.g., resetting a user's password), addressing the issue, and closing same (e.g., by resetting the password and notifying the user whose password was reset that this is completed)). Some processes may include only a few (e.g., 2 or 3) user actions, whereas other processes may include more (e.g., tens, hundreds, or thousands) user actions. For example, a process may include multiple activities each involving the user performing multiple actions.

A user may perform actions of a process by interacting with the one or more application program(s). The software application program(s) may be installed on a computing device to which the user has access (e.g., the user's desktop, laptop, smartphone, tablet, or other computing device). A user may interact with an application program through its user interface, for example, through its graphical user interface (GUI) by performing various acts via GUI elements shown on the application program's GUI screens. Examples of such acts include selecting checkboxes or radio buttons, entering information into fields, clicking on buttons, clicking on text, selecting text, cutting and/or pasting, clinking on links, dragging and dropping, moving, resizing, opening and/or closing a window, etc. A user may also interact with an application program by providing textual commands via a command-line interface or any other suitable interface. User actions may include various actions (e.g., mouse clicks, keystrokes, button presses). Each interaction between a user and an application program may be referred to as a digital interaction step or, more simply, an interaction step.

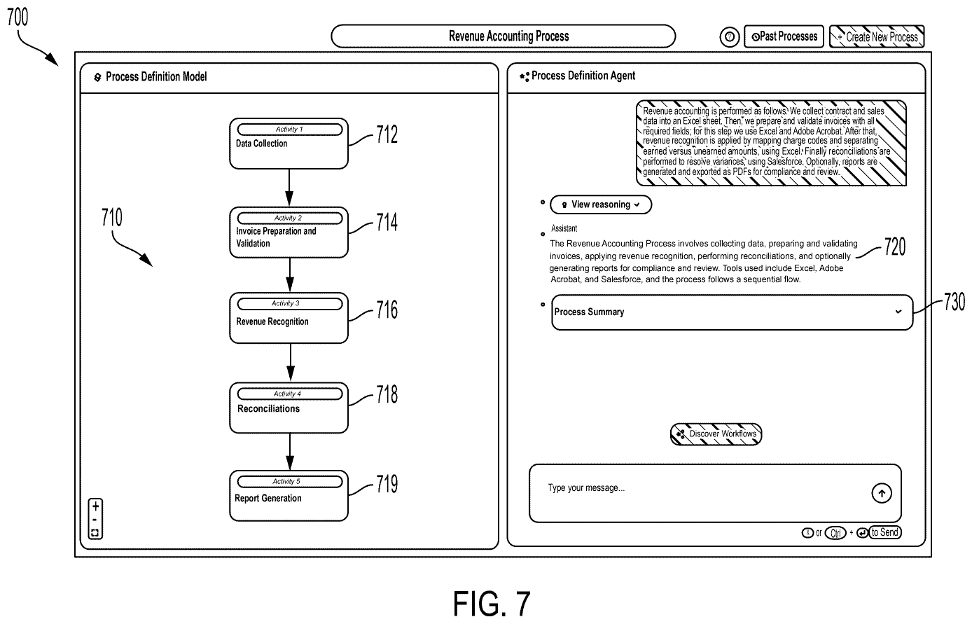

Accordingly, a user's performance of a particular process using one or more application programs involves the user performing a series of digital interaction steps (e.g., tens, hundreds, thousands, tens of thousands of steps, etc.) in furtherance of the particular process. In some instances, a process may involve the user performing multiple activities as part of the process and the series of interaction steps that the user takes to perform the process may involve different subsets of interaction steps for the different activities part of the process. For example, the series of interaction steps performed by a user in furtherance of a process that involve four different activities may include interaction steps for each of the four different activities. As a specific example, also illustrated in FIG. 7, a process for “revenue accounting” may involve multiple activities including “Data Collection”, “Invoice Preparation and Validation”, “Revenue Recognition”, “Reconciliations”, and “Report Generation. Thus, a user performing the “Revenue Accounting” process may perform a series of interaction steps (with one or more appropriate application programs) for each of these five activities.

As described herein, data about how users perform processes may be captured during their performance of such processes. When a user performs a series of interaction steps in order to perform a process, data about the series of interaction steps may be captured and stored. In some embodiments, that data is captured as a stream of event data. A stream of events corresponds to interactions between a user and one or more application programs executing on a computing device with which the user is interacting to perform a process. Events may be ordered in the stream with respect to time at which the events occurred during performance of the process. Individual events in the stream of events may correspond to individual interaction steps (e.g., keystrokes, clicks, button presses, etc.).

In some embodiments, data may be captured about each of at least some (e.g., all) events in a stream of events resulting in a stream of event data. Event data captured for an event may include information indicating the action taken by the user in the event (e.g., a click or keystroke) and associated metadata providing information about the context in which the user's action was taken. Non-limiting examples of such metadata include a unique identifier assigned to the event, an identifier for the computing device with which the user interacted during the event, a name of the application program with which the user interacted during the event, a title of an application program screen of the application program with which the user interacted during the event, an identifier of the user interface element of the application program screen with which the user interacted during the event, a type of the user interface element of the application program screen with which the user interacted during the event, one or more identifiers for one or more user interface elements of the application program screen with which the user did not interact during event, values shown in any user interface elements on the screen during the event, a duration of the interaction, and one or more textual phrases and/or sentences appearing on the application program screen.

Historical digital interaction data refers to previously-captured multiple streams of event data. Each particular stream of event data, from among the multiple streams, may correspond to a series of interactions between one or more application programs executing on particular computing device and a particular user performing a process using the one or more application programs. Historical digital interaction data may contain streams of event data captured for any suitable number of users (e.g., one, tens, hundreds, thousands, tens of thousands, etc.). For example, in some embodiments, historical digital interaction data may contain streams of event data for a group of users at a company (e.g., users on one team, users in one department or division, users in one physical location, users in one geographic region, etc.). Historical digital interaction data may contain streams of event data captured over any suitable period of time (e.g., over an hour, multiple hours, a day, multiple days, week, multiple weeks, a month, multiple months, a year, or multiple years, or any suitable period of time between minutes and years), as aspects of the technology described herein are not limited in this respect. Historical digital interaction data may contain any suitable number streams of event data (e.g., tens, hundreds, thousands, tens of thousands, millions, tens of millions, hundreds of millions, etc.), as aspects of the technology described herein are applicable regardless of the number of streams of event data part of historical event data. Historical digital interaction data may contain streams of data for any suitable number of processes (e.g., tens, hundreds, thousands, etc.). For example, users at an enterprise business may perform thousands or tens of thousands of different processes and the historical digital interaction data may include streams of event data captured during performance of these various processes by users in the enterprise business.

Process discovery refers to identifying, within historical digital interaction data, one or more streams of event data that correspond to one or more users performing a particular process of interest. Such discovered streams of event data may be referred to as process instances.

Importantly, the process discovery techniques described herein are efficient and can be effectively used to discover instances of a process being performed within historical digital interaction data even when the historical digital interaction data is large having thousands, millions, tens of millions or hundreds of millions of streams of data corresponding to tens, hundreds, thousands, or tens of thousands of different processes, and collected from tens, hundreds, thousands, or tens of thousands of users.

Conventional techniques for process discovery involve having subject matter experts (SMEs), being expert in performing a particular process, record multiple instances of themselves performing that particular process. A process discovery system can then use data derived from such recorded instances to discover process instances in historical digital interaction data. In this sense, SMEs can be said to teach the process discovery system how to discover instances of a particular process by providing the process discovery system with examples—taught process instances or “teachings”. Methods for process discovery based on taught process instances are described in U.S. Pat. No. 11,816,112, titled “Systems and Methods for Automated Process Discovery”, filed on Apr. 2, 2021, and granted on Nov. 14, 2023, as well as PCT Patent Publication WO2024/214113, titled “Machine Learning Systems and Methods for Automated Process Discovery”, filed on Apr. 10 2024 and published on Oct. 17, 2024, each of which is incorporated by reference in its entirety herein.

While process discovery methods based on teaching have advantages and may work well in various situations, these methods also suffer from a number of drawbacks. First, the individuals (e.g., SMEs) performing the teaching have to be trained in how to do so, which is time consuming. Second, specialized software for recording teaching instances needs to be installed on SMEs' devices along with any application programs needed to perform the processes being taught. Third, an SME may need to record a process multiple times to generate multiple process instances (because process signatures for use in process discovery are more reliably generated from multiple recorded instances rather than a single instance), which is time-consuming and error-prone. And even though an SME may try to create multiple process instances through teaching, only a small number (e.g., 3-5) of instances will be available and this may be insufficient to generate a high-quality process signature for discovering processes. Finally, when different SMEs record themselves performing the same process, there will invariably be variations in how they do so, which makes using such teachings for process discovery more challenging.

To address such shortcomings, the inventors have developed an alternative way of performing process discovery. As described herein, in lieu of teaching process instances, a user may provide a natural language description of a process. In turn, that natural language description may be processed to generate a representation of the process being described and, in turn, the resulting process representation may be used to discover process instances in historical digital interaction data. The “natural language” approach for process discovery may be used instead of or in addition to the “teaching” approach to process discovery.

The “natural language” approach to process discovery has a number of benefits including: (i) allowing users other than subject matter experts to describe the process (e.g., a manager likely knows a high-level description of the process, but may not necessarily know all the details for how to perform it); (ii) avoiding the need for a user to perform the process multiple times—only a natural language description is required; (iii) reducing delays in starting process discovery and allowing for process discovery to be implemented without delay for any process of interest because an SME need not be involved in teaching instances of a particular process anytime there is some need to discover instances of that particular process; and (4) avoiding the need for multiple users to co-operate for process discovery because instead of multiple SMEs recording process instances, a single user may provide a natural language description of the process of interest.

In order to implement such a design, however, the inventors had to solve multiple technological problems. In particular, the inventors had to develop a way to reliably translate a natural language description of a process into a meaningful process representation (embodied in one or more data structures) that can be used to both efficiently and accurately identify process instances in historical digital interaction data. This was challenging given the sheer volume of historical digital interaction data and the potential imprecision of natural language input. Nonetheless, as described herein, the inventors have developed two different methods for doing this—a so-called “activity-level” process representation, in one implementation, and a so-called “interaction step-level” process representation, in another implementation. These are described herein including in sections titled “Using “activity-level” process representations to identify process instance(s)” and “Using “interaction step-level” process representations to identify process instance(s)”.

Accordingly, some embodiments provide for a method of using natural language to identify instances of a process in multiple streams of event data, each particular stream of event data, from among the multiple streams, corresponding to a series of interactions between one or more application programs executing on particular computing device and a particular user performing the process using the one or more application programs, the method comprising: (A) receiving (e.g., via a GUI) natural language input describing the process; (B) generating a process representation (e.g., an activity-level representation or an interaction step-level representation as described herein) at least in part by using a language model (e.g., a large language model) to process the natural language input; (C) identifying, using the process representation and from among the multiple streams of event data, multiple candidate instances of the process; (D) selecting, based on user input, at least one of the multiple candidate instances; and (E) storing the selected at least one candidate instance as at least one confirmed instance of the process.

In some embodiments, the natural language input describes the process in part by identifying one or more application programs used to perform the process and one or more activities performed using the one or more applications programs in furtherance of the process.

In some embodiments, the process representation may be an “activity-level” representation, whereby the process representation indicates a set of activities and relationships among activities in the set of activities, the relationships indicating an order in which at least some of the activities in the activities are to be performed as part of the process. The process representation may further indicate, for each particular activity in the set of activities: an identifier, a natural language description of the activity, and a set of one or more application programs used to perform the activity.

In some embodiments, the “activity-level” process representation may be visualized to provide the user with a graphical summary of how the system understood the natural language input and providing the user with an opportunity to revise the process representation if needed.

Accordingly, some embodiments involve: generating a workflow graph visualization of the process representation, the workflow graph visualization comprising a graph with nodes representing activities in the set of activities and edges representing the relationships among the activities in the set of activities; and displaying the workflow graph visualization of the process representation in a graphical user interface (GUI).

To facilitate a user revising the process representation generated from the natural language description provided by the user the GUI may comprise one or more interfaces through which the user can revise the representation. One such interface may be an editing tool whereby the user can directly edit the workflow graph. Another such interface may be a chatbot interface. In embodiments involving a chatbot interface, some embodiments may involve: receiving, via the chatbot interface, further natural language input from the user indicating one or more modifications to make to the process representation; modifying the process representation in accordance with the further natural language input from the user to obtain an updated process representation; generating an updated workflow graph visualization of the updated process representation; and displaying the updated workflow graph visualization in the GUI.

In some embodiments, in order to perform process discovery using an “activity-level” process representation, a weighted finite state automaton (WFSA) may be generated from the process representation and the WFSA may be then used to identify the multiple candidate instances of the process in historical digital interaction data. In some embodiments, the WFSA may include states, edges between pairs of states, and weights associated with the edges, with the states comprising a respective state for each of the activities in the “activity-level” process representation.

In some embodiments, dynamic programming may be used to efficiently discover process instances using the WFSA. One of the inventors' insights is that process discovery using “activity-level” process representations may be formulated as a dynamic programing problem with respect to a WFSA generated from the process representation, which allows process discovery to be performed efficiently even when the number of streams of event data in historical digital interaction data is quite enormous.

Accordingly, in some embodiments, each particular stream of the multiple streams of event data comprises a respective sequence of interaction steps performed by a respective particular user, and identifying the multiple candidate instances of the process using the WFSA, comprises: (i) determining step-activity scores, the determining comprising, for each particular sequence of interaction steps among at least some of the sequences of interaction steps in the multiple streams of event data: determining a step-activity score for each pair of an interaction step from the particular sequence of interaction steps and an activity represented by a state in the WFSA; and (ii) identifying, using dynamic programming, the multiple candidate instances using the step-activity scores and the weights associated with the edges of the WFSA.

In some embodiments, the at least some sequences of interaction steps comprises a first sequence of interaction steps, the first sequence of interaction steps comprising a first interaction step, the WFSA comprises a first state associated with a first activity, and determining the step-activity scores comprises determining a first step-activity score for the first interaction step and the first activity at least in part by: (i) determining a semantic similarity score for the first interaction step and the first activity; (ii) determining a symbolic score for the first interaction step and the first activity; and (iii) optionally, determining a cross-encoder similarity score for the first interaction step and the first activity; and determining the first step-activity score as a weighted combination of the semantic similarity score, the symbolic score, and, optionally, the cross-encoder similarity score.

In some embodiments, determining the semantic similarity score comprises: (i) generating a textual description for the first interaction step by: generating interaction text data by aggregating textual labels and metadata associated with: (a) the first interaction step, and (b) interaction steps related to the first interaction step; and providing the interaction text data as input to an LLM to obtain the textual description for the first interaction step; (ii) embedding the textual description for the first interaction step using a trained text embedding model to obtain a first embedded vector; (iii) embedding a textual description of the first activity using the trained text embedding model to obtain a second embedded vector; and (iv) determining the semantic similarity score using the first embedded vector and the second embedded vector.

In some embodiments, determining the symbolic score comprises determining the symbolic score using a measure of similarity between an application associated with the first interaction step and one or more applications associated with the first activity.

In some embodiments, identifying the multiple candidate instances of the process using the WFSA, further comprises: after identifying, using dynamic programming, the multiple candidate instances using the step-activity scores and the weights associated with the edges of the WFSA, ranking the multiple candidate instances based on their respective average step-activity scores; and selecting a number of candidate instances based on their ranking.

In some embodiments, identifying the multiple candidate instances of the process using the WFSA, further comprises: after identifying, using dynamic programming, the multiple candidate instances using the step-activity scores and the weights associated with the edges of the WFSA, generating a measure of confidence and textual workflow summary for at least some of the multiple candidate instances.

As described herein, in some embodiments, an “interaction step-level” process representation may be used instead of an “activity level” process representation. An interaction step level process representation may be generated from the natural language input using a suitably trained large language model. Accordingly, in some embodiments, generating the process representation comprises prompting the LLM with the natural language input to obtain an output indicating a sequence of interaction steps, the output indicating for each interaction step in the sequence: a description of an interaction, an application used to perform the interaction, a screen name, an element name, and/or an indication of time spent during the interaction.

In some embodiments, prompting the LLM with the natural language input comprises: generating a prompt using the natural language input and a schema specifying format of output to be generated by the LLM; and providing the prompt as input to the LLM.

In some embodiments, the LLM may be trained at least in part by: (i) accessing a baseline LLM model; (ii) generating training data comprising pairs of natural language input and corresponding outputs, the generating comprising: selecting, at random, interaction sequences part of the multiple streams of event data; using the baseline LLM model to generate, as inputs, natural language prompts from the selected interaction sequences; and using the selected interaction sequences as outputs in the training data corresponding to the natural language prompts; and (iii) fine-tuning the baseline LLM model using the generated training data to obtain the LLM model. The fine-tuning may be performed by using group relative policy optimization (GRPO) and low-rank adaptors (LORA) or any other suitable methods. When GRPO is used, rewards during GRPO fine-tuning may include includes a format compliance reward component, an application consistency rewards component, and/or a redundancy penalty reward component, as described herein.

Regardless of the type of process representation (whether “activity-level” or “interaction step-level”) used to discover process instances from among historical digital interaction data, the discovered process instances may be used in numerous types of ways.

For example, in some embodiments, such confirmed instances may be used, in the future, to help the same user or other users perform the same process. This may be done by using the stored process instance(s) to generate guidance for one or more users in the future for how to perform the same process. Aspects of such user guidance are described herein including in the Section titled “Techniques for User Guidance Through Process Discovery”.

As another example, in some embodiments, the confirmed process instances may be used to generate a software robot to automate performance of the process. Aspects of generating software robots for process instances are described in U.S. Pat. No. 10,474,313, titled “SOFTWARE ROBOTS FOR PROGRAMMATICALLY CONTROLLING COMPUTER PROGRAMS TO PERFORM TASKS,” granted on Nov. 12, 2019, filed on Mar. 3, 2016, in U.S. Pat. No. 11,816,112, titled “SYSTEMS AND METHODS FOR AUTOMATED PROCESS DISCOVERY,” granted on Nov. 14, 2023, and filed on Apr. 2, 2021; and in U.S. Pat. No. 12,020,046, titled “SYSTEMS AND METHODS FOR AUTOMATED PROCESS DISCOVERY,” granted on Jun. 25, 2024, and filed on Apr. 1, 2022, each of which is incorporated by reference herein in its entirety.

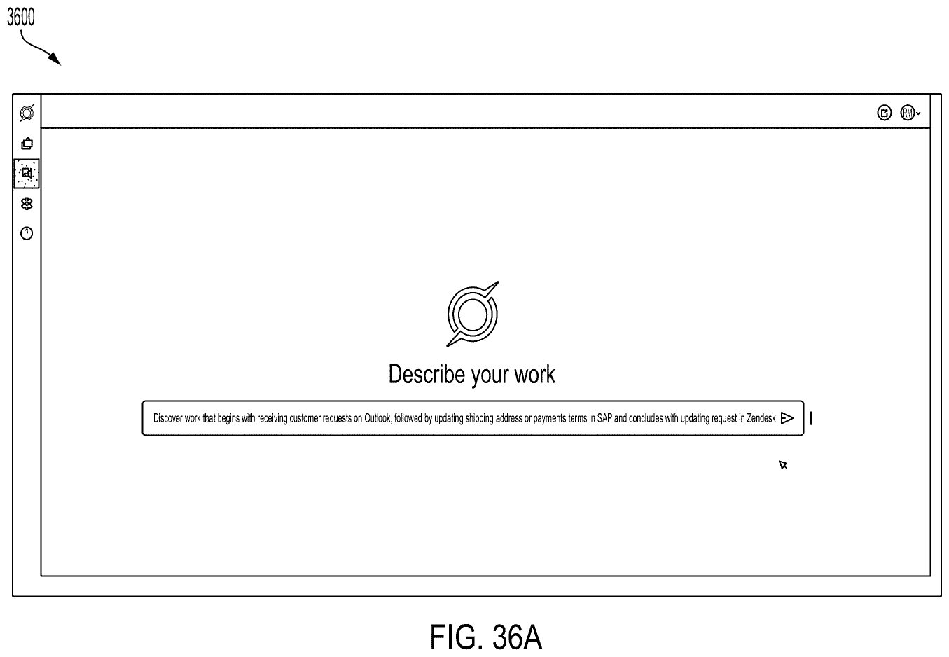

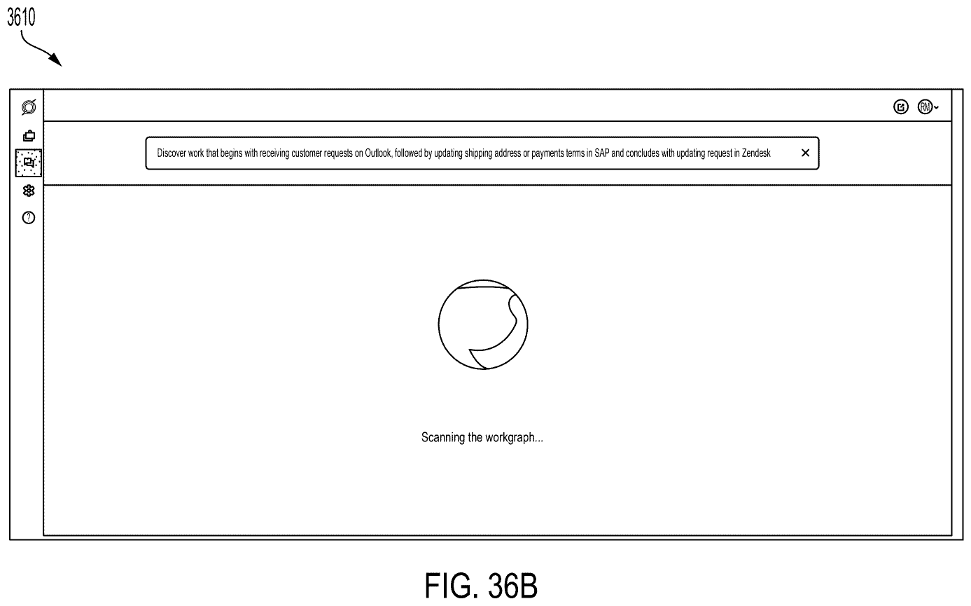

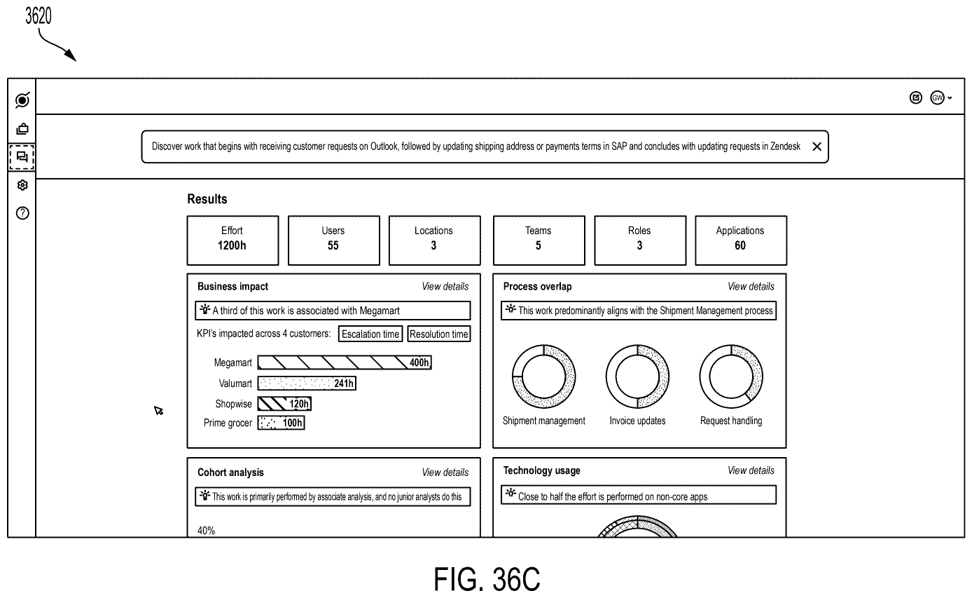

As yet another example, in some embodiments, the confirmed process instance(s) may be provided to the user. This may be done in any suitable way or format. In some embodiments, the confirmed process instances may be visualized and a visual representation of one or more of the confirmed process instances may be generated and displayed to the user. Additionally or alternatively, various pieces of information may be derived from the discovered instances of the process and may be presented to the user. For example, as shown in GUI 3620 of FIG. 36C, various metrics, including but not limited to: automatability, how many hours are spent performing the process, how many users perform the process, geographical locations in which the process is performed and across what teams, roles and applications, may be determined and presented to the user. Such information provides visibility into how the process is performed by various users (e.g., in a business) thereby providing the business with useful intelligence to improve internal processes (e.g., through automation).

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

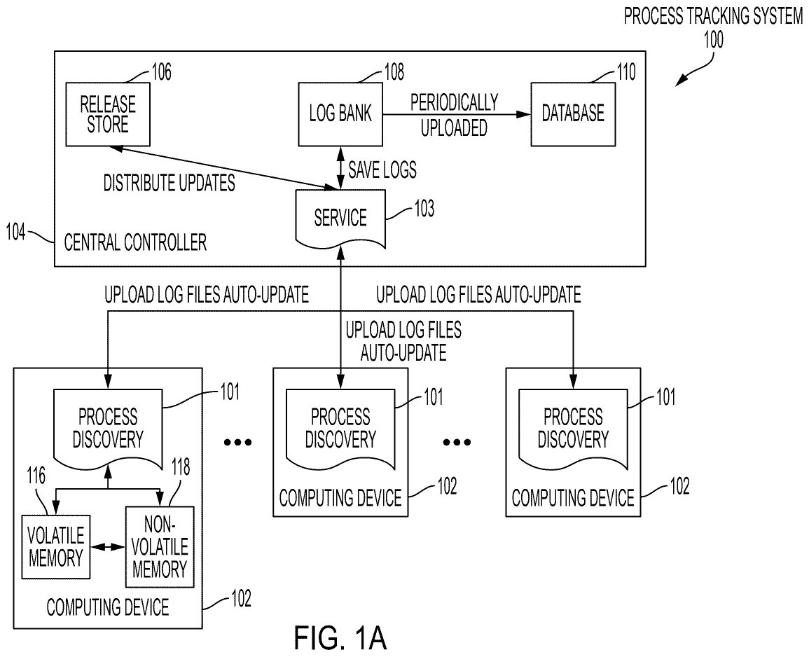

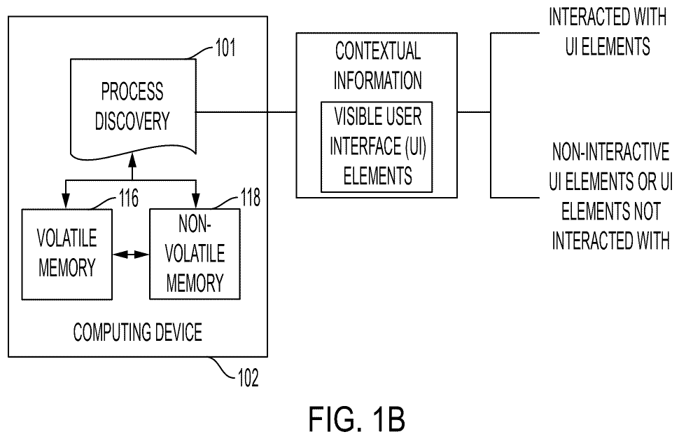

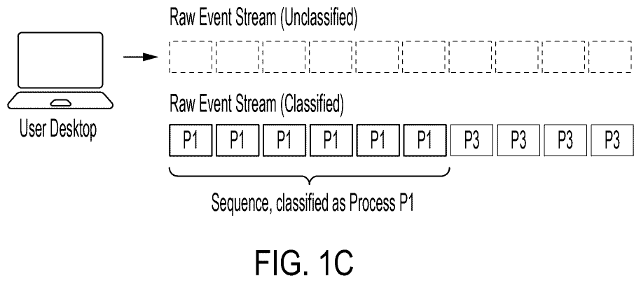

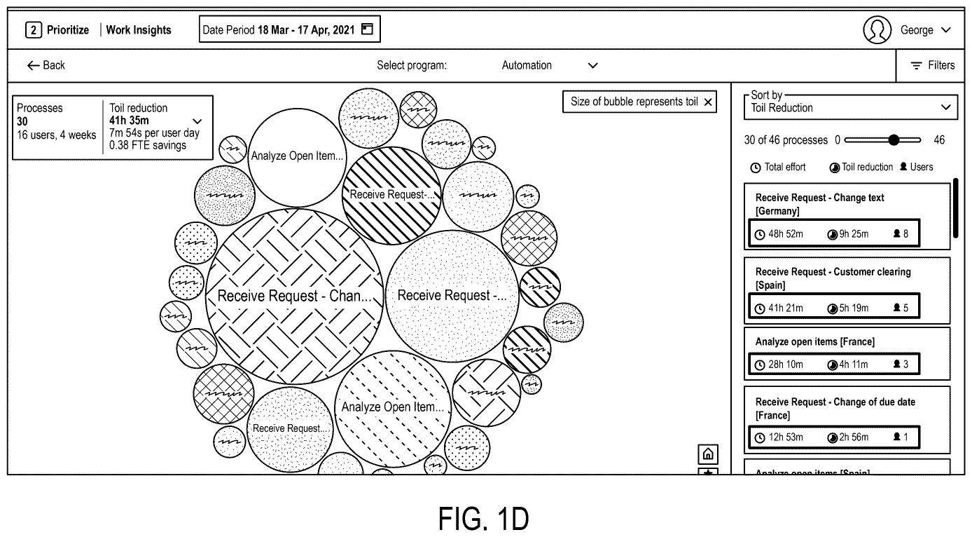

FIG. 1A shows an example process tracking system 100, according to some embodiments. The process tracking system 100 is suitable for tracking one or more processes being performed by users on a plurality of computing devices 102. Each of the computing devices 102 may comprise a volatile memory 116 and a non-volatile memory 118. At least some of the computing devices may be configured to execute process discovery module 101 that tracks user interaction with the respective computing device 102. Process discovery module 101 may be, for example, implemented as a software application and installed on an operating system, such as the WINDOWS® operating system, running on the computing device 102. In another example, process discovery module 101 may be integrated into the operating system running on the computing device 102. In some implementations, process discovery module 101 may include monitoring software installed on computing device 102.

As shown in FIG. 1A, process tracking system 100 further includes a central controller 104 that may be a computing device, such as a server, including a release store 106, a log bank 108, and a database 110. The central controller 104 may be configured to execute a service 103 that gathers the computer usage information collected from the process discovery modules 101 executing on the computing devices 102 and store the collected information in the database 110. Service 103 may be implemented in any of a variety of ways including, for example, as a web-application. In some embodiments, service 103 may be a Python Web Server Gateway Interface (WSGI) application that is exposed as a web resource to the process discovery modules 101 running on the computing devices 102.

In some embodiments, process discovery module 101 may monitor the particular tasks being performed on the computing device 102 on which it is running. For example, process discovery module 101 may monitor the task being performed by monitoring actions, such as keystrokes and/or clicks and gathering contextual information associated with each keystroke and/or click. The contextual information may include information indicative of the state of the user interface when the keystroke and/or click occurred. For example, the contextual information may include information regarding a state of the user interface such as the name of the particular application that the user interacted with, the particular button or field that the user interacted with, and/or the uniform resource locator (URL) link in an active web-browser. The contextual information may be leveraged to gain insight regarding the particular task that the user is performing. For example, a software developer may be using computing device 102 to develop source code and may be continuously switching between an application suitable for developing source code and a web-browser to locate code snippets. Unlike traditional keystroke loggers that would merely gather a string of depressed keys including bits of source code and web URLs, process discovery module 101 may advantageously gather useful contextual information such as the particular active application associated with each keystroke. Thereby, the task of developing source code may be more readily identified in the collected data by analyzing the active applications.

The data collection processes performed by process discovery module 101 may be seamless to a user of the computing device 102. For example, process discovery module 101 may gather the computer usage data without introducing a perceivable lag to the user between when one or more actions of a process are performed and when the user interface is updated. Further, process discovery module 101 may automatically store the collected computer usage data in the volatile memory 116 and periodically (or aperiodically or according to a pre-defined schedule) transfer portions of the collected computer usage data from the volatile memory 116 to the non-volatile memory 118. Thereby, process discovery module 101 may automatically upload captured information in the form of log files from the non-volatile memory 118 to service 103 and/or receive updates from service 103. Accordingly, process discovery module 101 may be completely unobtrusive on the user experience.

In some embodiments, the process discovery module 101 running on each computing device 102 may upload log files to service 103 that include computer usage information such as information indicative of one or more actions performed by a user on the respective computing device 102 and contextual information associated with those actions. Service 103 may, in turn, receive these log files and store the log files in the log bank 108. Service 103 may also periodically upload the logs in the log bank 108 to a database 110. It should be appreciated that the database 110 may be any type of database including, for example, a relational database such as PostgreSQL. Further, the events stored in the database 110 and/or the log bank 108 may be stored redundantly to reduce the likelihood of data loss from, for example, equipment failures. The redundancy may be added by, for example, by duplicating the log bank 108 and/or the database 110.

In some embodiments, service 103 may distribute updates (e.g., software updates) to the process discovery modules 101 running on each of the computing devices 102. For example, process discovery module 101 may request information regarding the latest updates that are available. In this example, service 103 may respond to the request by reading information from the release store 106 to identify the latest software updates and provide information indicative of the latest update to the process discovery module 101 that issued the request. If the process discovery module 101 returns with a request to download the latest version, the service 103 may retrieve the latest update from the release store 106 and provide the latest update to the process discovery module 101 that issued the request.

In some embodiments, service 103 may implement various security features to ensure that the data that passes between service 103 and one or more process discovery modules 101 is secure. For example, a Public Key Infrastructure may be employed by which process discovery module 101 may authenticate itself using a client certificate to access any part of the service 103. Further, the transactions between process discovery module 101 and service 103 may be performed over HTTPS and thus encrypted.

In some embodiments, service 103 makes the collected computer usage information in the database 110 and/or information based on the collected computer usage information (e.g., quality of attributes, user-level data indicative of how long it takes various users to perform the process, how many times the process is performed across a large organization, and/or other information) available to users. For example, service 103 (or some other component in communication with service 103) may be configured to provide a visual representation of at least some of the information stored in the database 110 and/or information based on the stored information to one or more users (e.g., of computing devices 102). For example, a series of user interface screens that permit a user to interact with the computer usage data in the database 110 and/or information based on the stored computer usage data may be provided as the visual representation. These user interface screens may be accessible over the Internet using, for example, HTTPS. It should be appreciated that service 103 may provide access to the data in the database 110 through still yet other ways. For example, service 103 may accept queries through a command-line interface (CLI), such as psql, or a graphical user interface (GUI), such as pgAdmin.

As described herein, a process is a unit of discovery that is searched for during “process discovery” to identify instances of the process in data other than training data, often referred to herein as “wild data” or “data in the wild.” In some embodiments, the “wild data” may be data captured during interaction between users and their computing devices. The data captured may include keystrokes, mouse clicks, and associated metadata (e.g., contextual information). In turn, the captured data may be analyzed using process discovery techniques to identify instances of one or more processes being performed by the users. Aspects of collecting data as the user interacts with a computing device and the types of data that may be captured are provided herein and in U.S. Pat. No. 10,831,450, titled “SYSTEMS AND METHODS FOR DISCOVERING AUTOMATABLE TASKS,” granted on Nov. 10, 2020, which is incorporated by reference herein in its entirety. Non-limiting examples of collected contextual information may include, but not be limited to: Application (e.g., the name of an application, such as an operating system (e.g., Microsoft Windows, Mac OS, Linux), an application executing in the operating system, a web application, or a mobile application); Screen Title (e.g., the title appearing on the application such as the name of the tab in a web browser, the name of a file open in an application, etc.); Element Type (e.g., the type of a user interface element of the application that the user interacted with, such as “button”, “input”, “dropdown”, etc.); Element Name (e.g., the name of a user interface element of the application that the user interacted with such as a name of a button, label of input, etc.); and Element Value (e.g., the value in the user interface element of the application that the user interacted with such as, value “100 Acme drive” in an element that represents the address).

Some embodiments relate to using user interaction information collected via one or more process discovery modules 101 to generate numeric representation(s) of a process that can then be used to identify instances of the process from captured data corresponding to further user interaction information collected via the one or more of the process discovery modules.

Various components in process tracker system 100 may be used to perform generation of numeric representation(s) in teaching mode and/or process discovery. In some embodiments, process discovery may be performed locally on individual computing devices 102 by process discovery modules 101, which may be updated with the most recent numeric representation(s) stored centrally by service 103 periodically, aperiodically or in response to a request from the computing device to provide an update. In some embodiments, process discovery may be performed centrally, with data collected by process discovery modules 101 executing on computing devices 102 being forwarded to service 103, and with service 103 performing process discovery on the received data (from computing devices 102) using the numeric representation(s). In some embodiments, process discovery results may be analyzed using one or more software tools as described herein, and the software tools may execute locally on one or more computing device(s) 102, centrally as part of service 103, and/or in any suitable combination of local and centralized processing. Regardless of whether process discovery is performed locally, centrally, or in a combination of local and central processing, in some embodiments, process discovery results may be provided to one or more users.

In some embodiments, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be automatically created by the process tracking system 100.

In some embodiments, the process tracking system 100 may identify an automatable task based on an automation score generated by analyzing metadata (for example, including the application UI screen metadata described herein) associated with actions or events in the discovered processes. For example, the metadata may be analyzed to determine values for one or more parameters that impact automatability of a given task. Example parameters include but are not limited to, a number of applications employed to perform a task, a number of keystrokes performed in the task, a ratio between keystrokes and clicks performed in the task, and/or other parameters. In some embodiments, the process tracking system 100 may generate the automation score by combining (e.g., linearly combining) the values of these parameters. A determination may be made regarding whether the automation score exceeds a threshold. For example, a task with an automation score that exceeds the threshold may be a good candidate for automation. In response to a determination that the automation score exceeds a threshold, a software robot may be generated to perform the automatable task. Aspects of generating an automation score are described in U.S. Pat. No. 10,831,450.

In some embodiments, a software robot that is configured to perform the automatable task may be generated. The software robot may be configured to control the same set of one or more computer programs employed in the task. The software robot may be generated in any of a variety of ways. In some embodiments, the software robot may be generated using, for example, a sequence of one or more events defining the automatable task. For example, the process tracking system 100 may comprise one or more predetermined software routines for replicating one or more events and the process tracking system 100 may combine these software routines in accordance with the defined sequence of events associated with the task to form a software robot that is configured to perform the task.

In some embodiments, as shown in FIG. 1B, process discovery module 101 may collect action information associated with zero, one or more actions (e.g., a keystroke and/or a click) performed by the user via an application user interface (UI) screen generated by an application program, such as a business application, a desktop application, the Internet Browser, an Operating System, or any other computer software programs executing on computing device 102. In some instances, the process discovery module 101 may consider zero action to be performed when interaction with a graphical user element (GUI) element on a first application UI screen causes a second application UI screen to be presented rather than causing a particular action to be performed on the first application UI screen.

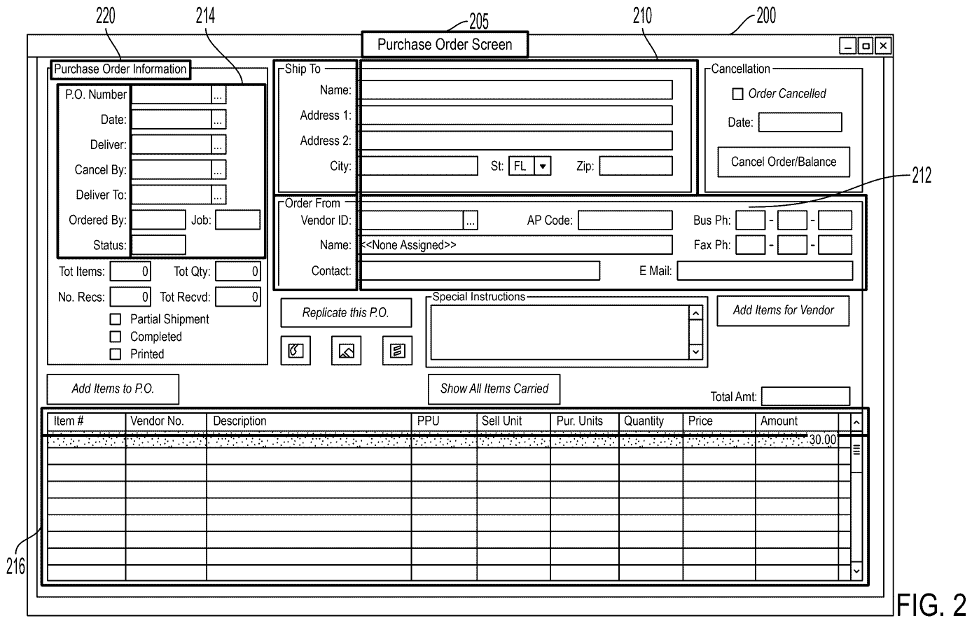

The process discovery module 101 may also collect contextual information associated with GUI elements that are visible in the application UI screen. These GUI elements may include elements, such as buttons or menus that the user interacts with and/or elements, such as fields or labels that the user does not interact with. In some embodiments, the process discovery module 101 may collect contextual information associated with GUI elements not visible in a UI screen. The contextual information may be analyzed to identify a number of attributes for the application UI screen. Each attribute may correspond to at least one GUI element visible in the application UI screen. An example application UI screen that a user may interact with is shown in FIG. 2. While in some embodiments, contextual information associated with visible GUI elements is collected, in other embodiments, contextual information associated with visible and invisible UI elements may be collected.

As depicted in FIG. 1C, process discovery technology may collect a raw event stream from the user's interactions with applications on their desktop, and then, classify the individual events into sequences of processes such as P1 and P3. All users in a team may have the events in their day classified to processes that they defined in their process catalogue and taught examples of. Once the user's days and their activities are classified into processes, the process discovery technology can provide statistics about the processes the users follow. This includes but is not limited to how many users conduct each business process, how many times they conduct it a day, the exact steps they follow and how those steps differ across the users, and how much total time and effort they spend on these processes. FIG. 1D illustrates an example user interface that shows how the process discovery technology attributes effort and statistics like the number of users who are conducting the process.

In some embodiments, one or more users “teach” the process by performing a plurality of actions that collectively form the process while interactions between the user and their computing device are captured (e.g., by using a process discovery module 101 executing on the computing device). Each performance of the process by a user may be called an “instance” of the process, and the data captured during the user's performance of the instance may be stored in association with the instance (e.g., in association with an identifier corresponding to the instance of the process). Specifically, with respect to teaching, an instance performed during teaching may be called a “teaching instance” performed by a user, and a collection of instances taught by one or more users for a particular process may be called the “taught instances” for that process.

As described above, data about how users perform processes may be captured during their performance of such processes. That includes situations where a user is “teaching” an instance of a process. When a user performs a series of interaction steps in order to perform a process, a stream of event data corresponding to the series of interaction steps may be captured and stored. Individual events in the stream of events may correspond to individual interaction steps (e.g., keystrokes, clicks, button presses, etc.). Event data captured for an event may include information indicating the action taken by the user in the event (e.g., a click or keystroke) and associated metadata providing information about the context in which the user's action was taken.

Data corresponding to the stream of events may be collected in any suitable way. In some embodiments the information may be collected as a user interacts with a computer. For instance, an application (e.g., process discovery module 101 shown in FIG. 1) may be installed on the user's computer that collects data as the user interacts with the computer to perform a process. In some embodiments, each user interaction such as a mouse click, keyboard key press, or voice command that a user performs may be considered as an “event.” For each event, metadata associated with the event may be collected. Aspects of the collecting information as the user interacts with a computer are described herein and in U.S. Pat. No. 10,831,450. Non-limiting examples of metadata that may be collected for each event include, but are not limited to:
Application (e.g., the name of an application program, such as an operating system (e.g., Microsoft Windows, Mac OS, Linux) application, a web application, or a mobile application)
Screen Title (e.g., the title appearing on an application program screen such as the name of the tab in a web browser, the name of a file open in an application, etc.)
Element Identifier(s) (e.g., identifier(s) of user interface element(s) of the application program screen with which the user interacted and/or identifier(s) for user interface element(s) of the application program screen with which the user did not interact)
Element Type (e.g., the type of a user interface element of the application program screen with which the user interacted, such as “button”, “input”, “dropdown” etc.)
Element Name (e.g., the name of a user interface element of the application program screen with which the user interacted such as a name of a button, label of input, etc.)
Duration of the interaction
One or more textual phrases and/or sentences appearing on the application program screen (e.g., subject and body of emails in an email application (e.g., Outlook); content of a spreadsheet or document, such as, a list of special words that are colored, italicized, bolded or highlighted, in the spreadsheet or document application (e.g., Excel, Word, Adobe reader); text displayed on the screen of a mainframe application, etc.)

In some embodiments, metadata associated with an event may additionally include an event identifier. The event identifier may be in any suitable format, such as, numeric, alphanumeric, or other format. For example, an event identifier may be combination of digits, alphabets, and special characters, such as, an underscore.

FIG. 2 illustrates an annotated screenshot indicating examples of metadata associated with events corresponding to user interactions with a purchase order screen 205, in accordance with some aspects of the technology described herein. As shown in FIG. 2, the metadata includes the title of the screen 205 (e.g., Purchase Order Screen), element identifiers, types (e.g., dropdowns, input, etc.) and names (e.g., P.O. Number, Date, Name, Address, etc.) associated with user interface elements 210, 212, 214, and 216 with which the user interacted, and/or element identifier for user interface element 220 with which the user did not interact.

In some embodiments, the metadata for each particular event specifies values for attributes of the particular event. For example, entering an address in an address field shown in FIG. 2 may cause the following information (attribute value pairs) to be captured as metadata. It will be appreciated that the following list is not exhaustive and other information may be captured without departing from the scope of this disclosure.
Application—Purchase Order
Screen Title—Purchase Order Screen
Element Type—Input field
Element Name—Address 1

### Techniques for Discovering Processes Using Natural Language Input

As described herein, the inventors have developed techniques for using natural language to identify instances of a process in multiple streams of event data. A user may describe a process by providing natural language input via a graphical user interface, and a language model (e.g., a large language model (LLM)) may be used to process the natural language input to generate a process representation of the process being described. In some embodiments, the process representation may be a so-called “activity-level” process representation that indicates a set of activities and relationships between activities in the set of activities. In other embodiments, the process representation may be a so-called “interaction step-level” process representation that indicates a sequence of interaction steps part of the process being described. Regardless of the type of process representation generated, that generated process representation may be used to identify one or more instances of the process in the multiple streams of event data.

In some embodiments, the multiple streams of event data may include historical event data comprising multiple streams of event data from one or more users, which may include the user providing the natural language input and/or one or more users different from the user providing the natural language input. Thus, the generated process representation may be used to identify one or more instances of the process previously performed by the user that is providing the natural language input and/or one or more instances of the process previously performed by one or more other users.

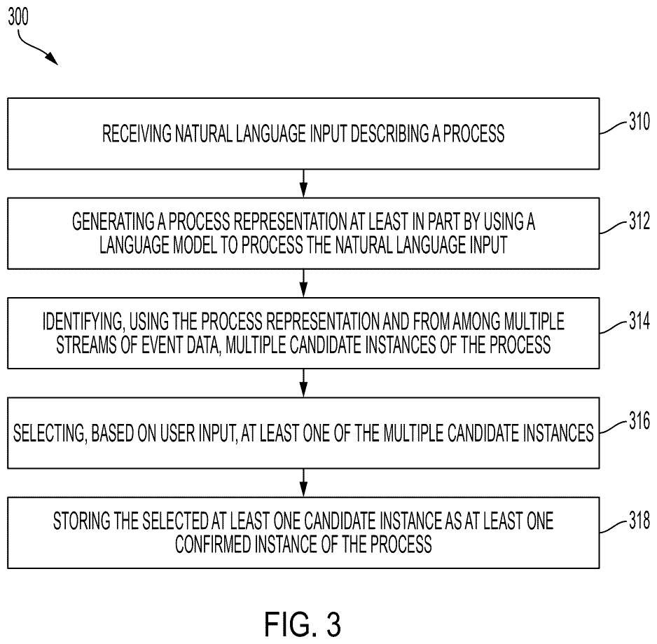

FIG. 3 is a flowchart of an illustrative method 300 for using natural language to identify instances of a process in multiple streams of event data, in accordance with some embodiments of the technology described herein. At least some of the acts of method 300 may be performed by any suitable computing device or devices, and, for example, may be performed by one or more of the computing devices 102 and/or central controller 104 shown in process tracking system 100 of FIG. 1.

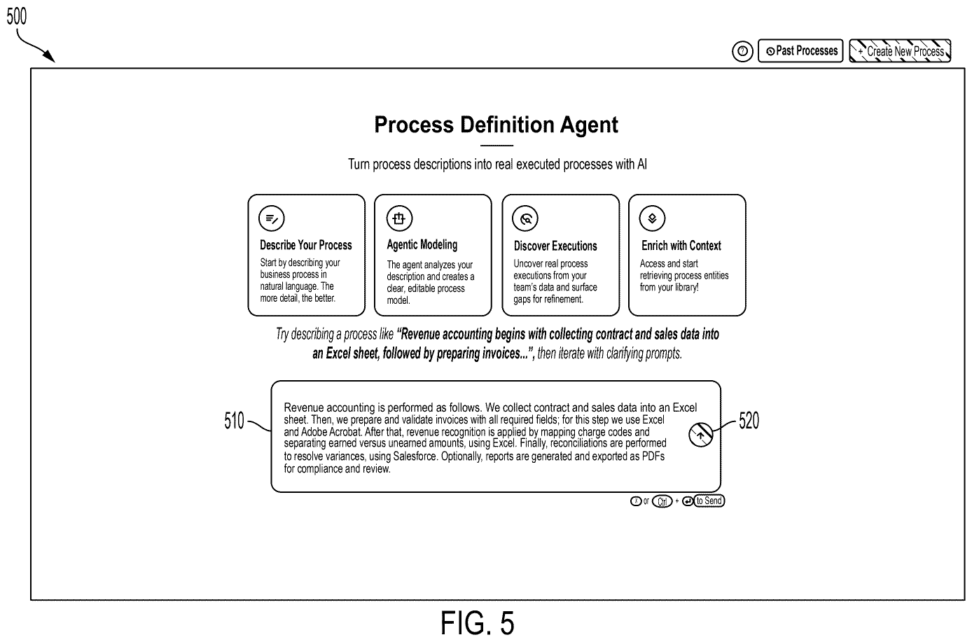

In act 310, natural language input describing the process may be received. The natural language input may be provided to the system performing process 300 in any suitable way. For example, the natural language input may be received via a graphical user interface (GUI). The GUI may be configured to receive the natural language input using any GUI element(s) suitable for receiving text input (e.g., a text input box, a search box, etc.). FIG. 5 shows illustrative GUI 500 that receives natural language input via GUI element 510. As another example, the natural language input may be provided by voice dictation.

Returning to the example of FIG. 5, GUI 500 shows an illustrative example of natural language input that was provided as input by a user trying to describe a process. The natural language input shown in FIG. 5 is:
“Revenue accounting is performed as follows. We collect contract and sales data into an Excel sheet. Then, we prepare and validate invoices with all required fields; for this step we use Excel and Adobe Acrobat. After that, revenue recognition is applied by mapping charge codes and separating earned versus unearned amounts, using Excel. Finally, reconciliations are performed to resolve variances, using Salesforce. Optionally, reports are generated and exported as PDFs for compliance and review.”

As can be seen from this illustrative example, the natural language input describes the process in part by identifying one or more application programs (e.g., Excel, Adobe Acrobat) used to perform the process and one or more activities (e.g., data collection, invoice preparation and validation, revenue recognition, reconciliation, report generation, etc.) performed using the one or more application programs in furtherance of the process. The natural language input may specify any suitable number of application programs and any suitable number of activities to be performed using the specified application programs, as aspects of the technology described herein are not limited in this respect.

Next process 300 proceeds to act 312. At act 312, the natural language input received at act 310 is processed using a language model (e.g., an LLM) to generate a process representation of the process from the natural language input.

In some embodiments, the process representation may be an activity-level process representation. For example, the process representation may be a structured process model that indicates a set of activities and relationships among at least some (e.g., all) of the activities in the set of activities. The relationships may indicate an order in which at least some (e.g., all) of the activities in the activities are to be performed as part of the process. For example, a process representation indicating that the process involves activities A, B, and C may indicate relationships among all of the activities, for instance, specifying that the activities A, B, and C are to be performed sequentially in that order. As another example, the process representation may indicate that activity C is to be performed after activities A and B, but not require that the activities A and B be performed in any particular order relative to one another because they do not depend on one another.

In some embodiments, the process representation may indicate, for each particular activity in the set of activities: an identifier, a natural language description of the activity, and a set of one or more application programs used to perform the activity. Additionally, in some embodiments, the process representation may indicate a title for each activity and/or one or more keywords related to the activity.

In some embodiments, the process representation may be defined as an object P=(A, R) that is composed of a set of activities A and a set of relations R that connects the activities. Moreover, each activity a E A is an object with at least some (e.g., all) of the following fields:
label: A unique label to the activity, e.g., “activity 1”.
title: A short title for the activity, e.g., “Data Collection”.
description: A natural language explanation of what the activity is about, e.g., “Collect contract and sales data into an Excel sheet”.
applications: A set of one or more applications associated with the activity, e.g., “Excel and Salesforce”.
keywords: An optional set of one or more words related to the activity, e.g., “PO number”.

In some embodiments, the process representation may be represented as a graph with nodes representing activities A and edges between nodes representing relations in the set of relations R. The edges may be directed edges representing an order of execution or undirected edges. Thus, in some embodiments, a process representation may be embodied in at least one data structure representing a graph, for example, with nodes representing activities and pointers representing edges, though any other suitable data structure(s) may be used to embody a process representation, as aspects of the technology described herein are not limited in this respect.

The above-described process representation is an example of an activity-level process representation.

In other embodiments, at act 312, the process representation may be an interaction step-level representation. In some such embodiments, a language model (e.g., an LLM) may be prompted with natural language input to obtain an output indicating the interaction step-level representation including a sequence of interaction steps. The output may indicate, for each interaction step in the sequence of interaction steps: a description of an interaction, an application used to perform the interaction, a screen name, an element name, and/or an indication of time spent during the interaction. For example, the output may indicate for each interaction step any one, any two, any three, any four, or all of these items without departing from the scope of this disclosure. Fewer or more items may be indicated in the output for each interaction steps, as the disclosure is not limited in this respect.

Regardless of the type of process representation generated at act 312, the generated process representation may be used, at act 314, to identify one or more candidate instances of the process from among multiple streams of event data. In embodiments where the process representation is an activity-level process representation (e.g., containing a set of activities and a set of relations between the activities), the candidate instance(s) of the process may be identified using the set of activities and the set relations as described herein, including with reference to the section below titled “Using “activity-level” process representations to identify process instance(s)”. In embodiments where the process representation is an interaction step-level process representation (e.g., containing interaction steps), the candidate instance(s) of the process may be identified using the interaction steps in the representation as described herein including with reference to the section below titled “Using “interaction step-level” process representations to identify process instance(s)”.

Once one or more candidate instance(s) are identified at act 314, process 300 proceeds to act 316, where at least one of the multiple candidate instances may be selected based on user input. The multiple candidate instances may be presented to the user via an interactive GUI and the user may provide input, through the interactive GUI, indicating that one or more of the candidate instances is a confirmed instance of the process that the user was describing using the natural language input provided at act 312. In some embodiments, the user may select one or more of the candidate process instances and the selected instance(s) may be stored, at act 318, for subsequent use in association with information indicating that the instance(s) are confirmed instances of the process being described.

There are numerous ways in which confirmed instances of the process may be used after they are stored. As described herein, including in the Section titled “Techniques for User Guidance Through Process Discovery”, confirmed process instance(s) may be stored and used, in the future, to help the same user or other users perform the same process by using the process instance(s) to generate guidance for one or more users for how to perform the same process.

As another example, in some embodiments, the confirmed process instance(s) may be used to generate a software robot to automate performance of the process.

As yet another example, in some embodiments, the confirmed process instance(s) may be provided to the user. This may be done in any suitable way or format. In some embodiments, the confirmed process instances may be visualized and a visual representation of one or more of the confirmed process instances may be generated and displayed to the user. Additionally or alternatively, various pieces of information may be derived from the discovered instances of the process and may be presented to the user, for example, like the metrics shown in GUI 3620 of FIG. 36C and presented to the user. Such information provides visibility into how the process is performed by various users thereby providing the business with useful intelligence to improve internal processes.

As yet another example, in some embodiments, at least one confirmed instance of the process may be used to identify further candidate instances of the process from among the multiple streams of event data. That is, in some embodiments, the one or more confirmed instances of the process may be used for process discovery. This may be helpful because the confirmed instance(s) of the process may provide a more accurate representation of the process than the process representation generated at act 312. In turn, discovering process instances using a more accurate representation of the process being described using natural language input will facilitate identifying process instances with greater accuracy (fewer false alarms and fewer missed detections). For example, as described herein, in the section below titled “Using “interaction step-level” process representations to identify process instance(s)”, when the process representation generated at act 312 is a interaction step-level representation, such a process representation may have language model hallucinations present and the impact of such hallucinations may be mitigated (e.g., removed) when process instances are identified in a two stage process: (i) first a confirmed instance of the process is identified using the process representation generated at act 312; and (ii) the confirmed instance of the process is used to identify further process instances instead of using the process representation generated at act 312 (because it may include hallucinations).

### Using “Activity-Level” Process Representations to Identify Process Instance(s)

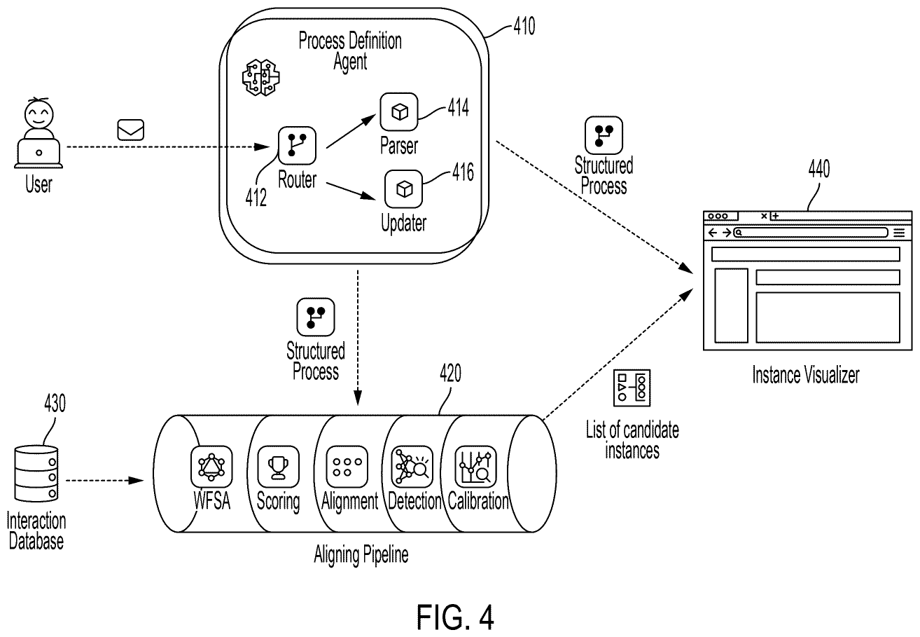

As discussed above with respect to FIG. 3, in some embodiments, the process representation generated at act 312 may be a structured process representation or model that indicates a set of activities and relationships among activities in the set of activities, where the relationships indicate an order in which at least some of the activities in the activities are to be performed as part of the process. In some such embodiments, acts 312 and 314 may be performed by system components shown in FIG. 4. FIG. 4 illustrates various system components implemented as part of the process tracking system 100 that are used to generate the process representation and identify instances of the process in multiple streams of event data using the process representation. The system components include a process definition agent (PDA) 410 and an aligning pipeline 420.

As shown in FIG. 4, PDA 410 includes a router 412, a parser 414, and an updater 416. In some embodiments, natural language input obtained at act 310 of process 300 may be provided as input to PDA 410. Each natural language input received by the PDA 410 is analyzed by the router 412. Router 412 classifies the natural language input as valid or not valid. When classified as valid, the router 412 routes the natural language input to either the parser 414 or updater 416. When classified as not valid, the router 412 discards the natural language input as being irrelevant to the PDA's goal. This ensures that malicious and off-topic prompts (e.g., prompts not relating to process description and discovery) do not go through the PDA.

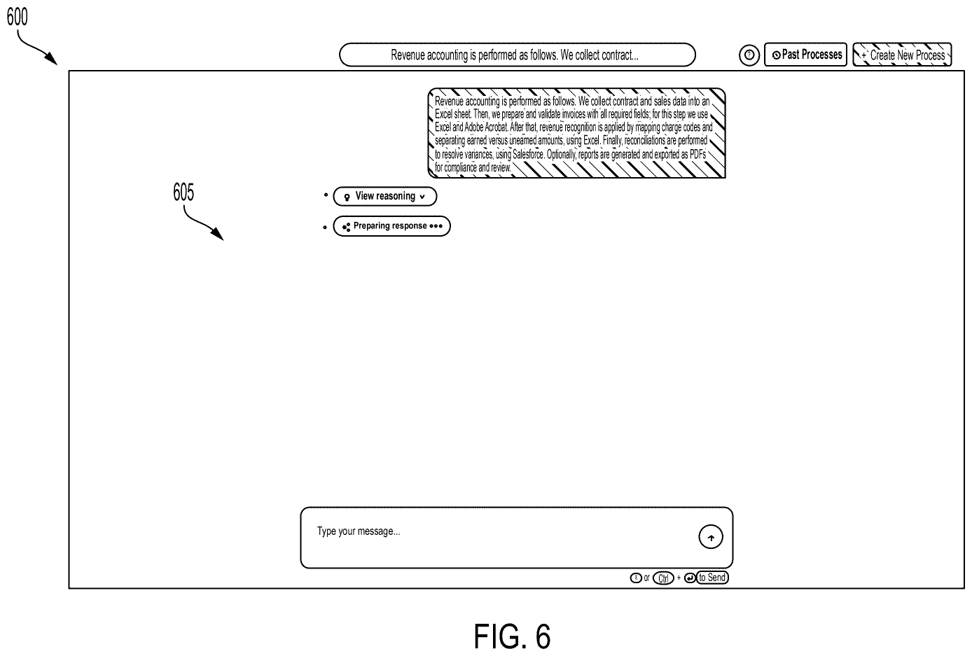

In some embodiments, the parser 414 implements an LLM that processes the natural language input and generates an output indicating the process representation. In some embodiments, the LLM prompted to elicit reasoning via chain-of-thought, is set to understand the process description and generate the process representation. FIG. 6 shows a GUI 600 including chatbot interface 605 through which the parser 414 is invoked to generate a process representation via chain-of-thought prompting.

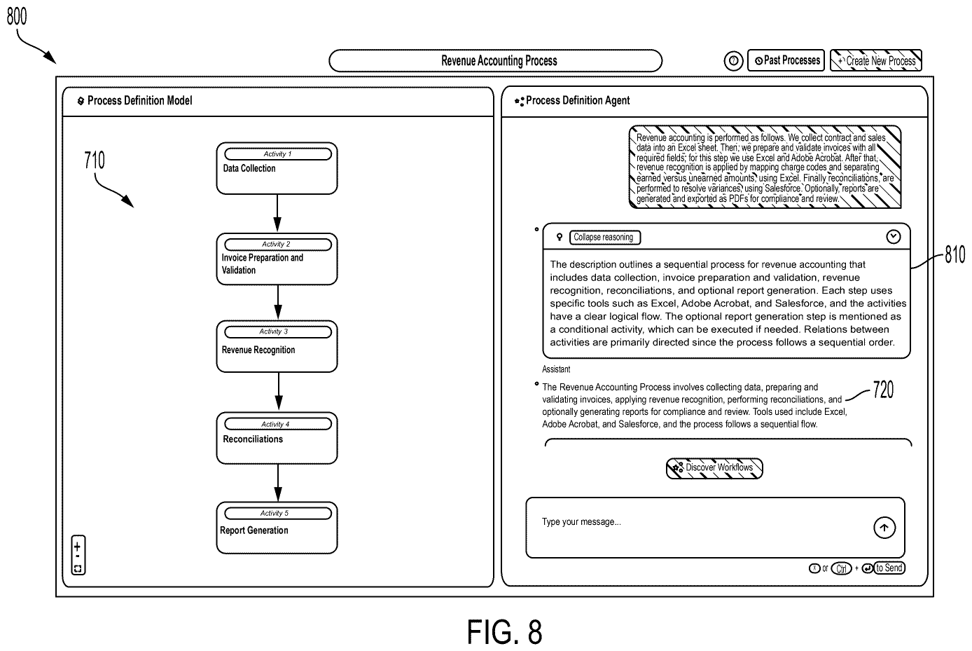

In some embodiments, the parser 414 may generate a workflow graph visualization of the process representation. FIGS. 7 and 8 are screenshots of example GUIs 700, 800 where a workflow graph visualization 710 is displayed. The workflow graph visualization 710, displayed on the left-hand side of the GUIs, includes a graph with nodes 712, 714, 716, 718, 719 representing activities in the set of activities and edges representing the relationships among the activities in the set of activities. As shown in FIGS. 7 and 8, the nodes represent activities “Data Collection,” “Invoice Preparation and Validation,” “Revenue Recognition,” “Reconciliations,” and “Report Generation.” The right-hand side of the GUIs displays the parser language model's reasoning 810, the output 720, and the process summary 730.

The router 412, parser 414, and updater 416 may be implemented in any suitable way. In one example implementation, the DSPy Python package may be used, which package makes use of “DSPy signatures”. A DSPy signature may be considered as a typed contract for a language model call that declares the inputs you will provide and the outputs you expect back.
A DSPy signature is a small class that:
   Has a (Python) docstring that becomes the instruction/prompt for the model.
   Declares fields with roles: inputs (what you give the model) and outputs (what you want the model to produce).
   Optionally uses concrete Python types (such as the “structured process”) so the result is parsed/validated into that shape.

In turn, the DSPy package uses the signature to build the prompt and to parse the model's response back into a structured object with named attributes. Accordingly, in some embodiments, the router 412, parser 414, and updater 416 may be implemented using three DSPy signatures as described below. Though it should be appreciated that these agents may be implemented without using the DSPy package specifically, as that is an example, and that other ways of prompting the model with a persona, inputs, and output structure may be employed, as aspects of the technology described herein are not limited in this respect.

Returning to the example implementation using the DSPy package, the router 412 agent may be implemented using a “QueryRouter” signature. This signature may be a simple classification contract that takes the user's raw message as input and returns a decision (one of “parse”, “update”, or “none”). Its docstring may instructs the language model to judge whether the message describes a new process to parse, feedback for modifying an existing one, or something unrelated. In the router 412 agent, it's bound with a lightweight predictor (dspy.Predict) and run first; its single output field drives the control flow so the service either invokes the parser, the updater, or replies that the message isn't process related.

The parser 414 agent may be implemented using a “ParseProcess” signature. This signature may be a parsing contract that accepts a natural language description and asks the underlying language model (any suitable language model may be used, for example, GPT-4o) to produce a process representation P, defining activities and relations, along with a human readable summary and optional clarifications. The docstring specifies concrete behaviors: label activities sequentially as activity₁, activity₂, . . . ; infer directed relations for ordered/dependent flow and undirected ones for independent steps; and provide questions when details are missing. In the agent, it may be run as a Chain of Thought program (dspy.ChainOfThought).

The updater 416 agent may be implemented using an “UpdateProcess” signature. This signature may be an editing contract that takes the current process representation together with a user instruction and returns an updated process representation, a short change summary, and optional clarifications. Its docstring tells the language model to use a provided toolset (add/remove/update/reorder/rename activities; add/remove relations) to make precise, auditable changes rather than free-form text. In the agent, it may be executed via ReAct (dspy.ReAct) with multi-hop planning over the tools, emitting reasoning and tool call status as it works, then returning the revised structure and a concise description of what changed.

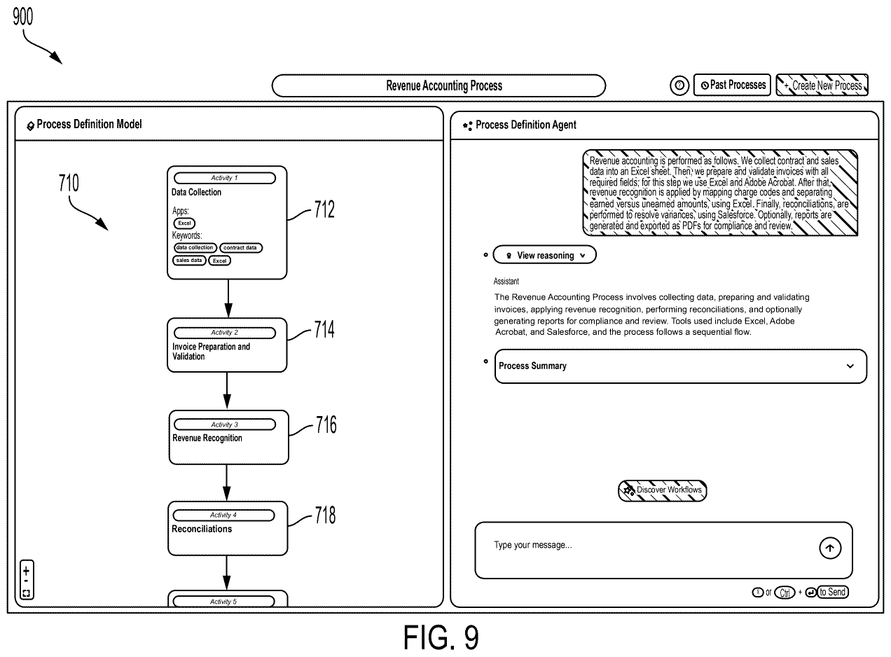

FIG. 9 is a screenshot of example GUI 900 that shows one of the nodes 712 in the workflow graph visualization 710 in an expanded form to visualize the application programs and keywords related to the “Data Collection” activity. A user can click each of the nodes 712, 714, 716, 718, and 719 (not visible in FIG. 9) to visualize the application programs and keywords related to each corresponding activity.

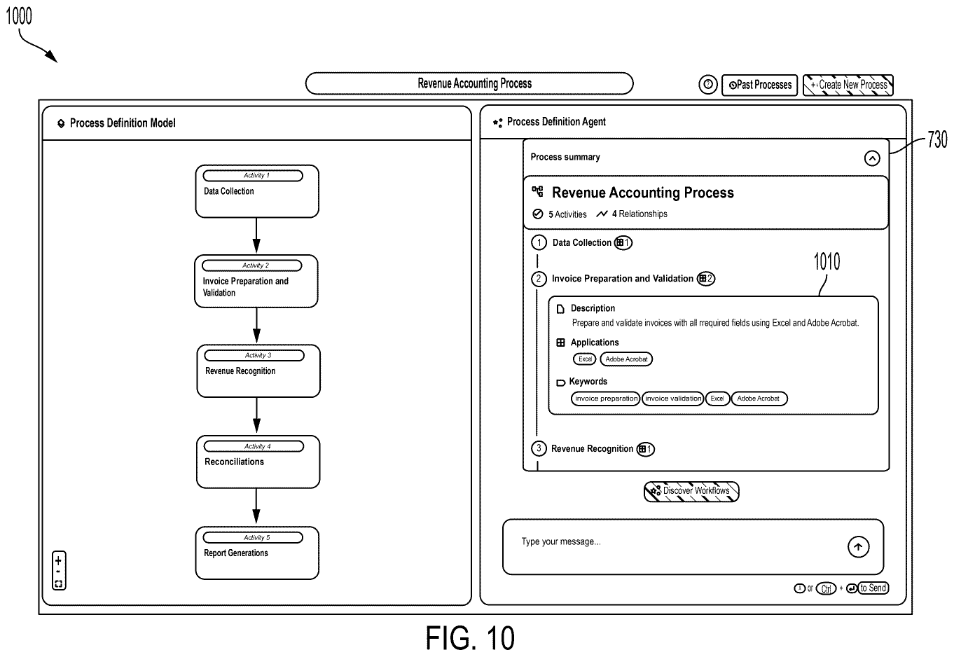

FIG. 10 is a screenshot of example GUI 1000 that shows an expanded view of the process summary 730. The user can click on “Process Summary” to inspect each activity of the process in more detail. For example, as shown in FIG. 10, a summary of the “Revenue Accounting Process” is provided which includes 5 activities and 4 relationships among the activities. The user can click on each activity to view a summary of that activity. FIG. 10 shows a summary 1010 of the “Invoice Preparation and Validation” activity. The activity summary includes a title for the activity, a description of the activity, application programs associated with the activity, and keywords related to the activity.

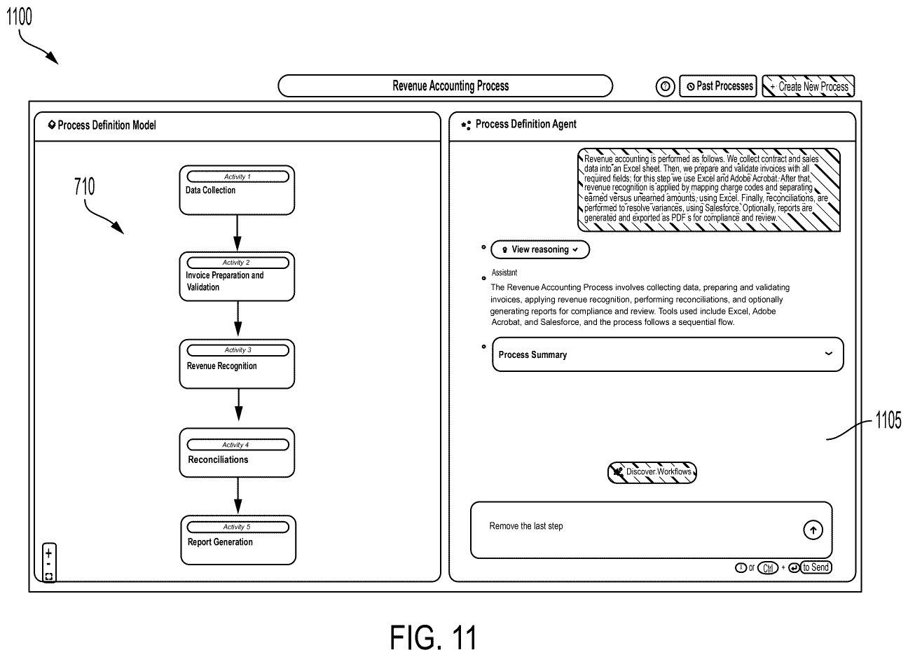

In some embodiments, after reviewing the process representation generated by parser 414, a user may determine that the process representation needs to be updated. An update may be needed either because the parser 414 misinterpreted the natural language input or the user desires to make a refinement (e.g., remove an activity, add an activity, add a relationship between activities, add/remove application program associated with an activity, add/remove keywords associated with an activity, etc.). In either scenario, the user may provide further natural language input, via a chatbot interface, indicating one or more modifications to make to the process representation. FIG. 11 is a screenshot of example GUI 1100 including chatbot interface 1105 where the user provides further natural language input in the form of feedback —“Remove the last step”—implying that the last activity “Report Generation” should be removed from the process representation.

In some embodiments, the further natural language input is sent to the router 412. The router 412 routes the further natural language input to the updater 416. The updater 416 implements an LLM that processes the further natural language input and generates an output indicating an updated process representation. The updater 416 modifies the process representation in accordance with the further natural language input to obtain the updated process representation. The updater 416 generates an updated workflow graph visualization of the updated process representation and displays the updated workflow graph visualization in the GUI.

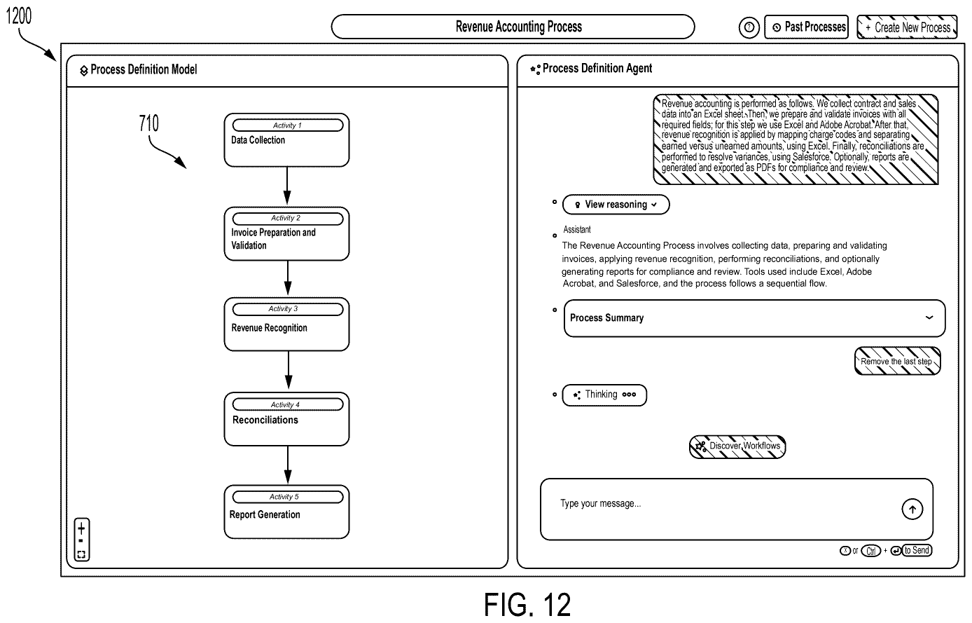

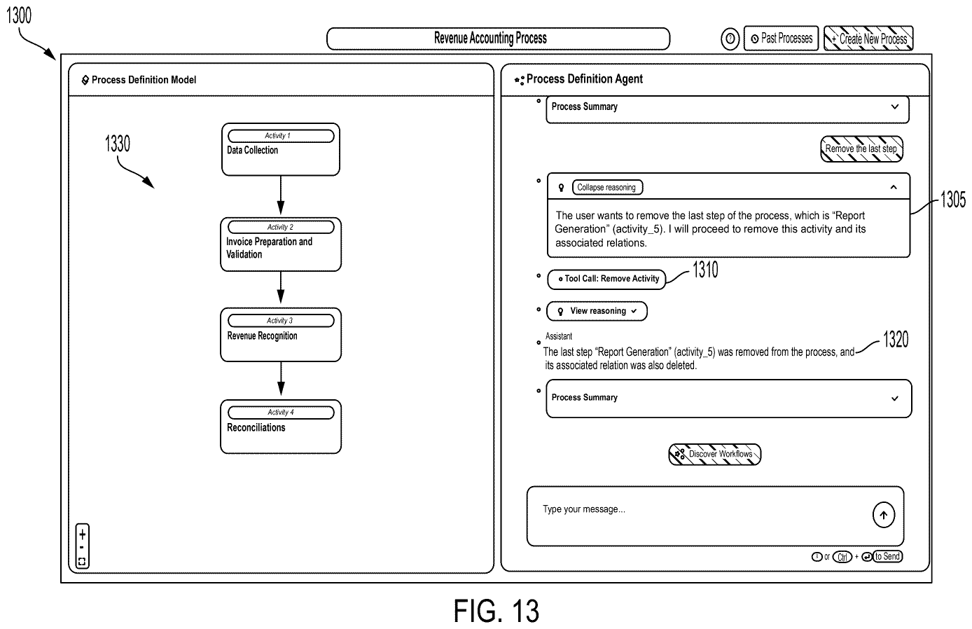

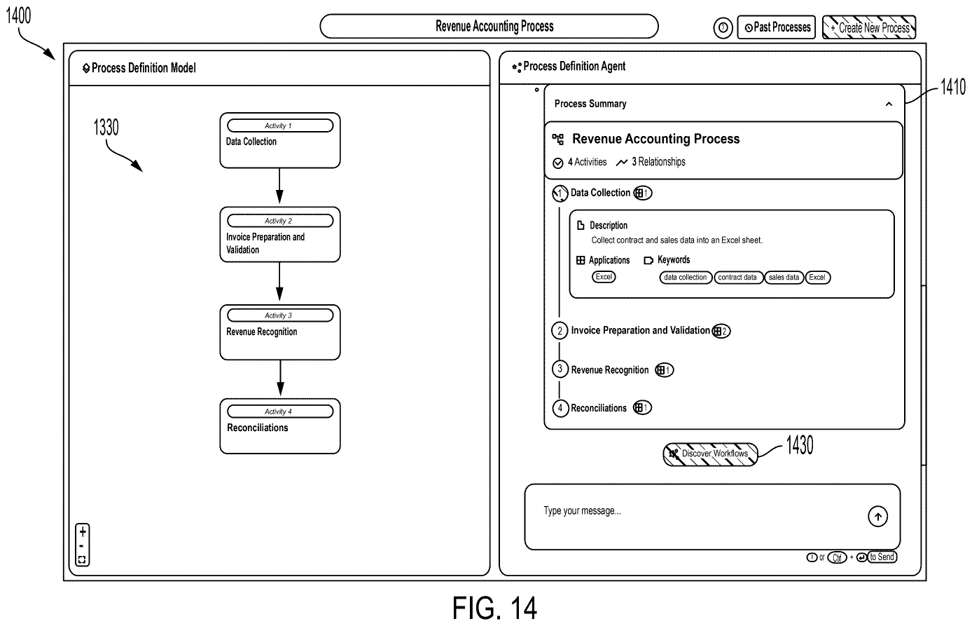

FIG. 12 is a screenshot of an example GUI 1200 that shows the updater reasoning though the further natural language input on the right-hand side of the GUI. FIG. 13 is a screenshot of an example GUI 1300 that shows the updater LLM's reasoning 1305, action(s) 1310 (e.g., pre-defined function calls) performed to implement the modification, and summary 1320 of the action(s) performed. As shown on the left-hand side of FIG. 13, the workflow graph visualization 710 is updated by removing the last node representing the “Report Generation” activity to obtain an updated workflow graph visualization 1330. FIG. 14 is a screenshot of an example GUI 1400 that shows the updated workflow visualization 1330 and an updated summary 1410 of the “Revenue Accounting Process” which includes 4 activities and 3 relationships among the activities.

Once the user is satisfied with the generated process representation, the user can click the “Discover Workflows” button 1430. Selection of button 1430 causes the PDA 410 to send the structured process model to the aligning pipeline 420. The aligning pipeline 420 identifies, as part of act 314, using the generated process representation and from among multiple streams of event data, multiple candidate instances of the process.

In some embodiments, identifying at act 314, using the process representation and from among the multiple streams of event data, the multiple candidate instances of the process, comprises: (1) generating weighted finite-state automaton (WFSA) from the process representation, the WFSA comprising states, edges between pairs of states, and weights associated with the edges, the states comprising a respective state for each of the activities in the process representation; and (2) identifying the multiple candidate instances of the process using the generated WFSA.

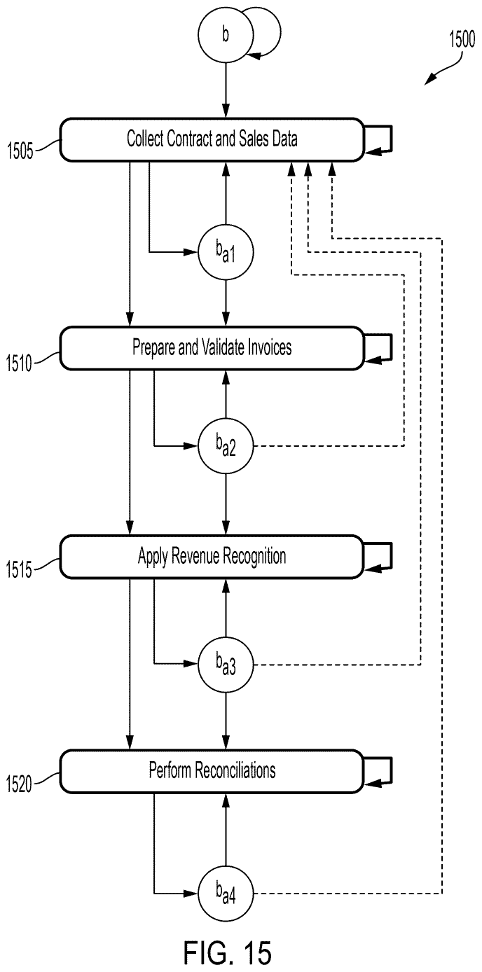

Accordingly, in some embodiments, the aligning pipeline 420 generates a weighted finite-state automaton (WFSA) from the process representation generated at act 312. FIG. 15 shows an example WFSA 1500 generated from the structured process model for the “Revenue Accounting Process”. The WFSA includes states, edges between pairs of states, and weights associated with the edges. The states include a respective state for each of the activities in process representation generated at act 312 (the structured process model). As shown in the example of FIG. 15, WFSA 1500 includes states 1505, 1510, 1515, and 1520 for the activities “Collect Contract and Sales Data,” “Prepare and Validate Invoices,” “Apply Revenue Recognition,” and “Perform Reconciliations”.

In some embodiments, the WFSA may be defined as follows:

A weighted finite-state automaton (WFSA) is a 3-tuple W=(S, E, w), where:
S is a finite set of states.
E⊆S×S is a finite set of weighted transitions (edges).
w:E→R is a weight function that assigns a real number weight to each transition.

Now let the activities A={a₁, . . . , a_{K}} from the process representation P=(A, R) represent activity states. Let S= A∪{b}∪{bₐ: a∈ A} be the WFSA state set consisting of each activity state, a global background state b, and per-activity background state bₐ.

The WFSA may then be built based on the process representation P=(A,R) as follows:
Add global background self-loop: b→b with cost 0.
Add entry edges: b→ a with cost −0.6 for each root activity (i.e., for activities that do not themselves depend on any other activities).
Intra-activity edges: a→ a (self) with cost −0.01; a→bₐ (exit) with cost −0.3; and bₐ→ a (resume) with cost −0.2.
Inter-activity edges: For each activity relation a→c (with cost −0.01), add bₐ→c with cost −0.2; for undirected relations also b_{c}→ a.

These costs may be considered as log-transition scores; they softly prefer short, linear progress while allowing background detours, such as briefly moving to a different application program while performing an activity. It should be appreciated that the costs or weights listed above are illustrative and non-limiting, as other costs or weights may be used in other embodiments.

In some embodiments, the aligning pipeline 420 obtains historical interaction data from interaction database 430. The historical interaction data includes multiple streams of event data, where each particular stream of event data includes a respective sequence of interaction steps performed by a respective particular user. The interaction database 430 may include streams of event data from any suitable number of users, as aspects of the technology described herein are not limited in this respect. Moreover, the interaction database 430 may include one or more streams of event data from the user who provided the natural language input at act 310 and/or one or more streams of event data from one or more users other than the user who provided the natural language input at act 310.

In some embodiments, in the context of the aligning pipeline 420, an interaction step may be represented as follows:

xₜ=(tₛₜₐₘₚ, app, description), where tₛₜₐₘₚ is the timestamp of the start of the interaction step, app is the active application program during the interaction step, and description is a textual description that describes the interaction step.

In some embodiments, the above representation for an interaction step may be generated for each of one or more (e.g., all) interaction steps in each of one or more streams of events in the multiple streams of events. Generating a representation for a particular interaction step may involve determining the time at which the particular interaction step took place (e.g., time it started, time it completed, any time in between, etc.), determining the application with which the user was interacting during the particular interaction step, and generating a textual description for the particular interaction step.

In some embodiments, the textual description for a particular interaction step may be generated not only using the information associated with the particular interaction step, but also using information associated with one or more other interaction steps that are related to the particular interaction step. In this way, a description of a particular interaction step may reflect the context in which the particular interaction step was taken during performance of the process.

For example, in some embodiments, a textual description for a particular interaction step may be generated by generating interaction text data by aggregating textual labels and metadata associated with: (i) the particular interaction step, and (ii) interaction steps related to the particular interaction step, and providing the interaction text data as input to a language model (e.g., an LLM) to obtain the textual description for the particular interaction step.

In some embodiments, related interaction steps may be determined according to one or more of the following criteria:
Application continuity: Consecutive interaction steps may be determined as being related if they occur within the same application (e.g., multiple interaction steps between a user and Microsoft WORD may be considered related since they all take place in the context of the same application program).
Screen similarity: Interaction steps may be determined as being related if the visible user-interface labels or textual elements on a user interface screen differ by no more than 50% between consecutive captured events, for example, as measured by a cosine similarity of their Term Frequency-Inverse Document Frequency (TF-IDF) feature vectors.
Temporal proximity: Interaction steps may be determined as being related if their combined duration does not exceed a threshold amount of time (e.g., one minute).

In some embodiments, a window of the related interaction steps may be created and the last interaction step in that window may be identified as being representative of the whole window. The textual labels and metadata (e.g., metadata indicating interacted-with fields, screen names, application names, etc.) associated with that event may be provided as input to the language model (e.g., an LLM, for example, the OpenAI's GPT-4o-mini language model) together with the following instruction:
“Describe What the User is Doing in One Clear Sentence.”

In turn, the language model processes this input to produce a natural-language statement that characterizes the activity performed by the user within that window of events corresponding to interactions. The resulting description serves as the textual description for xₜ.

In some embodiments, step-activity scores may be determined for pairs of interaction steps and activities represented by states in the WFSA. Each particular stream of event data includes a respective sequence of interaction steps performed by a respective particular user. For each particular sequence of interaction steps among at least some of the sequences of interaction steps in the multiple streams of event data, a step-activity score may be determined for each pair of an interaction step from the particular sequence of interaction steps and an activity represented by a state in the WFSA.

In some embodiments, for each interaction step xₜ and activity state aₖ, a step-activity score e_{t,k}∈[0,1] may be computed by combining two or more of the following scores: semantic similarity score, symbolic score, and cross-encoder similarity score.

In some embodiments, the at least some sequences of interaction steps comprise a first sequence of interaction steps, where the first sequence of interaction steps comprise a first interaction step, and the WFSA comprises a first state associated with a first activity. A first step-activity score for the first interaction step and the first activity may be determined at least in part by: determining a semantic similarity score for the first interaction step and the first activity; determining a symbolic score for the first interaction step and the first activity; optionally, determining a cross-encoder similarity score for the first interaction step and the first activity; and determining the first step-activity score as a weighted combination of the semantic similarity score, the symbolic score, and, optionally, the cross-encoder similarity score.

In some embodiments, determining the semantic similarity score includes embedding the textual description for the first interaction step using a trained text embedding model to obtain a first embedded vector, embedding a textual description of the first activity using the trained text embedding model to obtain a second embedded vector, and determining the semantic similarity score using the first embedded vector and the second embedded vector.

In some embodiments, the semantic similarity score may be computed by:

$${s}_{t , k}^{sim} = \frac{〈 ϕ ( {x}_{t} ) , ϕ ( {a}_{k} ) 〉 + 1}{2}$$

where φ(⋅)∈R^{dim} is the embedding model that maps any sentence to a multi-dimensional vector; and [symbol] ⋅,⋅ [symbol] denotes the inner product.

$${s}_{t , k}^{sim} ∈ [ 0 , 1 ]$$

quantifies how likely an interaction step xₜ belongs to an activity state aₖ. For example, if the interaction step xₜ is about “Editing an invoice in an Excel sheet” and the activity aₖ is about “Preparing and validating invoices with all required fields using Excel and Acrobat,” then

$${s}_{t , k}^{sim}$$

can be expected to be closer to 1.

In some embodiments, the trained text embedding model may be OpenAI's text-embedding-3-small model to encode the textual descriptions into numerical vectors. Each resulting embedded vector is a 1536-dimensional vector. It should be appreciated that any other trained text embedding models may be used in this respect. Additionally, the embedding may be into a space of any other suitable dimension (e.g., 256, 512, 1024, 3072-dimensional), thus a different dimensional embedding may be used without departing from the scope of this disclosure.

In some embodiments, determining the symbolic score comprises determining the symbolic score using a measure of similarity between an application program associated with the first interaction step and one or more applications programs associated with the first activity. The application program associated with the first interaction step is the application program in which the interaction occurred.

In some embodiments, the symbolic score may be computed by:

$${s}_{t , k}^{struct} = g ( app ( {x}_{t} ) , apps ( {a}_{k} ) ) ,$$

where g measures the maximum similarity of the application program associated with the interaction step xₜ, given by app(xₜ), with respect to any of the applications associated with the activity aₖ, given by apps(aₖ). For example, if app(xₜ) is “Acrobat”, and apps(aₖ) is “Excel and Adobe Acrobat”, then

$${s}_{t , k}^{struct}$$

returns a score close to 1.

In some embodiments, symbolic scoring may determine the best per-app similarity using fuzzy string and token comparisons across four (weighted) facets: brand (0.45), product (0.25), token/label similarity (0.20, taking the max of token-set Jaccard and canonical label similarity), and raw normalized label similarity (0.10); exact matches yield 1.0 immediately. This weighted similarity in [0,1] is then linearly mapped and clamped to a score via (1.5·sim −0.4)∈[−0.5,1.0], so strong app matches provide a positive boost and clear mismatches can penalize. In some embodiments, fuzzy string matching may be performed using the ‘RapidFuzz’ Python library. It should be appreciated that the foregoing weights are illustrative and other values may be used in some embodiments.

In some embodiments, the optional cross-encoder similarity score may be computed by:

$${s}_{t , k}^{ce} \approx {f}_{cross} ( {x}_{t - 2 … t + 2} , {a}_{k} )$$

where f_{cross} is a neural model that takes two inputs and similarly assigns a score in [0,1]. The overall idea is the same with respect to the semantic similarity score. However, in contrast to the semantic similarity score, where interaction steps and activities are embedded independently, cross-encoder models are specialized models that simultaneously process both inputs to measure similarity. The trade-off is that cross encoders are computationally more expensive to compute and for that reason, for each interaction step xₜ,

$${s}_{t , k}^{ce}$$

is only computed for the top-k activities using the scores

$${s}_{t , k}^{sim} .$$

Finally, the input to the cross encoder is not just the step xₜ but xₜ−2_{. . . t+2}, which includes neighboring steps, as context, to assess the likelihood of the step xₜ belonging to the activity aₖ.

In some embodiments, a cross-encoder model comprises a BAAI's bge-reranker-v2-m3 model, which is a lightweight, multilingual reranker model used to improve the relevance of search results by re-ranking a list of items based on a query. In this case, given the steps xₜ−2_{. . . t+2} and activity aₖ, the model is queried to measure how likely the step xₜ belongs to the activity aₖ using additional step context in xₜ−2_{. . . t+2}. Though it should be appreciated that other models may be used in other embodiments.

In some embodiments, the first step-activity score e_{t,k}∈[0,1] is a convex combination given by

$${e}_{t , k} = {w}_{sim} {s}_{t , k}^{sim} + {w}_{ce} {s}_{t , k}^{ce} + {w}_{struct} {s}_{t , k}^{struct} ,$$

with defaults (wₛᵢₘ,w_{ce},w_{struct})=(0.4,0.3,0.3) when a cross-encoder is enabled and (0.4,0,0.6) otherwise. Other weights may be used in other embodiments.

Thus far, for each interaction step xₜ and activity states aₖ, a step-activity score is determined. However, the WFSA also incorporates background states and background scores for each interaction step xₜ may be determined as is described next.

For background, a soft inverse of the best foreground (activity) score is used, that is,

$${e}_{t}^{b g} = {η ( 1 - {max}_{j} {e}_{t , j} )}^{γ} , η ∈ ( 0 , 1 ] , γ > 0 .$$

favoring background when all activity scores are weak.

In some embodiments, identifying the multiple candidate instances of the process may include identifying, using dynamic programming, the multiple candidate instances using the step-activity scores for pairs of interaction sets and activity states and the weights associated with the edges of the WFSA.

In some embodiments, the dynamic programming comprises determining a sequence of interaction steps (xᵢ,xᵢ₊₁, . . . , xⱼ₋₁,xⱼ) that not only match the activities of the process representation, but also respect the relationships among the activities.

In some embodiments, a state label (activity or background) may be assigned to each interaction step xₜ as to optimize (e.g., maximize) the global score of the given sequence of steps x_{1 . . . T}. This problem is known as the global alignment problem in Hidden Markov Models.

Let w(p→q) denote the (log) transition cost or weight in the WFSA. A global alignment of the full sequence may be decoded by allowing variable-length segments in a single state, which yields a semi-Markov dynamic program. Let F[t,q] be the best total score to explain steps x_{1 . . . t} ending in state q; then

$$F [ t , q ] = {{max}_{1 \leq L \leq {L}_{max}}}_{p ∈ Pred ( q )} ( F [ t - L , p ] + w ( p \to q ) + {\sum }_{τ = t - L + 1}^{t} {e}_{τ , q} + ℓ ( L \vert q ) ) , \qquad ( 1 )$$

where e_{τ,q} is the step-activity score for step x_{τ} in state q (with q=b using e_{τ}^{bg}), and l(L|q) is an optional segment-length prior. Initialize F[0,b]=0 and F[0,q=/b]=−∞, then backtrack from argmax_{q}F[T,q] to obtain segments (s,e,q).

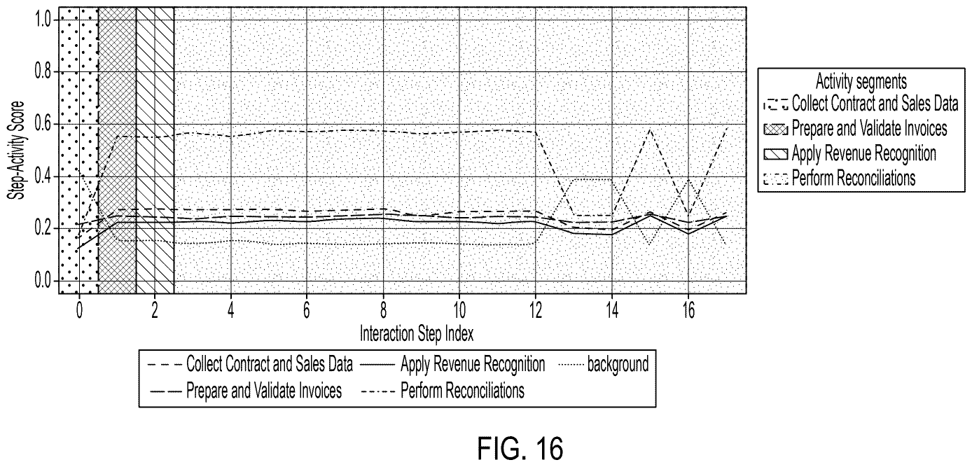

The algorithm complexity is O(T|S|Lₘₐₓ+|E|T) in time and O(T|S|) in space, where T is the total number of interaction steps, |S| is the number of states in the WFSA, |E| is the total number of transition edges in the WFSA, and Lₘₐₓ is the maximum segment length for a single state. A synthetic example is shown in FIG. 16.

After assigning optimal state labels (activity or background) for each step xₜ, the whole sequence of interaction steps x_{1 . . . T} may be cut into chunks that match the process representation P. To do so, contiguous interaction steps that were labeled to the same state may be concatenated into activity segments. Then a search is performed for activity segments that traverse the activities of the process representation by following the process transitions. For any valid traverse, the activity segments are stored as a valid candidate instance of the process. In this case, a ‘soft’ final validation may be used in that if there are activity segments that are valid traverses of the process flow but do not cover all activities of the process, then as long as 70% of the process activities are covered by the activity segments, these activity segments are considered valid candidate instances of the process.

In some embodiments, after identifying, using dynamic programming, the multiple candidate instances using the step-activity scores and the weights associated with the edges of the WFSA, the multiple candidate instances may be ranked based on their respective average step-activity scores and a number of candidate instances may be selected based on their ranking.

In some embodiments, the number of candidate instances selected based on their ranking is twenty although the disclosure is not limited in this respect and lower or higher number of candidate instances (e.g., 5, 10, 15, etc.) may be selected. In some embodiments, a candidate instance reranking step may be performed, as described below.

In some embodiments, a measure of confidence and textual workflow summary may be generated for at least some of the candidate instances. In some embodiments, for each candidate instance, the following steps may be performed:
1. For each activity, an LLM (via dspy.Predict) may be prompted with: (1) A structured activity definition (in JSON format from the structured process model) and (2) the observed interaction steps for that activity rendered as a short list. The LLM returns a probability and a brief explanation. Finally, the activity-level confidences are combined using a geometric mean to get an overall activities confidence.
2. Separately, the LLM is asked to rate the overall candidate instance's plausibility using the process overview (in JSON format with process name and activities) plus a textual workflow summary (span, total step-activity score and an activity breakdown). That returns a candidate instance-level probability and explanation.
3. The final confidence is then computed as 0.7 activities confidence+0.3·candidate instance confidence. An ‘insight’ is generated, and candidates are re-sorted by the new confidence (optionally filtered by a minimum threshold).

An example of activity-level LLM based assessment is provided below:

| | |
|---|---|
| • | activity_definition (JSON) |
| | { |
| | “label”: “activity_1”, |
| | “title”: “Collect Contract and Sales Data”, |
| | “description”: “Gather contract and sales data into an Excel sheet.”, |
| | “apps”: [“excel”], |
| | “keywords”: [“data collection”, “Excel”] |
| | } |
| • | activity_steps (text) |
| | Activity: activity_1 |
| | - Open Excel workbook for the monthly contracts |
| | - Copy sales entries from source CSVs |
| | - Normalize columns and save the workbook |
| • | LLM output |
| | { |
| | “probability”: 0.83, |
| | “explanation”: “All steps focus on gathering and organizing contract/sales data in Excel.” |
| | } |

An example of candidate instance-level LLM based assessment is provided below:

| | |
|---|---|
| • | process_overview (JSON) |
| | { |
| | “process_name”: “Revenue Accounting Process”, |
| | “activity_count”: 5, |
| | “activities”: [“activity_1”, “activity_2”, “activity_3”, “activity_4”, “activity_5”] |
| | } |
| • | workflow_summary (text) |
| | Workflow span: Steps 45 to 68 |
| | Total step-activity score: 23.20 |
| | Activity breakdown: |
| | - activity_1: score=0.79, time_spent=3.4s |
| | - activity_2: score=0.72, time_spent=2.1s |
| | - activity_3: score=0.75, time_spent=4.6s |
| | - activity_4: score=0.69, time_spent=3.0s |
| | - activity_5: score=0.64, time_spent=2.5s |
| • | LLM output |
| | { |
| | “probability”: 0.62, |
| | “explanation”: “Sequence follows the modeled flow from data collection to reconciliation |
| | and archiving; minor gaps in invoice validation detail.” |
| | } |

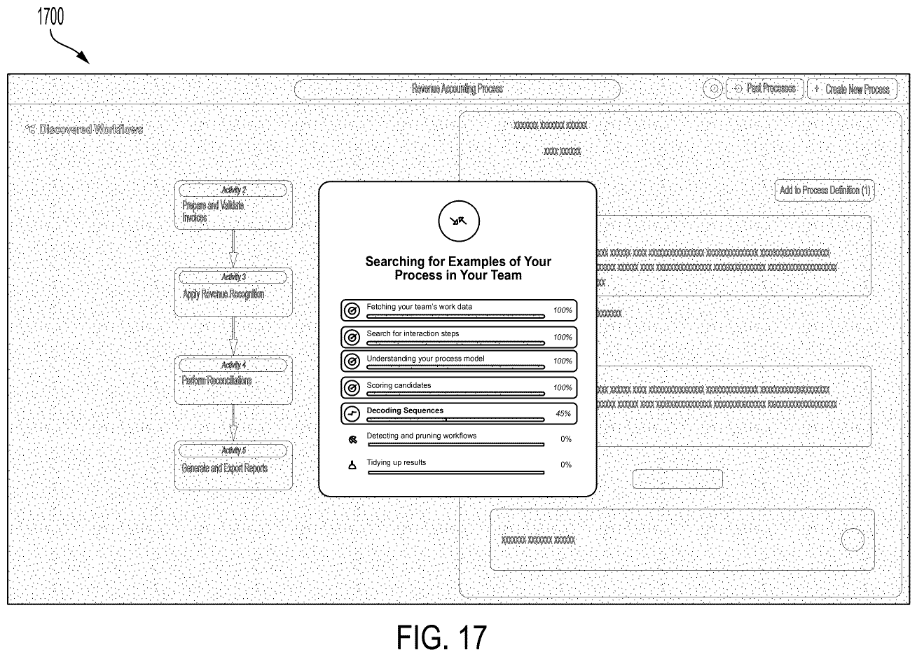

In some embodiments, the aligning pipeline 420 may perform the steps shown in Algorithm 1 below, though it should be appreciated the aligning pipeline 420 may operate differently in other embodiments. For example, in some embodiments, the re-ranking step may be omitted. As another example, in some embodiments, the preprocessing (of step 2) whereby information is obtained about individual interaction steps (e.g., metadata associated with the various steps) may have been previously performed rather than as part of Algorithm 1. FIG. 17 is a screenshot of an example GUI 1700 presented to a user while the aligning pipeline is performing the steps below.

Algorithm 1 Aligning Pipeline

1: Input: Structured process P, interaction steps x_{1:T}
2: steps ← preprocess(x_{1:T})
3^{:} W ← build_wfsa(P)
4: scorer ← HybridScorer(steps, P)
5: segments ← semiMarkovDecode(steps, W, scorer)
6: workflows ← detectWorkflows(segments, thresholds)
7: workflows ← rerank_with_agent(workflows, P)
8: return workflows

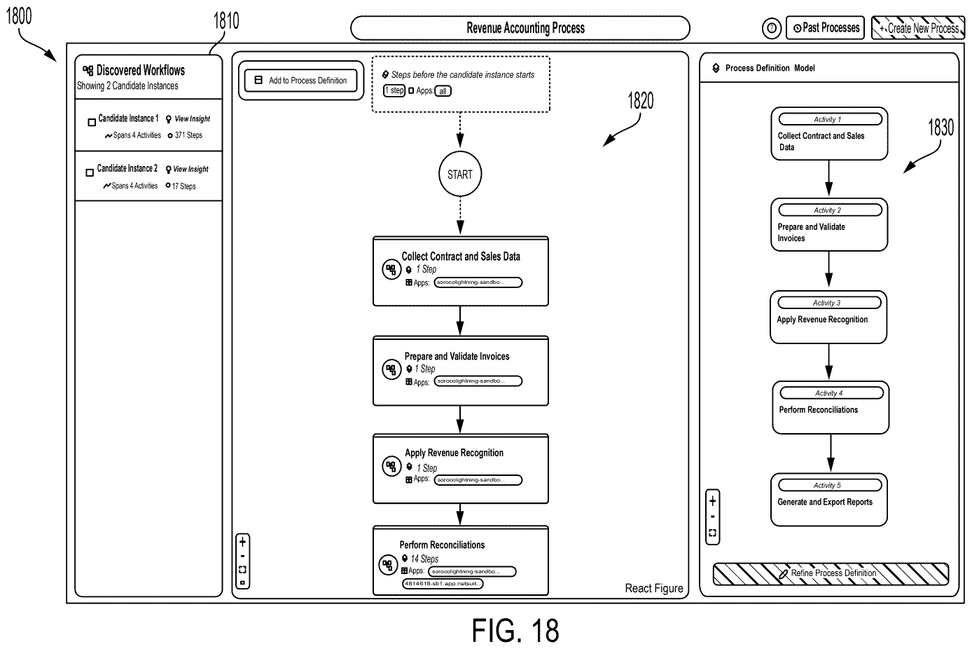

In some embodiments, the candidate instances identified by the aligning pipeline 420 are presented to a user in an instance visualizer 440. FIG. 18 is a screenshot of example GUI 1800 that includes a list of candidate instances 1810, where each candidate instance can be clicked for inspection. GUI 1800 is a GUI for visualizing and/or interacting with discovered workflows. As shown in FIG. 18, GUI depicts two identified candidate instances on the left-hand side under the “Discovered Workflows” heading. The middle panel of GUI includes a canvas that displays a visualization 1820 of the selected candidate instance (e.g., candidate instance 2 in listing 1810) where each node in the visualization relates to one of the activities from the structured process model 1830, which is displayed on the right-hand side as a reference.

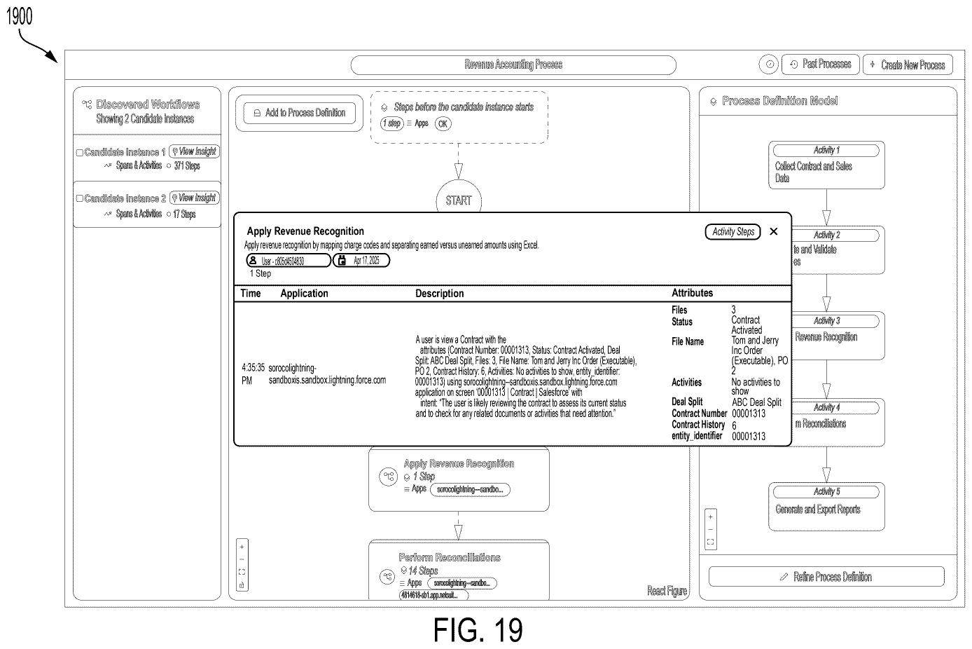

The user can click on each node of the candidate instance visualization to inspect the actual interaction data. FIG. 19 shows a screenshot of an example GUI 1900 where interaction data is displayed after the user clicks on “Apply Revenue Recognition” node.

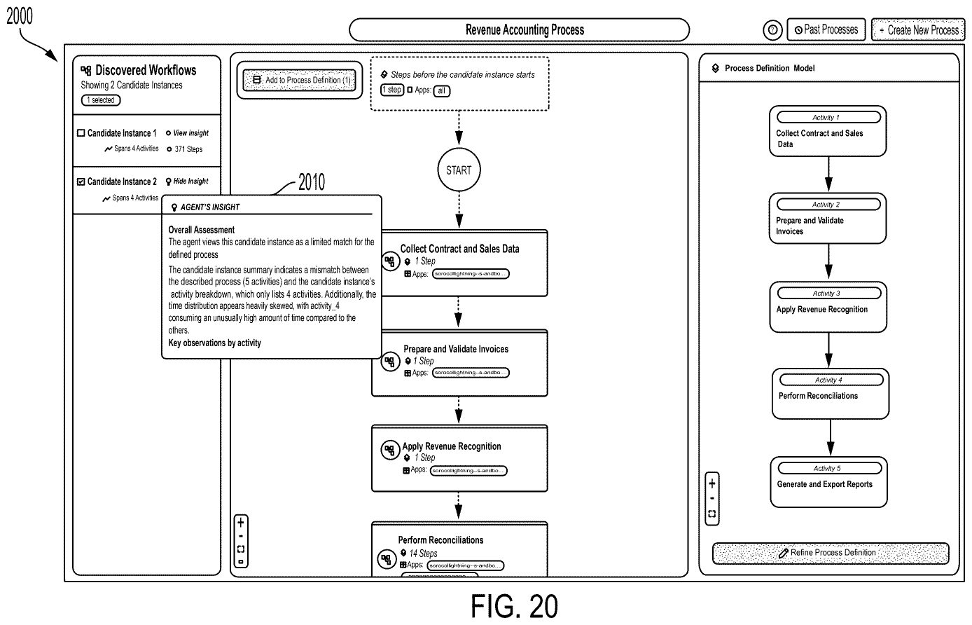

In some embodiments, an insight is generated for each candidate instance. The insight provides an explanation of how the candidate instance matches with the structured process model. FIG. 20 shows a screenshot of an example GUI 2000, where insight 2010 is provided.

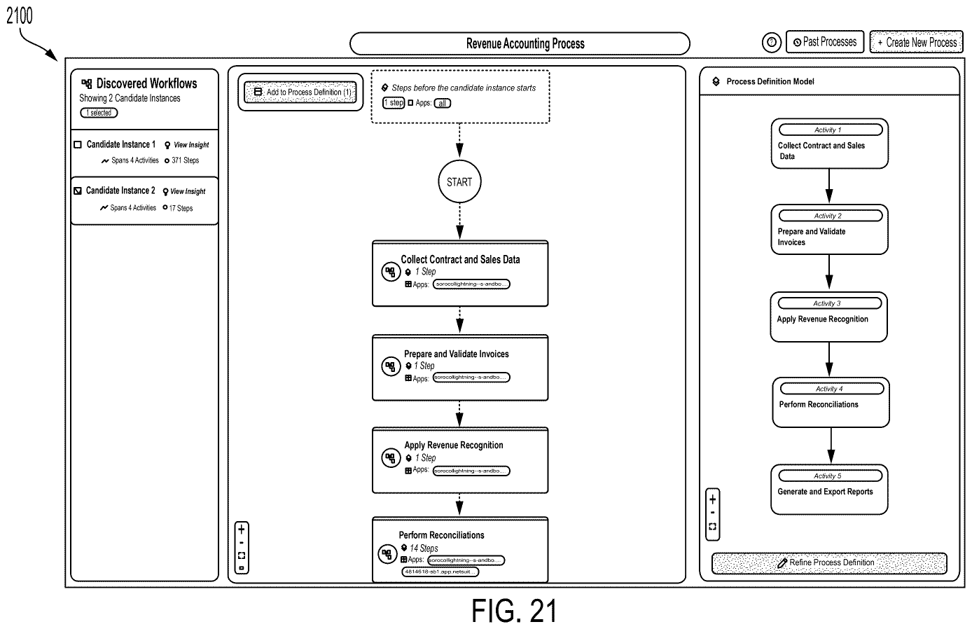

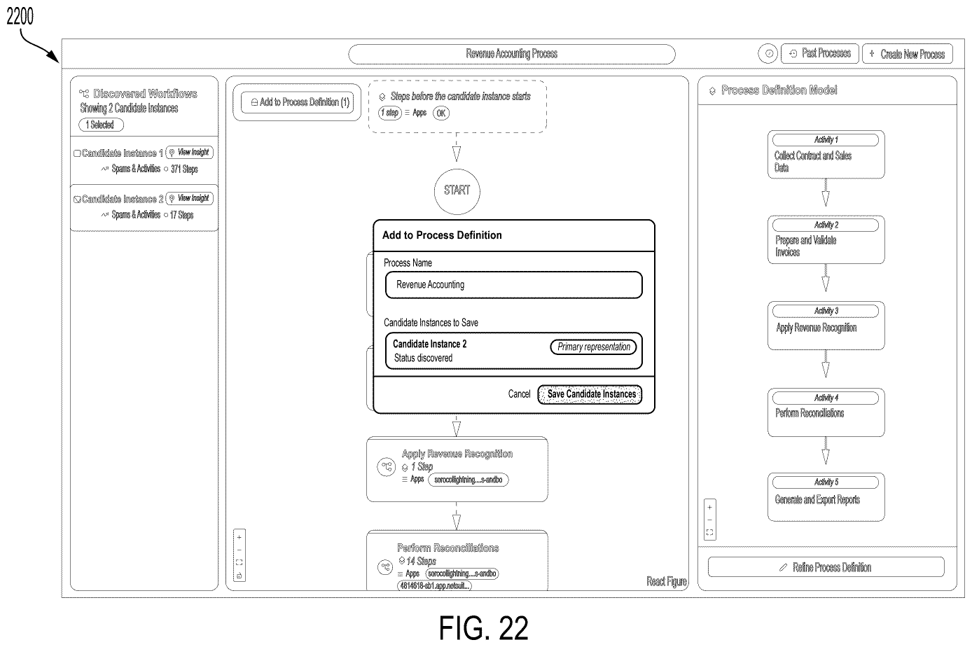

In some embodiments, at least one of the multiple candidate instances may be selected, based on user input. FIG. 21 is a screenshot of example GUI 2100 where a user selection of candidate instance 2 is received indicating that the user agrees that the selected candidate instance accurately represents the structured process model. The selected at least one candidate instance may be stored as at least one confirmed instance of the process. In some embodiments, a visualization the at least one confirmed instance of the process may be generated. FIG. 22 is a screenshot of example GUI 2200 where a dialog box is presented for the user to input a process name for the selected candidate instance and select the “save” button to store the selected candidate instance in a process library or database.

### Using Interaction Step-Level Process Representations to Identify Process Instance(s)

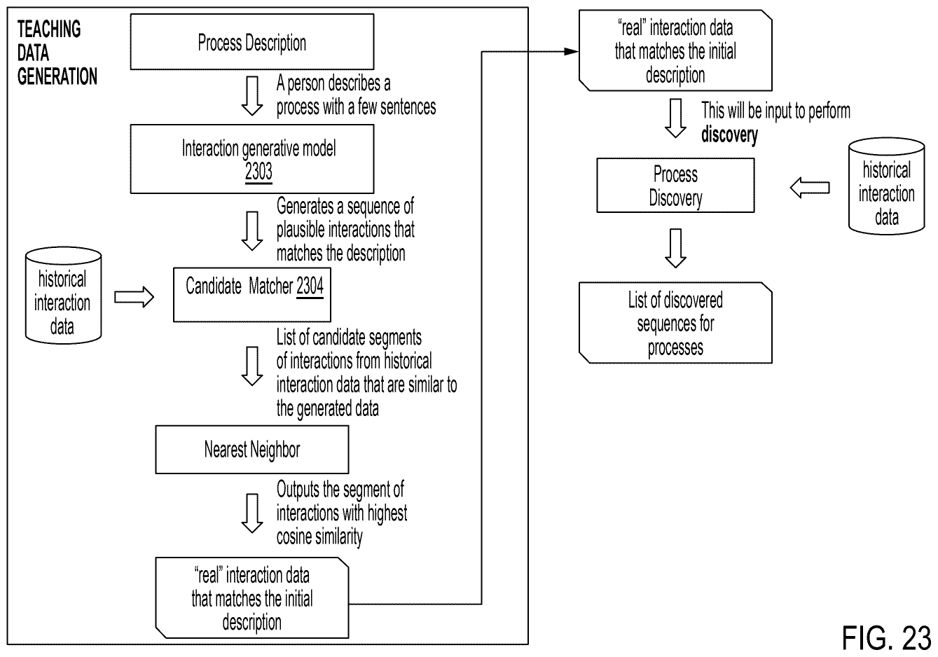

As discussed above with respect to FIG. 3, in another embodiment, the process representation generated may be an interaction step-level representation. In this embodiment, acts 312 and 314 are respectively performed by the interaction generative model 2303 and candidate matcher 2304 of FIG. 23. In some embodiments, the process representation is generated at least in part by using the interaction generative model 2303 to process the natural language input describing the process. The interaction generative model 2303 comprises an LLM that is prompted with the natural language input to obtain an output indicating a sequence of interaction steps. In some embodiments, based on the provided natural language input, the LLM generates a plausible sequence of interaction steps that matches the natural language input describing the process. These interaction steps represent a “hypothesis” for what the described process might look like. Because the interaction generative model 2303 generates plausible interaction steps, rather than a list of activities (each of which may involve numerous interaction steps), the model 2303 may be considered to generate an interaction step-level representation.

In some embodiments, the LLM output indicates for each interaction step in the sequence of interaction steps: a description of an interaction, an application used to perform the interaction, a screen name, an element name, and/or an indication of time spent during the interaction. It will be appreciated that any one, two, three, four, or all of these items may be indicated in the output without departing from the scope of this disclosure. Fewer or more items for an interaction step may be indicated in the output, as aspects of the technology are not limited in this respect.

In some embodiments, generating an interaction step-level process representation, from natural language input describing a process, comprises generating a prompt from the natural language input and prompting the LLM (of model 2303) with the generated prompt to obtain the interaction step-level process representation. In some embodiments, the prompt includes a schema specifying format of output to be generated by the LLM, and providing the prompt as input to the LLM. An example schema is provided below:

$$DESCRIPTION = … \vert APPLICATION = … \vert SCREEN\_NAME = … \vert ELEMENT\_NAME = … \vert TIME\_SPENT = …$$

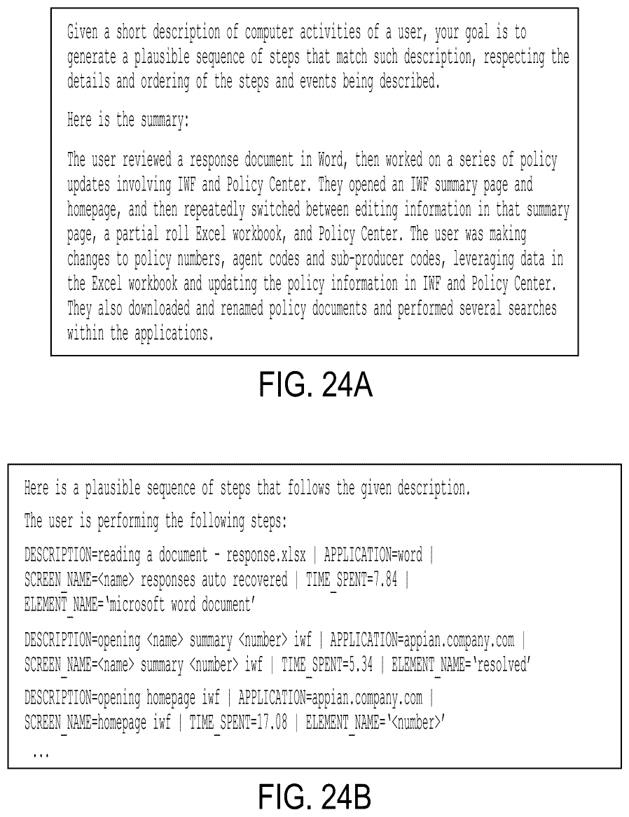

FIG. 24A shows an example of the natural language input provided as input to the LLM and FIG. 24B shows an example of the output provided by the LLM indicating the sequence of interaction steps. FIG. 24B shows three interaction steps in the sequence formatted according to the schema above.

In some embodiments, a 2-message prompt per episode (system+user) may be provided. System prompt anchors the role:
“You are a business process consultant who can explain and generate digital interactions in business processes . . . You serve . . . <Company> . . . <Team> . . . ”
User message template (key excerpt):
“Given a description . . . generate a plausible sequence of interactions that fully follow the given description. Importantly, pay attention to the details and respect the ordering . . . Here is the description: {description}”

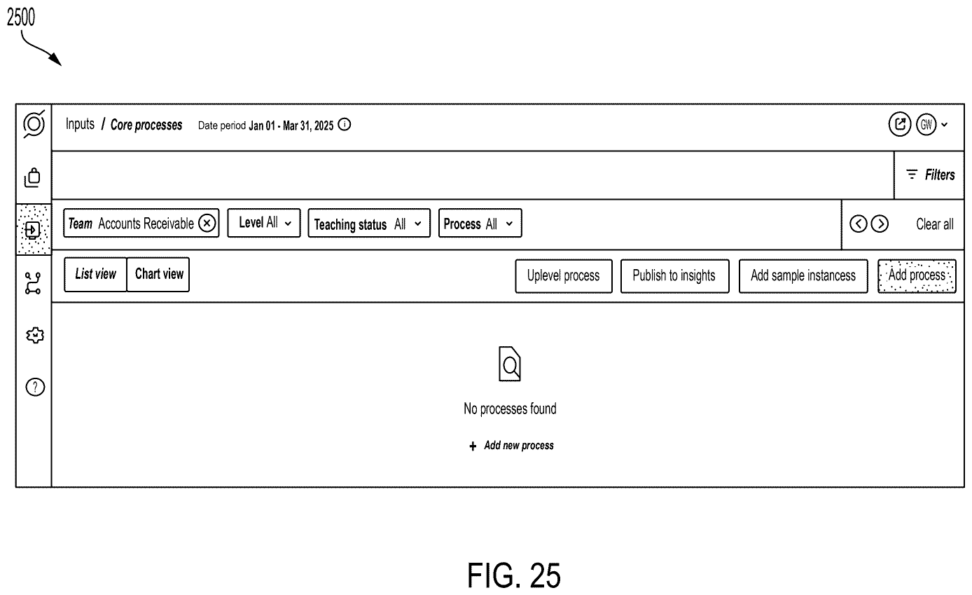

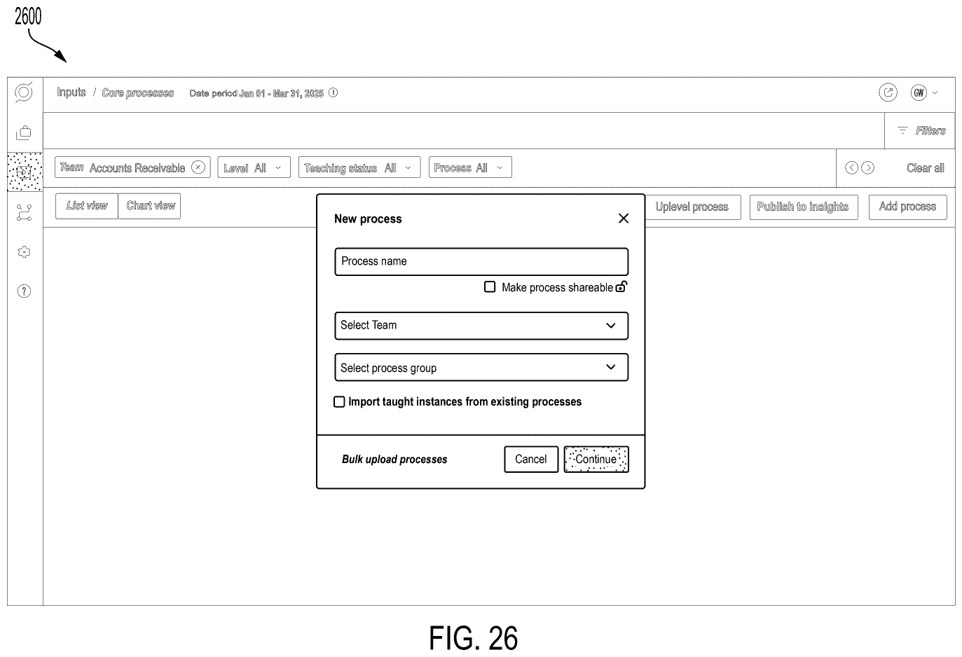

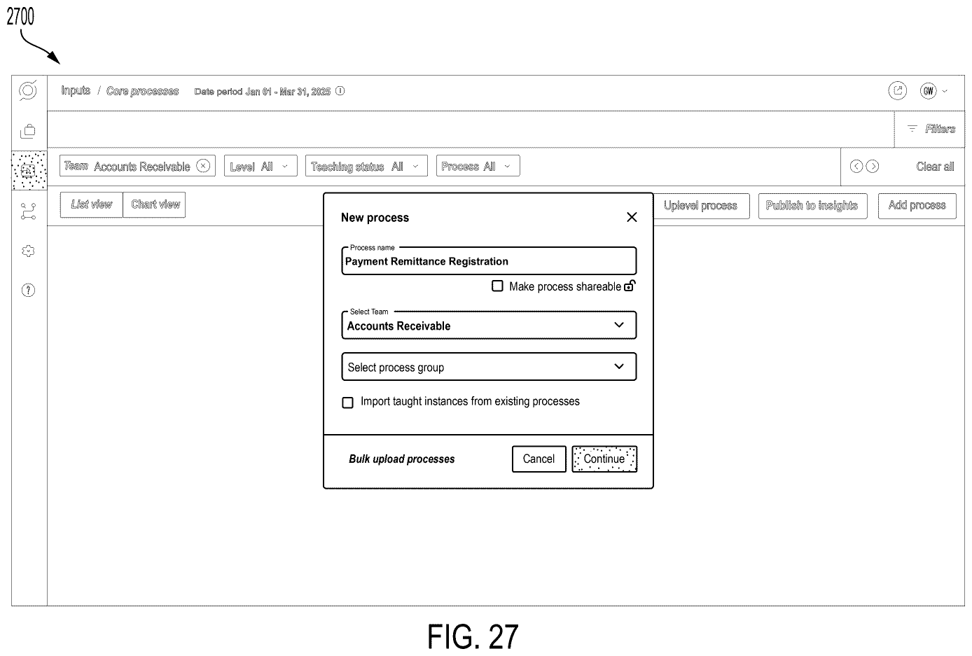

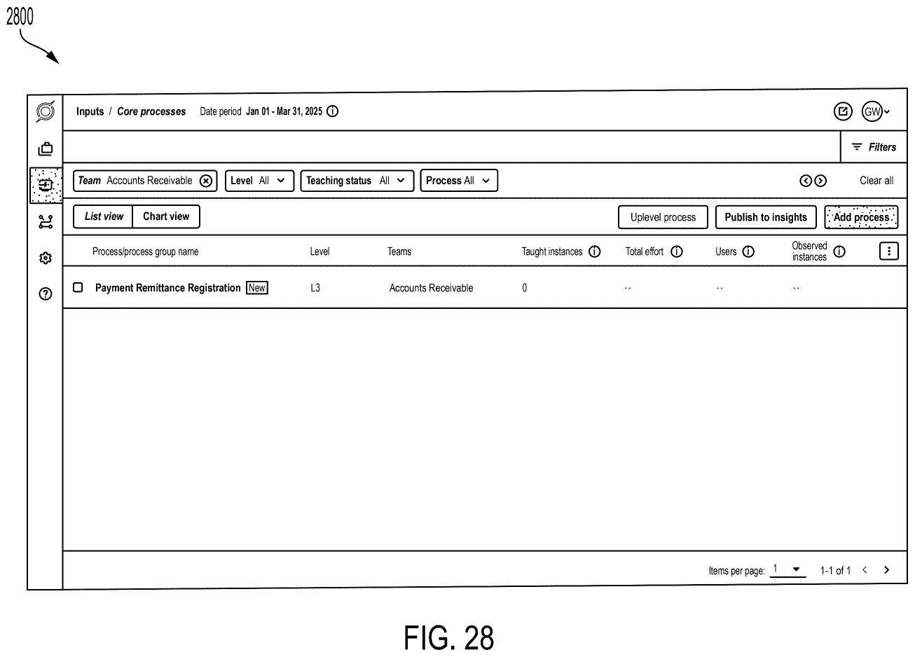

FIG. 25 is a screenshot of an example GUI interface 2500 that allows a user to click on the “Add process” button to initiate describing a process. FIG. 26 is a screenshot of an example GUI interface 2600 that allows a user to add information about the process, such as, name of the process, the team that is going to perform it, and any group to which the process should belong. FIG. 27 is a screenshot of an example GUI interface 2700 where the user has input the process name as “Payment Remittance Registration” and the team as “Accounts Receivable”. FIG. 28 is a screenshot of an example GUI interface 2800 that displays the added process. At this point, the process is only added by name and there is no understanding of how the process is performed.

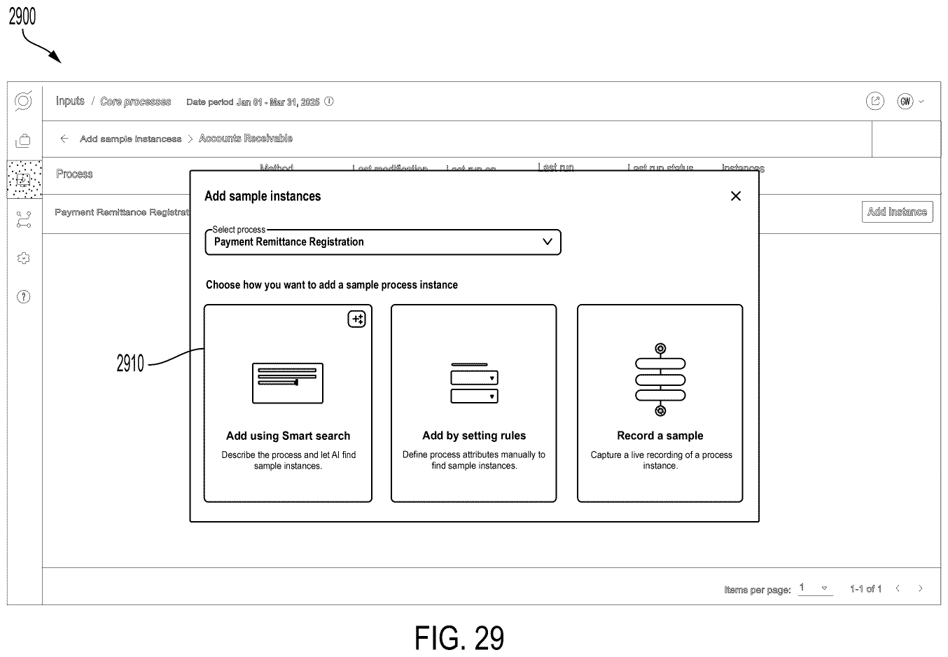

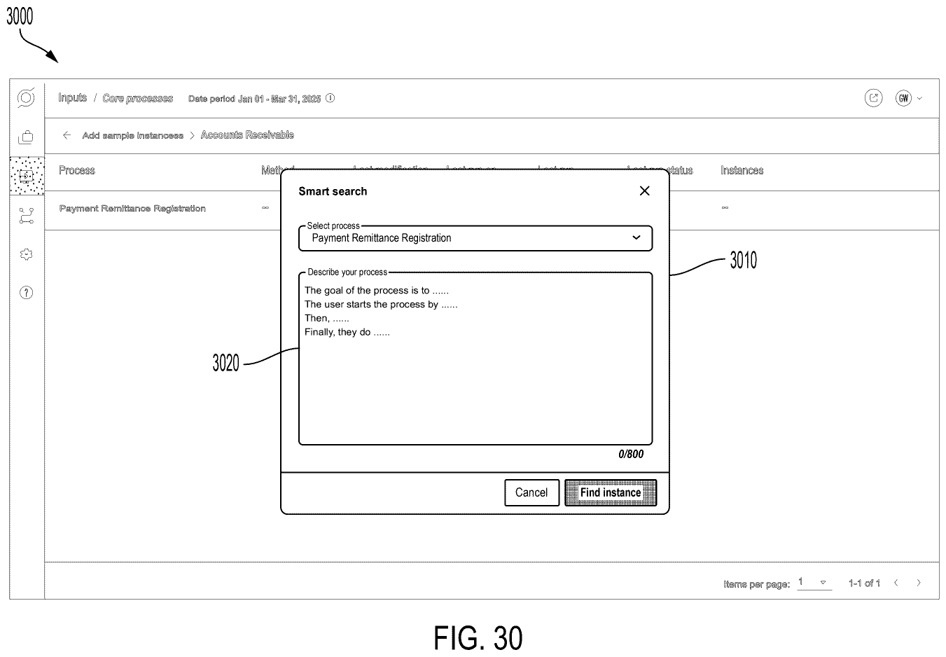

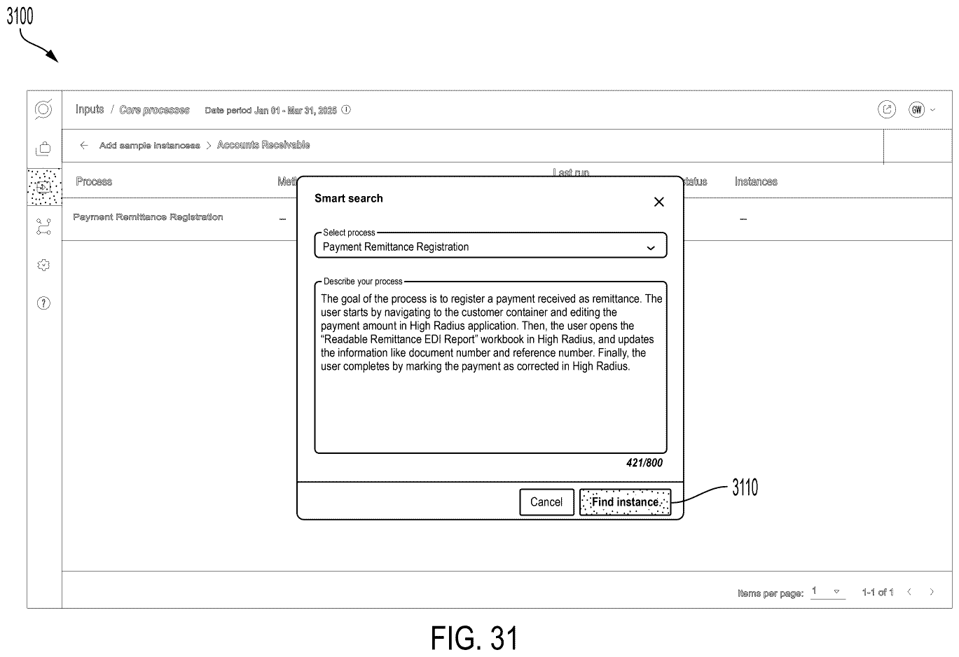

FIG. 29 is a screenshot of an example GUI 2900 that allows the user to provide natural language input describing the “Payment Remittance Registration” process. The user can do so by selecting “Add using Smart Search” GUI element 2910. Selection of GUI element 2910 causes a smart search dialog box 3010 to be presented as shown in GUI 3000 of FIG. 30. The user may enter the natural language input describing the process in the “Describe your process” text box 3020. In some embodiments, a template of the description may be provided to the user to assist the user in describing the process, though the user need not follow the exact template. The user can describe the intent of the process, how the process starts, the series of steps that are performed in the process, and a clarification regarding what some of the final steps in the process are. FIG. 31 is a screenshot of an example GUI 3100 that shows the natural language input describing the process as provided by the user. The natural language input shown in FIG. 31 is:
“The goal of the process is to register a payment received as remittance. The user starts by navigating to the customer container and editing the payment amount in High Radius application. Then, the user opens the “Readable Remittance EDI Report” workbook in High Radius, and updates the information like document number and reference number. Finally, the user completes by marking the payment as corrected in High Radius”

FIGS. 36A-36B are screenshots of other example GUIs 3600, 3610 for receiving natural language input describing a process.

Continuing this example, an LLM may be prompted with this natural language input to obtain an output indicating a sequence of interaction steps that match the natural language input. Referring back to FIG. 23, in some embodiments, the candidate matcher, using the sequence of interaction steps generated by the LLM and from among the multiple streams of events data, identifies multiple candidate sequences of interaction steps. In some embodiments, selection of the “Find Instance” button 3110 in FIG. 31 initiates the identification of candidate sequences of interaction steps.

In some embodiments, the candidate matcher generates, using at least one trained embedding machine learning (ML) model, a numeric representation corresponding to the generated sequence of interaction steps. The candidate matcher determines a measure of similarity between the numeric representation corresponding to the generated sequence and each of multiple stored and previously-determined numeric representations of respective windows of events in the multiple streams of event data in historical digital interaction data to obtain a plurality of measures of similarity. Details regarding generating numeric representations and measures of similarity are described in the section below titled “Techniques for User Guidance Through Process Discovery.”

In some embodiments, determining a measure of similarity may include determining a cosine similarity between the numeric representation corresponding to the generated sequence and each of the multiple stored and previously-determined numeric representations. In some embodiments, a similarity score may be obtained by computing the cosine similarity between the numeric representation corresponding to the generated sequence and each of the multiple stored and previously-determined numeric representations. The similarity score may be a value between 0-1, a higher score indicating a better match than a lower score.

In some embodiments, the determined plurality of measures of similarity may be used to identify candidate sequences of interaction steps in the multiple streams of event data whose determined measure of similarity to the generated sequence was greater than a first threshold (0.7 or 70%). Any suitable first threshold may be used. Further details regarding the generation of numeric representations, determining measures of similarity, and organizing events into windows are described in section titled “Techniques for User Guidance Through Process Discovery” below and PCT Application WO2024/214113.

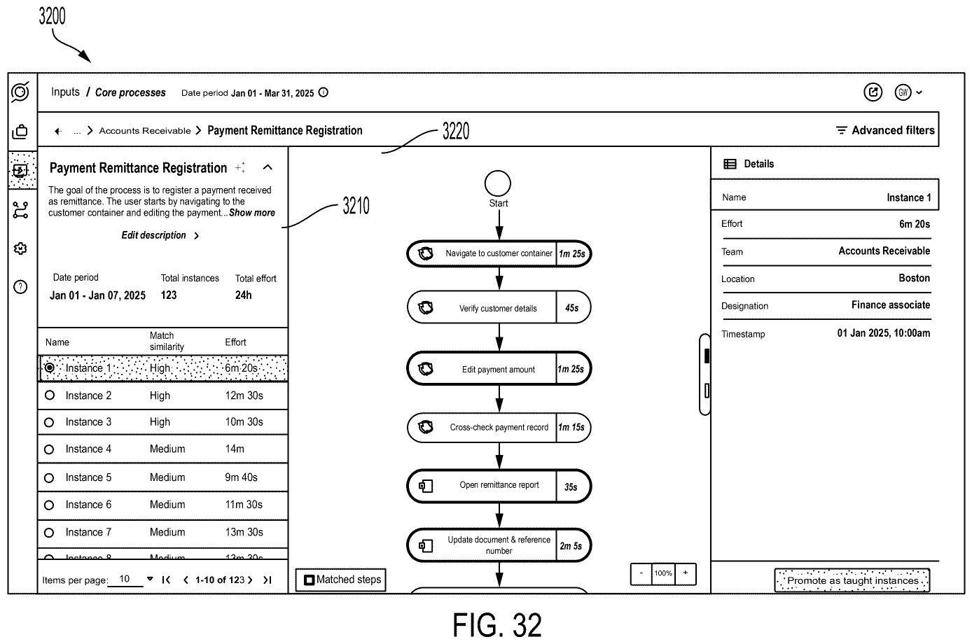

The candidate sequences of interaction steps, in this embodiment, correspond to multiple candidate instances of the process. The identified candidate instances may be presented to the user as shown in FIG. 32. FIG. 32 is a screenshot of example GUI 3200 that includes a list of candidate instances 3210, where each candidate instance can be clicked for inspection.

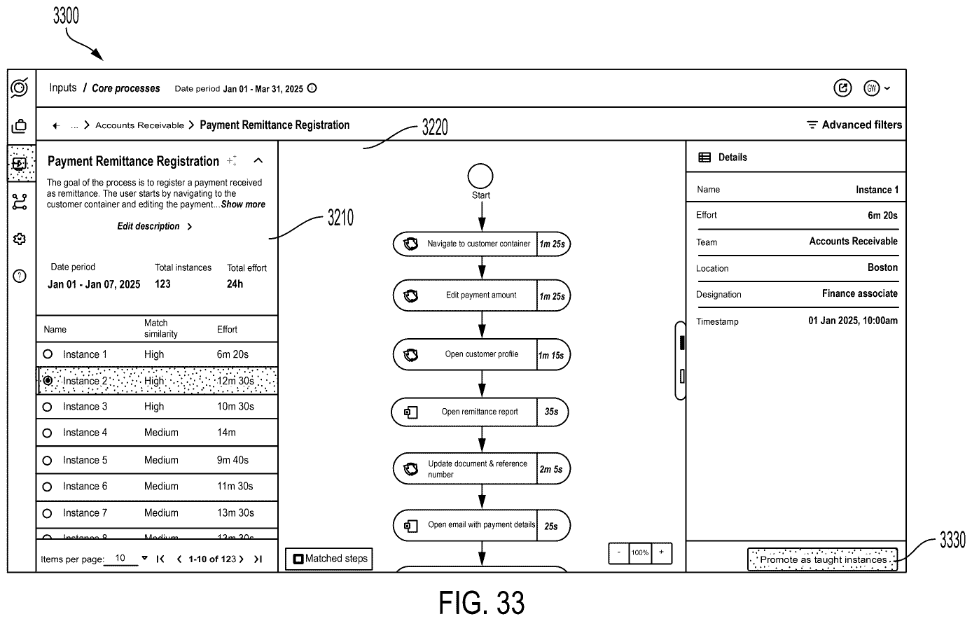

As shown in FIG. 32, GUI 3200 depicts a number of identified candidate instances on the left-hand side for the “Payment Remittance Registration” process. The middle panel of GUI includes a canvas that displays a visualization 3220 of the selected candidate instance (e.g., candidate instance 1 in listing 3210) with nodes in the visualization representing the sequence of interaction steps in that instance. The right-hand side of GUI 3200 displays details regarding the instance. FIG. 33 is a screenshot of example GUI 3300 in which the user selected candidate instance 2 from listing 3210, which causes the visualization 3320 of the candidate instance 2 to be displayed in the middle panel.

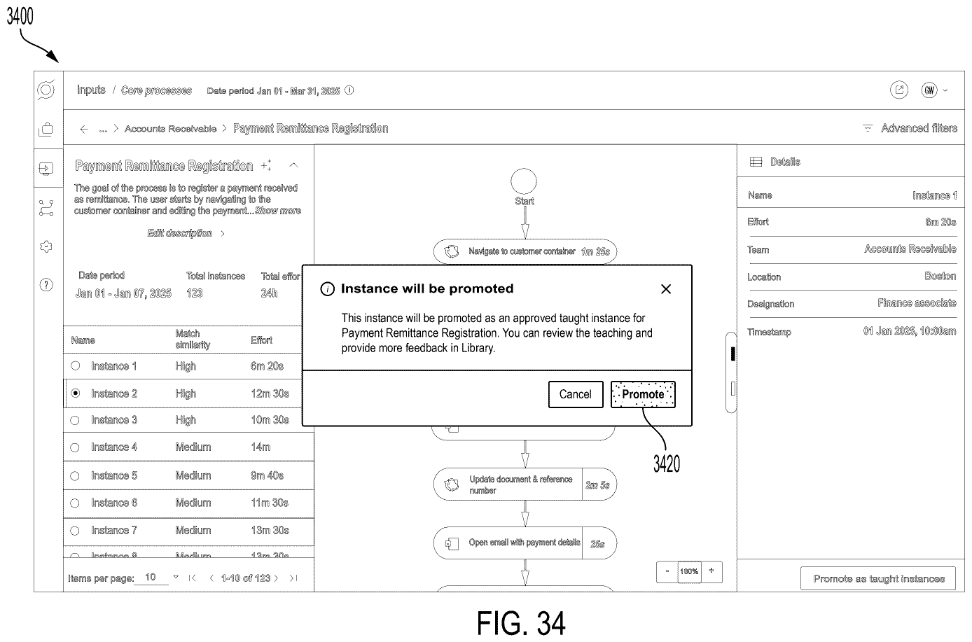

In some embodiments, at least one of the multiple candidate instances may be selected, based on user input. For example, the user can review candidate instance 2 in FIG. 33 and determine that it indeed accurately matches the natural language input describing the process. The user may then click the “Promote as taught instances” button 3330, which causes a dialog box of FIG. 34 to be displayed. User selection of the “Promote” button 3420 in the dialog box causes the selected candidate instance may be stored as a confirmed instance of the process. This confirmed instance of the process may be considered as a confirmed taught instance of the process, which can then be used for process discovery as shown in FIG. 23. Enabling user review mitigates the risk of possible hallucinations of the model predicting or generating incorrect instances.

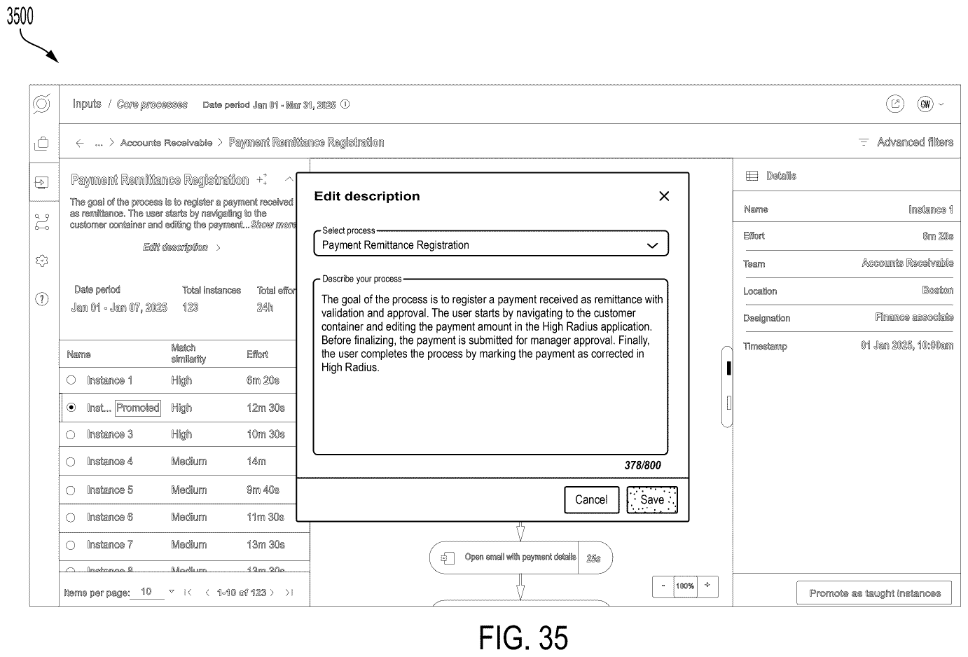

In some embodiments, the natural language input describing the process may be edited as shown in GUI 3500 of FIG. 35. Multiple candidate instances of this edited process may then be identified using the techniques described in this section.

With any generative model, though, it is possible that the model hallucinates which in this case may be, for example, generating a screen title that does not exist in practice or using a particular application that was not in the process description. To mitigate this effect, candidate matching is used. That is, to take the sequence of interaction steps generated by the generative model (also referred to as synthetic sequence of interaction steps) and identify sequences in the multiple streams of event data (also referred to as real interaction data) that may be similar to that generated sequence, and then use an identified sequence instead of the generated sequence for purposes of process discovery. By identifying candidate instances from real interaction data that are similar to the generated sequence, the candidate matcher can avoid any hallucinated interactions steps in the generated interaction step-level process representation. It will be appreciated that the candidate matching step may be optional when a generative model capable of generating accurate sequences of interaction steps is used.

In some embodiments, the LLM used to generate an interaction step-level process representation (the LLM part of interaction generation model 2303) may be trained at least in part by accessing a baseline LLM model, generating training data comprises pairs of natural language input and corresponding outputs, and fine-tuning the baseline LLM model using the generated training data. The training data may be generated by (i) selecting, at random, interaction sequences part of the multiple streams of event data, (ii) using the baseline LLM model to generate, as inputs, natural language prompts from the selected interaction sequences, and (iii) using the selected interaction sequences as outputs in the training data corresponding to the natural language prompts. In some embodiments, the interaction sequences are filtered to exclude interactions related to “switching” application programs to reduce the number of tokens to be processed. In some embodiments, the selected interaction sequences may include a minimum of 15 interactions and a maximum of 100 interactions although the disclosure is not limited to these numbers of minimum and maximum interactions.

In some embodiments, the baseline LLM model is the base Llama 3-70B model, a base Llama 3.1-8B model or any other suitable model. In some embodiments, the fine-tuning is performed using group relative policy optimization (GRPO) described and low-rank adaptors (LORA). GRPO is described in article titled “DeepSeekMath: Pushing the Limits of Mathematical Reasoning in Open Language Models,” by Shao et al., arXiv:2402.03300 (April 2024), which is incorporated by reference herein in its entirety. LORA is described in article titled “LoRA: Low-Rank Adaptation of Large Language Models,” by Hu et al., arXiv:2106.09685 (2021), which is incorporated by reference herein in its entirety. In some embodiments, 1942 natural language prompts were collected, and 1553 samples were used for fine-tuning although the disclosure is not limited these numbers.

In some embodiments, reward during GRPO fine-tuning includes a format compliance reward component, an application consistency rewards component, and a redundancy penalty reward component. Rewards operate on model completions by extracting lines that begin with DESCRIPTION=and parsing fields with a strict regex. The reward components during training may include one or more of the “format compliance”, “application consistency”, and “redundancy penalty” components:

Format compliance—fraction of lines matching the strict schema via regex.

$$Validates every generated line matches the schema$$

$$DESCRIPTION = … \vert APPLICATION = … \vert SCREEN\_NAME = … \vert ELEMENT\_NAME = … \vert TIME\_SPENT = …$$

$$Score is fraction of compliant lines in the completion ∈ [ 0 , 1 ] .$$

$$Training weight : + 0.5 \times score .$$

Application consistency—average of (coverage of described application programs) and (1-extra-apps rate in generations), after mapping to normalized application buckets.
Extracts application programs referenced in the description (via string patterns+normalization to common application buckets) and compares to the application programs present in the generated interactions.
Blends coverage and precision:

$$Coverage = fraction of described application programs found in the \\ \\ generation .$$

$$Precision = penalizes application programs generated that are not in the \\ \\ description .$$

$$Final score = 0.5 \times coverage + 0.5 \times precision .$$

$$Training weight : + 2. \times score .$$

Redundancy penalty—weighted combination of overall uniqueness and consecutive duplicate tuples.
Penalizes duplicate descriptions and consecutive identical application-screen-description tuples.
Final redundancy score E [0, 1] measures “how redundant.” The trainer applies a negative weight: −0.1× score.

In some embodiments, for the GRPO fine-tuning, a GRPO trainer from Transformer Reinforcement Learning (TRL) library may be used. Briefly, GRPO groups multiple samples per prompt to compute relative advantages and stabilize policy gradients without an external critic. At a high level for each prompt x:
Sample ‘K=num_generations' completions ‘y_1 . . . y_K−π_θ(⋅|x)’ (via fast vLLM inference).
Compute rewards ‘r_i=R(x, y_i)’ using the reward functions above.
Compute group baseline ‘b=mean(r_1 . . . r_K)’ and advantages ‘A_i=r_i−b’.
Update parameters to maximize ‘Σ_i A_i·log π_θ(y_i|x)’ subject to standard stabilization (e.g., clipping, entropy/KL as configured by TRL's GRPOTrainer).

In some embodiments, the dataset provided to GRPO contains chat prompts (system+user) and the trainer handles sampling and reward evaluation end-to-end. Reward scaling puts most emphasis on application consistency, while enforcing perfect format and discouraging duplicates. Redundancy penalty may be modest to avoid over-penalizing necessary repeats (e.g., series of edits within the same app and screen).

In some embodiments, the illustrative end-to-end training pipeline described below may be used, though it should be appreciated that LLM training may be performed in any other suitable way, as aspects of the technology described herein are not limited in this respect.

### Illustrative LLM Training Pipeline:

Load model with Unsloth+LoRA adapters (rank 64).
Build chat prompts from descriptions (‘add_convos’).
Configure GRPO with ‘num_generations=8’ and reward functions.
Train for 1-2 epochs; monitor reward trends, lengths, and sample generations.
Save adapters and tokenizer; optionally merge and export.
Evaluate with held-out descriptions; inspect format and app transitions.

In some embodiments, an open-source pre-trained LLM, such as Llama3.1-8B-Instruct, may be fine-tuned using the methods described above. To fine-tune the LLM, a training dataset of (natural language prompts, interaction sequences) pairs may be generated. In some embodiments, a larger model, such as, Llama3.1-70B, may be used to generate the natural language prompts from selected interaction sequences. In some embodiments, five thousand synthetic natural language prompts may be generated although a higher or lower number of synthetic natural language prompts (e.g., 1000, 2000, 3000, 4000, 5000, 6000, etc.) may be generated without departing from the scope of this disclosure.

A Parameter-Efficient FineTuning (PEFT) using the LoRA (Low-Rank Adaptation) approach may be employed. LoRA significantly reduces the number of trainable parameters by inserting smaller, trainable “adaptation” matrices into specific layers of the pretrained model, making fine-tuning more memory and computationally efficient.

After fine-tuning using the training dataset, the generation of the fine-tuned LLM may be further refined using reinforcement learning methods. For example, the Group Relative Policy Optimization (GRPO) algorithm and a set of reward functions that give feedback to the model to better align to the constraints given in the natural language prompts may be used.

### Techniques for User Guidance Through Process Discovery

When needing assistance while performing tasks, users in an organization typically look for sources of information that include guidance for resolving issues or using a technology. For example, users may look up information through public data sources, such as websites and available online documentation (e.g., wikis). The inventors have recognized that such documentation is often outdated, intermittently updated, and lacks details on how a task is actually performed. Additionally, what steps a user should perform to resolve an issue can be highly dependent on the exact steps performed up to that point. Teams suffer from siloed knowledge in organizations and so these steps cannot be learned from any public data source and has to be learned from the teams performing that work.

To address these concerns, the inventors have developed techniques for guiding a user in performing a process based on historical digital interaction data of one or more users performing the process. The techniques involve providing (e.g., real-time) suggestions to the user requesting or needing guidance in furtherance of performing the process. In some embodiments, the guidance may be generated by identifying, within the historical interaction digital interaction data, instances of the process previously performed by one or more users, and using the identified instances to generate the guidance for the user. In other embodiments, the guidance may be generated by identifying, using the historical digital interaction data and a trained language model, suggested act(s) for the user to perform in furtherance of performing the process and using the identified suggested acts(s) to generate the guidance for the user.

It should be appreciated that the historical digital interaction data used to generate guidance for a user performing a particular process may include historical data about the same particular process being performed by the same user and/or one or more other users. In this way, the user's own experience and/or the experience of other users in performing the particular process may be brought to bear on generating informative guidance for the user.

Accordingly, some embodiments provide for a method of guiding a user in performing a process based on historical digital interaction data of one or more users performing the process, the historical digital interaction data comprising multiple streams of event data, each particular stream of event data, from among the multiple streams, corresponding to interactions between one or more application programs executing on particular computing device and a particular user performing the process using the one or more application programs, the method comprising: (A) obtaining a stream of event data corresponding to a series of interactions between at least one application program executing on the user's computing device and the user performing the process using the at least one application program; (B) identifying, within the historical digital interaction data and using the stream of event data, at least one instance of the process previously performed by at least one user (e.g., the user being guided or at least one user different from the user being guided); (C) generating guidance for the user performing the process using the at least one instance of the process, the guidance indicating one or more suggested acts for the user in furtherance of performing the process; and (D) providing the generated guidance to the user (e.g., by presenting the user with a textual or graphical description of the at least one instance of the process).

In some embodiments, the method also involves deciding as to whether the guidance is to be generated for the user performing the process. Such a determination could be made in response to a user requesting assistance in performing the process or it can be made automatically, without the user specifically asking for assistance. For example, the guidance may be provided automatically when the process being performed by the user is sufficiently similar to an instance of a process in the historical interaction data. For instance, the system may be continuously comparing the user's interaction steps with historical interaction data comprising multiple streams of events from interactions users had in the past and when a stream of events is found that has a portion that is sufficiently similar to the user's interaction steps, that stream of events may be used to generate guidance for the user.

In some embodiments, identifying, within the historical digital interaction data and using the stream of event data, at least one instance of the process previously performed by at least one user may be performed by generating numeric representations of the user's stream of event data (obtained at (A)) and compared against numeric representations of events part of the historical interaction data.

For example, in some embodiments, the stream of event data contains event data for each event in a stream of events and identifying, within the historical digital interaction data and using the stream of event data, at least one instance of the process previously performed by at least one user comprises: (i) organizing events in the stream of events into at least one window of events, each of the at least one window of events comprising one or multiple events in the stream of events; (ii) generating, using at least one trained embedding ML model (e.g., a trained neural network having a transformer-based architecture, for example, a BERT model architecture or a RoBERTa model architecture), at least one numeric representation corresponding to the at least one window of events; (iii) determining a measure of similarity (e.g. a cosine similarity) between the at least one numeric representation and each of multiple stored and previously-determined numeric representations of respective windows of events in the multiple streams of event data in the historical digital interaction data to obtain a plurality of measures of similarity; and (iv) identifying, using the determined plurality of measures of similarity, the at least one instance of the process in the stream of events.

In some embodiments, the at least one window of events comprises a first window comprising a first plurality of events, generating the at least one numeric representation corresponding to the at least one window of events comprises generating a first numeric representation of the first window, and generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

The combining may be performed in any suitable way. For example, in some embodiments, the combining comprises: normalizing each of the numeric representations to obtain normalized numeric representations; and generating the first numeric representation of the first window as a weighted average of the normalized numeric representations. In some embodiments, determining weighted average may involve weighting the normalized numeric representations based on durations and/or recency of events from which the normalized numeric representations were derived.

In some embodiments, the first plurality of events comprises a first event corresponding to an interaction between a user and an application program, the event data for the first event comprises attribute-value pairs derived from information about the interaction between the user and a GUI of the application program, and processing the event data for first event comprises: (i) generating a textual event representation of the first event using the attribute-value pairs in the event data for the first event; (ii) tokenizing the textual event representation to obtain a tokenized event representation; (iii) determining an initial numeric encoding of the tokenized event representation; and (iv) processing the initial numeric encoding with the trained embedding ML model to obtain a numeric representation of the first event.

In some embodiments, the attribute-value pairs comprise values for one or more attributes selected from the group consisting of: a name of the application program, a title of an application program screen of the application program with which the user interacted during the first event, an identifier of the user interface element of the application program screen with which the user interacted, a type of the user interface element of the application program screen with which the user interacted, one or more identifiers for one or more user interface elements of the application program screen with which the user did not interact, a duration of the interaction, and one or more textual phrases and/or sentences appearing on the application program screen.

As described herein, another way of generating guidance is to use a language model (e.g., an LLM) trained on historical interaction data. Accordingly, some embodiments provide fora method of guiding a user in performing a process based on historical digital interaction data of one or more users performing the process, the historical digital interaction data comprising multiple streams of event data, each particular stream of event data, from among the multiple streams, corresponding to interactions between one or more application programs executing on particular computing device and a particular user performing the process using the one or more application programs, the method comprising: (A) obtaining a stream of event data corresponding to a series of interactions between at least one application program executing on the user's computing device and the user performing the process using the at least one application program; (B) identifying, using the historical digital interaction data, the stream of event data, and a trained large language model (LLM), one or more suggested acts for the user to perform in furtherance of performing the process; and (C) generating guidance for the user performing the process using the identified one or more suggested acts (e.g., presenting the user with a textual or graphical description of the at least one instance of the process).

In some embodiments, identifying, using the historical digital interaction data, the stream of event data, and a trained large language model (LLM), one or more suggested acts for the user to perform in furtherance of performing the process comprises: (i) generating a prompt from the stream of event data; and (ii) prompting the trained large language model with the prompt generated from the stream of event data to obtain an output indicating one or more acts that the user could perform as part of performing the process, wherein the trained LLM was trained by fine-tuning a baseline LLM with the historical digital interaction data. The fine tuning may involve: accessing a baseline LLM, and fine-tuning the baseline LLM with the historical digital interaction data using low-rank adaptors (LORA).

As described herein, information corresponding to a stream of events may be collected as a user interacts with one or more application programs executing on a computer. For instance, an application (e.g., process discovery module 101 shown in FIG. 1) may be installed on the user's computer that collects data as the user interacts with the computer to perform a process. In some embodiments, each user interaction step such as a mouse click, keyboard key press, or voice command that a user performs may be considered as an “event.” For each event, metadata associated with the event may be collected. Metadata associated with an event may comprise attribute-values pairs derived from information about the interaction between the user and a GUI of the application program. Examples of attribute-value pairs include, but are not limited to:

| Field Name | Description |
|---|---|
| ID | Unique event identifier |
| Machine Name | User Machine Name |
| Application Label | Application Label |
| Screen Title | Title of the Screen |
| Action | User action (e.g., click or keystroke) |
| Interacted Field | Interacted Field Name |
| Interacted Value | Interacted Field Value |
| Screen Text | Screen text extracted from Visual Hierarchy |
| Identifiers | Key-value pairs of fields on the screen from |
| | the Visual Hierarchy |
| Visual Hierarchy | Structured view of on-screen elements and |
| | their relationships |
| Timestamp | Event timestamp |

As users interact with application programs on their machines, a series of digital interactions that contain some or all of the information above is captured. These digital interactions are streamed while a user performs a process and can be leveraged by the techniques described herein to generate guidance for that user or other users requesting or needing guidance to perform the process.

In some embodiments, a stream of event data corresponding to a series of interactions obtained while a user is performing a process is converted into a numeric representation that is used to identify similar sequences of actions performed by at least one user (the same user or different users) within the historical digital interaction data. The similar sequences of actions are instances of the process previously performed by the at least one user that are then used to generate guidance for the user performing the process. The system may generate guidance including suggested acts for the user in furtherance of performing the process. For example, the system may present examples of how similar processes were completed, including any additional steps the user may have missed, to provide clear, and contextual guidance.

### User Guidance Using Numeric Representations of Processes

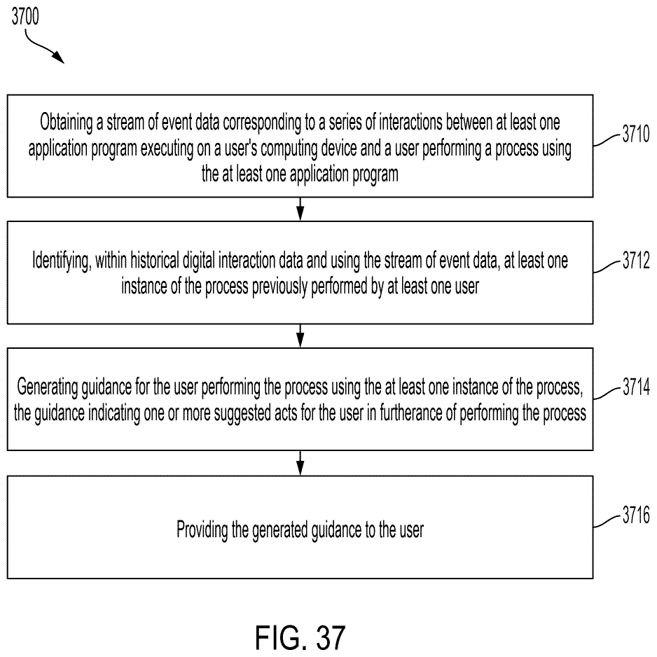

FIG. 37 is a flowchart of an illustrative method 3700 for guiding a user in performing a process based on historical digital interaction data of one or more users performing the process, in accordance with some embodiments of the technology described herein. At least some of the acts of method 3700 may be performed by any suitable computing device or devices, and, for example, may be performed by one or more of the computing devices 102 and/or central controller 104 shown in process tracking system 100 of FIG. 1.

In act 3710, a stream of event data may be obtained, the stream of event data corresponding to a series of interactions between at least one application program executing on the user's computing device and the user performing a process using the at least one application program. The events collected while the user interacts with the at least one application during performance of the process may be considered a stream of events sorted with respect to the time at which the events occurred during performance of the process. For each event, metadata associated with the event may be collected as described herein.

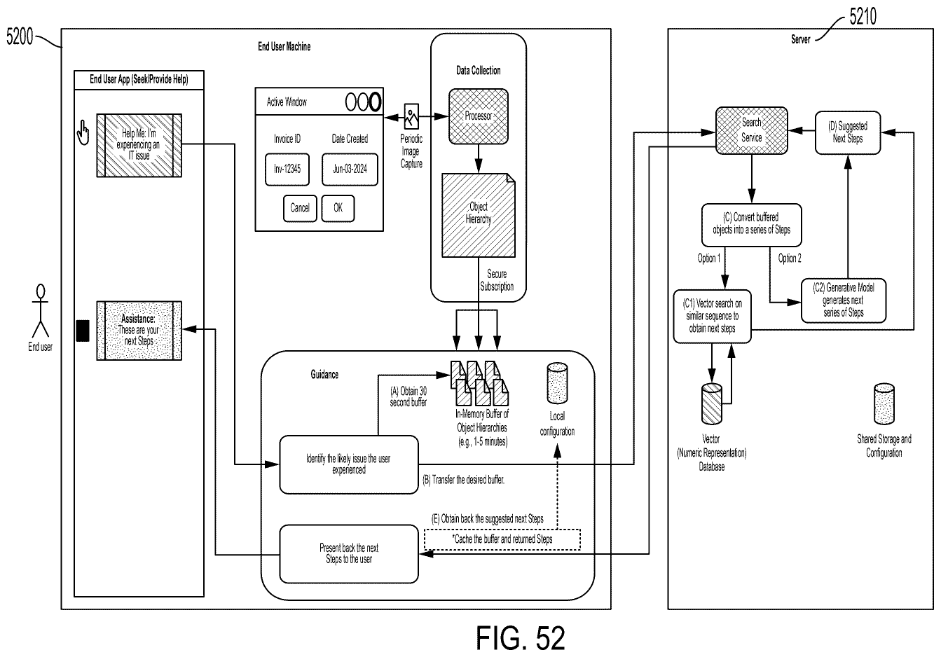

In some embodiments, event data may be captured continuously as the user is performing the process. The stream of event data may correspond to a series of interactions occurring within a fixed window of time (e.g., last 5 seconds, last 10 seconds, last 25 seconds, last 30 seconds, last minute, last 2 minutes, last 5 minutes, etc.). This can be implemented with a buffer as shown in FIGS. 52-56 for example, whereby data associated with the series of interactions occurring within the fixed window of time are stored in memory (e.g., volatile memory) and, for example, used to identify previously-performed processes containing similar series of interactions.

In act 3712, at least one instance of the process previously performed by at least one user may be identified. The at least one instance of the process may be identified within the historical digital interaction data and using the stream of event data. In some embodiments, the at least one of instances of the process may be identified by generating, using at least one trained machine learning model, a numerical representation of the process corresponding to the stream of events and determining a measure of similarity between the numerical representation of the process and each of multiple stored and previously-determined numeric representations of the process.

In some embodiments, the stream of event data contains event data for each event in a stream of events. Events in the stream of events may be organized into at least one window of events, each of the at least one window of events comprising one or multiple events in the stream of events. In some embodiments, the windows of events may overlap (e.g., meaning that the same event may be associated with two or more windows). In other embodiments the windows may not overlap, as aspects of the technology described herein are not limited in this respect. Thus, events in the stream of events may be organized into one window or multiple windows, which may be overlapping or not overlapping. As described below, each of the windows may be assigned a numerical representation which may be used to search against historical data of event streams that have been windowed using an analogous windowing with the resulting windows also assigned a numerical representation using an analogous numerical represent assignment method.

Any suitable windowing technique may be used to organize the events in the stream of events into at least one window of events. In some embodiments, one or more windowing parameters such as, time, number of events, or number or sequence of actions may be used to split the stream of events into smaller subsets or windows of events. For example, each set of events in the stream that is associated with a number of consecutive user actions (e.g., 2, 3, 4, 5, or other suitable number of consecutive actions) performed by the user may be organized into a window. As another example, each set of events in the stream that is associated with a particular timeframe (e.g., 10 seconds, 20 seconds, 30 seconds, 40 seconds, 50 seconds, 1 minute, 2 minutes, 5 minutes, 30 minutes, or other suitable timeframe) may be organized into a window. As yet another example, each set number of events (e.g., 5, 10, 15, 20, 25, 30, or any other suitable number) in the stream may be organized into a window.

In some embodiments, a time-based windowing technique may be used to group events that occur within a fixed time interval (e.g., every 10 seconds, 20 seconds, 30 seconds, 40 seconds, 50 seconds, 1 minute, 2 minutes, 5 minutes, 30 minutes, or other suitable interval). This approach captures user activity within consistent time slices, which is useful for continuous monitoring and workload analysis. However, it may fragment longer tasks that span multiple intervals or combine unrelated actions if the user is multitasking within the same period.

In some embodiments, an inactivity-based windowing technique may be used in which a new window starts whenever a user resumes activity after a defined idle period (for example, 2 minutes of inactivity). This approach is effective for modeling user sessions or task bursts and tends to capture natural boundaries in work behavior. It adapts better to variable task durations and avoids splitting meaningful sequences across arbitrary time limits.

In some embodiments, an event trigger-based windowing technique may be used where event-triggered windows are formed based on contextual transitions rather than fixed time or idle thresholds. These transitions can include changes in the active application, shifts between business contexts, or the duration of focus within a specific application where the user may need assistance. For example, a window can represent the continuous period a user spends working within a customer relationship management (CRM) system or enterprise resource planning (ERP) system. This approach is useful when assistance or retrieval is application-specific, ensuring that the captured context reflects the precise environment of the user's task.

In some embodiments, a sliding-based windowing technique may be used. Sliding windows advance by a fixed step (for example, a 5-minute slide on a 15-minute window) to ensure that transitional or overlapping activities between windows are captured. This method provides a continuous view of user activity and can help maintain context across shifting tasks, though it may introduce some redundancy if overlap is large.

Next, a numeric representation for each window of events may be generated. As described herein, numeric representations of windows of events may be then used to identify similar processes in historical interaction data. Generating a numeric representation for a window of events may be done hierarchically, whereby numeric representations of events in a window are determined first and subsequently are combined to provide a numeric representation for the window itself. Numeric representations of events may be generated using a trained embedding ML model (e.g., a trained neural network having a transformer based architecture, such as a BERT or RoBERTa architecture).

Accordingly, in some embodiments, at least one numeric representation corresponding to the at least one window of events may be generated using at least one trained embedding ML model. In some embodiments, metadata associated with the at least one window of events may be processed using the at least one trained embedding ML model to generate the at least one numeric representation corresponding to the at least one window of events. In some embodiments, the at least one trained embedding ML learning model includes a first trained embedding ML model. In some embodiments, each window of events of the at least one window of events may include a plurality of events and a numeric representation of the window may be generated by processing at least some of the metadata associated with events in the plurality of events using the first trained embedding ML model.

In some embodiments, generating a numeric representation of a window of events may include generating a numeric representation of each event of the plurality of events in the window using the first trained ML model to obtain a plurality of numeric representations corresponding to the plurality of events. In some embodiments, generating the numeric representation for each event comprises generating the numeric representation of the event by processing its associated metadata with the first trained ML model.

In some embodiments, generating the numeric representation of the event by processing its associated metadata with the first trained ML model comprises generating a textual event representation of the event using attribute-value pairs in the metadata associated with the event, tokenizing the textual event representation to obtain a tokenized event representation, determining an initial numeric encoding of the tokenized event representation, and processing the initial numeric encoding with the first trained ML model to obtain the numeric representation of the event. Examples of attribute-value pairs are provided in the table above.

An example of metadata associated with an event (e.g., interaction with an Order field in an SAP application screen) is shown below, where the metadata comprises attributes and values of the attributes.

| | | | | Element |
|---|---|---|---|---|
| Attributes | Application | Screen Title | Element Type | Name |
| Values | Sap | SAP Easy Access | Guictextfield | Order |

A textual representation of the event generated using the values of these attributes may be sap_->_SAP_Easy_Access_->_Guictextfield_->_Order. In some embodiments, the textual representation may be generated by following the steps below, although other textual representation formats may be used:
Within an event, all the different attributes are concatenated with the token ‘->’
Within an attribute, all spaces are replaced with‘->’
Events are separated by spaces
Independent user days of events are separated by new line characters

In some embodiments, the special characters are different kinds of delimiters which are uniquely defined as special tokens in a tokenizer.

A tokenized event representation generated by tokenizing the textual representation above may be [‘s’, ‘ap’, ‘_’, ‘->’, ‘_’, ‘S’, ‘AP’, ‘_’, ‘Easy’, ‘_’, ‘Access’, ‘_’, ‘->’, ‘_’, ‘Gu’, ‘ic’, ‘text’, ‘field’, ‘_’, ‘->’, ‘_’, ‘Order’]. Any suitable tokenizing algorithm may be used to generate the tokenized event representation.

In some embodiments, an initial numeric encoding of the tokenized event representation above may be determined. The initial numeric encoding may be [0, 29, 1115, 1215, 46613, 1215, 104, 591, 1215, 43361, 1215, 35505, 1215, 46613, 1215, 14484, 636, 29015, 1399, 1215, 46613, 1215, 45613, 2]. In some embodiments, determining the initial numeric encoding may include determining a byte pair encoding (BPE) of the tokenized event representation. Each token may have a corresponding ID that is determined via byte pair encoding (BPE). BPE is typically used by tokenizers of BERT based models. For example, a RoBERTa tokenizer may be used to tokenize the textual representation and generate the initial numeric encoding.

In some embodiments, the numeric representation of the event may be obtained by processing the initial numeric encoding above with the first trained ML model. In some embodiments, the BPE may be converted to a numeric representation using an embedding layer of the BERT based model.

In some embodiments, the first trained ML model may include an encoder including a trained neural network having a transformer-based architecture, such as, a BERT model architecture described in Devlin et. al., “BERT: Pre-training of Deep Bidirectional Transformers for Language Understanding,” Computation and Language, arXiv:1810.04805, May 2019 or a RoBERTa model architecture described in Liu et al., “A Robustly Optimized BERT Pretraining Approach,” Computation and Language, arXiv:1907.11692, July 2019, both of which are incorporated by reference herein in their entirety). In some embodiments, a trained ML model that is a variation of the BERT and/or RoBERTa models may be used, as aspects of the technology described herein are not limited in this respect.

In some embodiments, RoBERTa may use the same transformer-based architecture as BERT, which comprises several layers of multi-headed attention and feed-forward neural networks. However, RoBERTa may implement some optimizations to improve pretraining such as dynamic masking, omitting the next sentence prediction task and increasing the batch size.

This modification may allow RoBERTa to capitalize on larger training datasets and longer training durations, enhancing its ability to learn the underlying structure in the data, capturing complex linguistic patterns and nuances.

In some embodiments, RoBERTa may operate by first tokenizing input text into sub-word or word tokens, each mapped to a high-dimensional embedding vector. These embeddings may then be fed into transformer blocks, where multi-head self-attention mechanisms and position-wise feed-forward networks refine the contextualized representations of tokens. By iteratively encoding the input sequence through multiple transformer blocks, RoBERTa may capture semantic and structural intricacies in the data. A pooling strategy may be employed to aggregate contextualized token embeddings into a fixed-size vector representation for the entire input sequence. This final representation may serve as input for downstream applications.

In some embodiments, the first trained ML model is configured to process the first portion of the metadata that includes attribute values that do not include natural language text and/or complex values such as textual phrases, sentences, paragraphs, etc. Whereas a second trained ML model may be configured to process a portion of the metadata that includes attribute values taking on natural language text values. In some such embodiments, multiple different trained ML models may be used to generate numeric representations.

In some embodiments, the at least one trained machine learning model includes a second trained ML model different from the first trained ML model. In some embodiments, each window of events may include a plurality of events and a numeric representation of the window may be generated by processing at least some of the metadata associated with events in the plurality of events using the first trained ML model and at least some other of the metadata associated with events in the plurality of events using the second trained ML model.

In some embodiments, generating a numeric representation (which can equivalently be termed a numeric embedding) of each event of the plurality of events in the window may include generating a first numeric representation of the event by processing a first portion of the metadata associated with the event with the first trained ML model and generating a second numeric representation of the event by processing a second portion of the metadata associated with the event with the second trained ML model.

In some embodiments, the second trained ML model is configured to process the second portion of the metadata that includes attribute values that include natural language text and/or complex values such as textual phrases, sentences, paragraphs, etc.

In some embodiments, the second trained ML model may include an encoder having a trained neural network having a Sentence-BERT architecture described in Reimers et. al., “Sentence-BERT: Sentence Embeddings using Siamese BERT-Networks,” Computation and Language, arXiv:1908.10084, August 2019, which is incorporated by reference herein in its entirety. Sentence-BERT is a modification of the pretrained BERT network that use siamese and triplet network structures to derive semantically meaningful sentence embeddings that can be compared using cosine-similarity. Sentence-BERT is pretrained on natural language data.

In some embodiments, the first numeric representation output from the first trained ML model may be a first multi-dimensional embedding (e.g., an embedding having 768 dimensions) and the second numeric representation output from the second trained ML model may be a second multi-dimensional embedding (e.g., an embedding having 384 dimensions). In some embodiments, the first and second numeric representation may be concatenated to generate the numeric representation of the event. For example, the numeric representation of the event may be a multi-dimensional embedding obtained by concatenating the first and second multi-dimensional embeddings (e.g., 768+384=1152-dimensional embedding). This numeric representation or embedding contains data about different attributes associated with the event including some attributes that are associated with natural language text and others that are not.

For example, metadata associated with an event corresponding to an interaction with an email application (e.g., clicking the send button to send an email message) may specify values for the following attributes: application, element name, element type, and text. The value of the application attribute may be “Outlook”, the value of the element name attribute may be “Send”, the value of the element type attribute may be “Button”, and the value of the text attribute may be “Email body” which includes natural language text. For this example, a first portion of the metadata (e.g., values of the first three attributes—application, element name, and element type) associated with the event may be processed with the first trained ML model to generate a first numeric embedding of the event and a second portion of the metadata (e.g., value of the fourth attribute—text) associated with the event may be processed with the second trained ML model to generating a second numeric embedding of the event. These first and second numeric embeddings may be concatenated to generate a numeric embedding for the event.

In some embodiments, the attribute values (e.g., email bodies, paragraphs in a document) associated with the second portion of the metadata may be pre-processed prior to generating the numeric embedding of the event. The inventors have recognized that some events may be associated with metadata including similar values for certain attributes (e.g., the “text” attribute including natural language text) and it may be beneficial to preprocess these events by applying clustering techniques. For example, when interacting with an email application to send or reply to a message, the body of the email during both these events may be similar. In some embodiments, the attribute values (e.g., email bodies) associated with both these events may be processed using the Sentence-BERT model to generate corresponding embeddings. Based on these embeddings, clustering may be performed to merge together attribute values that are similar. The attribute values for each event may then be mapped to the attribute value of the corresponding cluster medoids before forming the textual event representation. For example, considering two email events with representations “outlook_->_Email_Body_One_->_Button_->_Send” and “outlook_->_Email_Body_Two_->_Button_->_Reply”. If these events are preprocessed by applying clustering to the email bodies, and assuming that both email bodies are clustered into one group and its medoid is “Email Body One”, then the textual event representations for these events would be modified to “outlook_->_Email_Body_One->_Button_->_Send” and “outlook_->_Email_Body_One_->_Button_->_Reply”.

Given numeric representations or embeddings of each of multiple events in a window, those representations may be combined to obtain the numeric representation of the window of events. In some embodiments, combining the plurality of numeric representations (of events) may include averaging the plurality of numeric embeddings to obtain the numeric representation of the window of events. In other embodiments, combining the plurality of numeric representations (of events) may include determining a weighted average of the plurality of numeric representations to obtain the numeric representation of the window of events. Determining the weighted average may include weighting the plurality of numeric representations based on durations and/or recency of the plurality of events from which the plurality of numeric representations were derived.

Accordingly, in some embodiments, the at least one window of events includes a first window comprising a first plurality of events. In some embodiments, generating the at least one numeric representation corresponding to the at least one window of events includes generating a first numeric representation of the first window, wherein generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

In some embodiments, combining the numeric representations of the events in the first plurality of events to obtain the first numeric representation of the first window includes normalizing each of the numeric representations to obtain normalized numeric representations; and generating the first numeric representation of the first window as a weighted average of the normalized numeric representations. In some embodiments, generating the first numeric representation of the first window as a weighted average, optionally, comprises weighting the normalized numeric representations based on durations and/or recency of events from which the normalized numeric representations were derived.

In some embodiments, each window of events includes information as shown in the table below.

| Column | Description |
|---|---|
| Window UUID | Unique identifier for the window session |
| | (primary key) |
| Machine Name | Name of user's machine |
| Date | Date of captured session |
| Start Time | Start timestamp of the session |
| End Time | End timestamp of the session |
| Event Count | Total number of events in the window |
| Window vector | Numerical representation of the window |
| Window frequency | How often is this window seen in the data |

The information in the table above may be used to lookup the numerical representation of the window for purposes of identifying instances of the process in a stream of events. In some embodiments, the numerical representation of the window may be created by using a series of operations on all the numerical representations of the events in the window. An example implementation of this is mean pooling with normalization, optionally weighted by each event's importance or time.

In some embodiments, the numerical representation of a window may be obtained as follows:
1. L2-normalize each event vector eᵢ.
2. Choose a weight wᵢ for each event (for example, dwell time, recency decay, or 1 if unweighted).

$$3. Compute the weighted mean : v = \frac{{\sum }_{i} {w}_{i} {e}_{i}}{{\sum }_{i} {w}_{i}} .$$

4. L2-normalize v to get the final numerical representation of the window.

In some embodiments, weighting may be performed using techniques like term frequency-inverse document frequency (TF-IDF) of events that have been seen in the data to determine uniqueness of the information.

In some embodiments, the numerical representation of a window comprises a representation of the digital interactions that were performed in that window of time. Window frequency can then be used to not only find semantically similar series of digital interactions, but ones that are commonly performed by users of a team. This can be useful in generating a ranking of steps when deciding what series of steps of a process are to be suggested to the user.

In some embodiments, a plurality of measures of similarity may be obtained by determining a measure of similarity between the numerical representation of the window and each of multiple stored and previously-determined numeric representations of respective windows of events in the multiple streams of event data in the historical digital interaction data. In some embodiments, determining the measure of similarity may include determining a cosine similarity between the numeric representation of the window and each of multiple stored and previously-determined numeric representations of respective windows of events. In some embodiments, a similarity score may be obtained by computing the cosine similarity between the numeric representation of the window and each of multiple stored and previously-determined numeric representations of respective windows of events. The similarity score may be a value between 0-1, a higher score indicating a better match than a lower score.

In some embodiments, a numeric representation of the window is compared with each of multiple stored and previously-determined numeric representations of respective windows of events. As part of this comparison, the ith dimension of the numeric representation may be compared to the ith dimension of the stored numeric representation. In other words, the dimensions that embed the first portion of the metadata are compared to one other and the dimensions that embed the second portion of the metadata are compared to one another. This comparison makes process discovery extendable and capable of using data from multiple domains.

In some embodiments, the determined plurality of measures of similarity may be used to identify the instances of the process in the stream of events as comprising events in those windows whose determined measure of similarity to the numeric representation of the window was greater than a first threshold (e.g., 0.7 or 70%). Any suitable first threshold may be used.

Aspects of techniques for generating numerical representations of windows and identifying instances of the process using determined measures of similarity can be found in PCT Application No. WO2024/214113, titled “Machine learning systems and methods for automated process discovery,” published Oct. 17, 2024, which is incorporated by reference herein in its entirety.

In some embodiments, an example series of steps performed to identify instances of a process for purposes of guiding users is described below:
1. Normalize the numeric representation of the window q with L2 normalization.
2. Index all stored and previously-determined numeric representations of respective windows vⱼ in a vector store. Normalize them once at ingest.
3. Similarity metric: use cosine similarity. With normalized numerical representations, cosine similarity is the same as the dot product.
4. Search: retrieve top-k nearest neighbors of q.
5. Filter: apply metadata filters if needed, for example machine name, date range, or application.
6. Score and threshold: keep results with similarity≥a chosen cutoff to avoid weak matches.
7. Rank and Judge: Using the Window Frequency information and language models, optionally judge the quality of the results.
8. Return: the matching windows, their similarity scores, and any metadata needed to display examples.

There are many different ways to store, index, and search these numerical representations as described above. One such example, used in some embodiments, is using pgvector with Postgres, which provides several indexing methods and top-k nearest neighbor implementations. By default, that would be a Euclidean (L2) distance for top-k and an index type of Inverted Flat File index (ivfflat).

A top-k search may be performed, for example with a default of top 5, to find similar windows of digital interactions that match the one the user is currently experiencing.

With the top-k results some ranking steps may be performed. Since the top-k results will be based on semantics and not necessarily frequency, Window Frequency may be used to perform ranking (e.g., which may indicate popularity of the sequence of steps). In this way, the search may find semantically similar sequences, which can then be re-ranked by Window Frequency. The idea here is that a high Window Frequency may indicate that multiple users/teams perform such steps, increasing their value to guiding other users.

In some embodiments, classification labels may assist in helping identify processes. For example, if the process a user is performing during a captured window can be associated with a classification label, that information can be stored alongside the numerical representation of the window as structured metadata. The process label may represent the task or workflow context, such as updating a record, submitting a claim, or reviewing an application. By associating this classification with the numerical representation, each window becomes semantically richer and more interpretable, allowing downstream systems to reason about both the vectorized behavioral pattern and its categorical intent. This turns the numeric representation of the window into a multimodal artifact that blends numeric embeddings with symbolic context.

In some embodiments, when performing the similarity search, such process classifications may be used to refine retrieval results. For example, before the similarity search, the process type can act as a filter, returning only windows that match the same process category as the query. Alternatively, after retrieving the top-k results by semantic similarity, the process classification label can influence the ranking, giving higher priority to windows associated with the same or closely related process types. This combined approach improves both precision and relevance by ensuring that the returned examples are not only similar in user behavior and screen context but also aligned with the user's current task or intent.

Referring back to FIG. 37, the method proceeds to act 3714, where guidance for the user performing the process may be generated using the at least one instance of the process identified in act 3712. The guidance indicates one or more suggested acts for the user in furtherance of performing the process. The generated guidance may be presented to the user in act 3716.

In some embodiments, a determination may be made that guidance is to be generated for the user performing the process. In some embodiments, in response to determining that the guidance is to be generated for the user performing the process, acts 3712 and 3714 may be performed. In other embodiments, in response to determining that the guidance is to be generated for the user performing the process, act 3714 may be performed. In this embodiment, act 3712 may be continuously performed in the background and determining that guidance is to be generated triggers act 3714 to be performed.

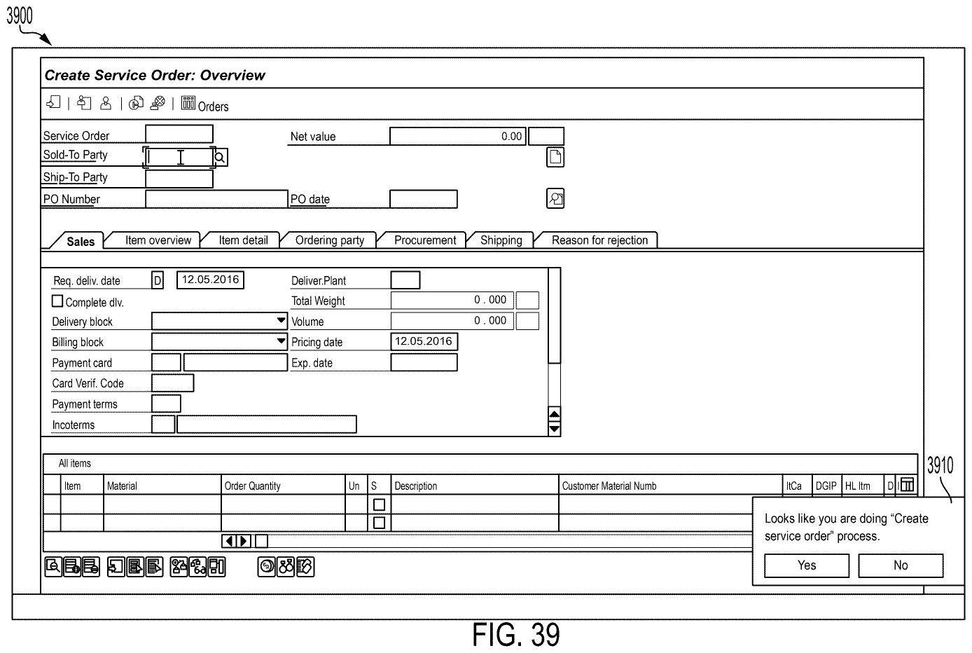

In some embodiments, after identifying the at least one instance of the process at act 3712, a determination may be made that the guidance is to be generated for the user. In some such embodiments, acts 3710 and 3712 may be continuously performed in the background while user's interactions are being buffered, and identification of the at least one instance of the process within the historical digital interaction data in act 3712 may trigger generation of guidance for the user. For example, as shown in FIG. 39, the system may determine automatically that a user is performing the “Create service order” process (based on the similarity of the user's interactions to prior instances of that process performed by one or more other users) and may ask the user, via dialog box 3910, whether the user is performing such a process and may present the user with guidance for one or more steps to perform next.

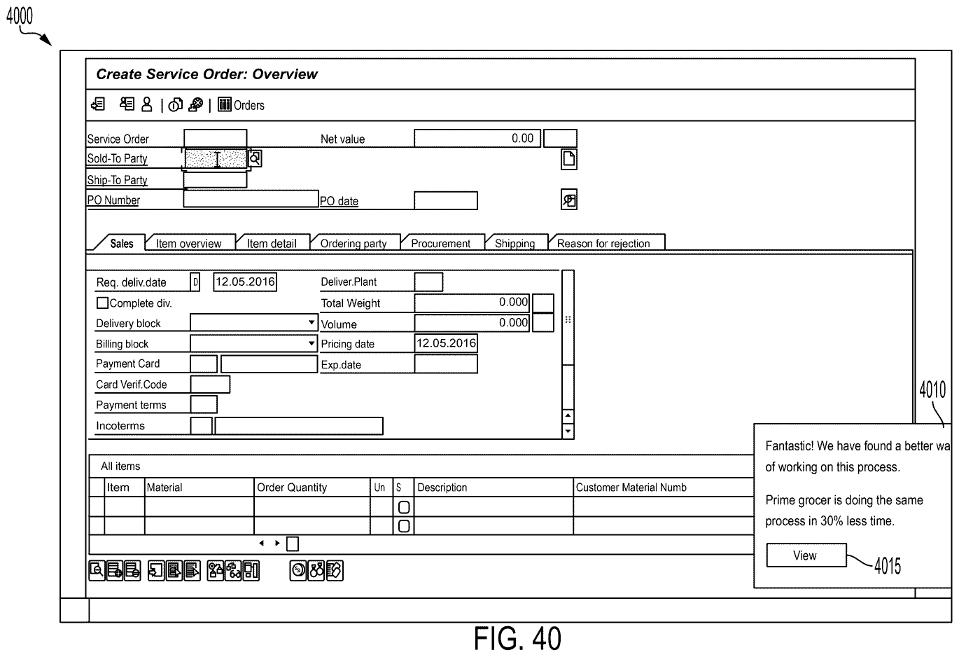

In some embodiments, a further determination may be made that the previously performed instance of the process is a more efficient way (e.g., takes less time than the user's way of performing the process) of performing the process or performing one or more steps in the process. In other words, the identified instance of the “Create service order” process is a more efficient way performing that process. FIG. 40 is a screenshot of an example GUI 4000 that shows a dialog box 4010, indicating that a more efficient way of performing the “Create service order” process has been found. In some embodiments, the user may be guided to perform the process or one or more steps in the process in the more efficient way. In some embodiments, the guidance may include presenting the user with a textual description of the instance of the process or one or more steps in the process.

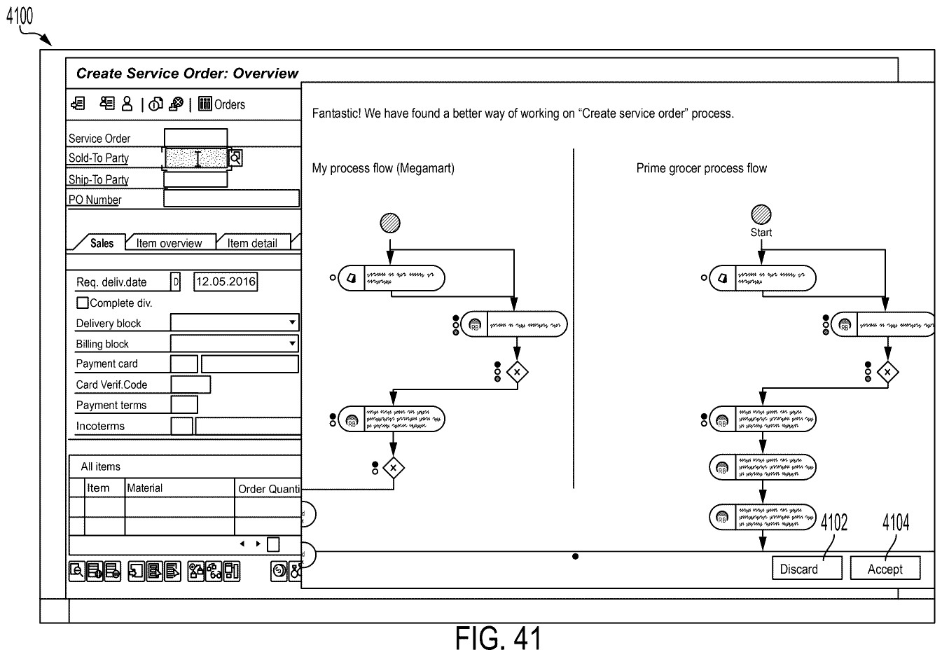

In some embodiments, the guidance may include presenting the user with a graphical description of the instance of the process or one or more steps in the process. For example, selection of the view button 4015 in GUI 4000 causes a graphical description of the instance to be displayed, as shown in GUI 4100 of FIG. 41. As shown in FIG. 41, a side-by-side view of the user's way of performing the process and the more efficient way of performing the process may be presented. The user may select the discard button 4102 to opt out of using the more efficient way of performing the process and may select the accept button 410 to opt in to using the more efficient way of performing the process. The guidance may include suggested steps the user can take to perform the process in the more efficient way.

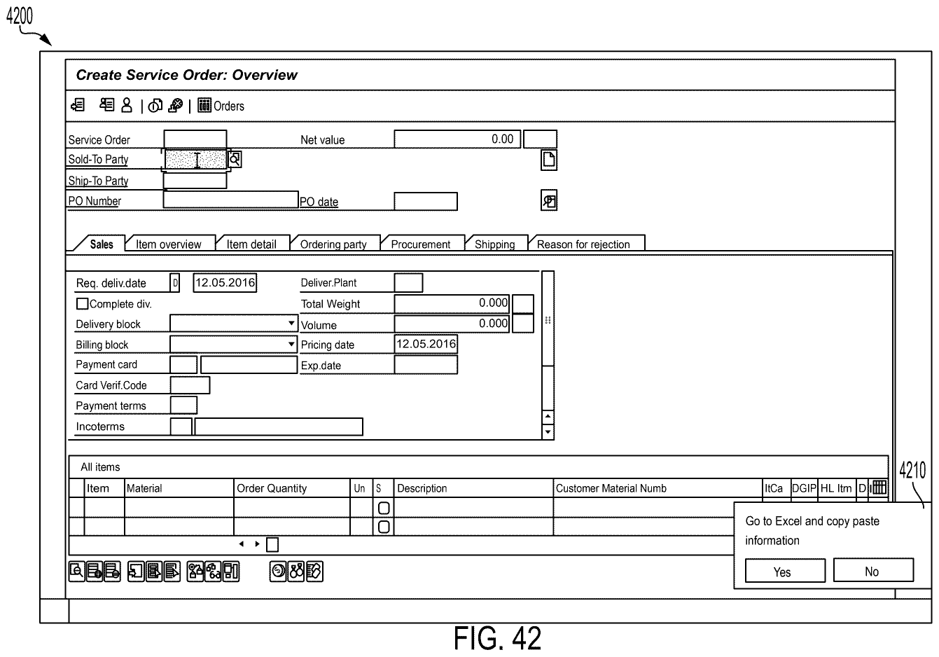

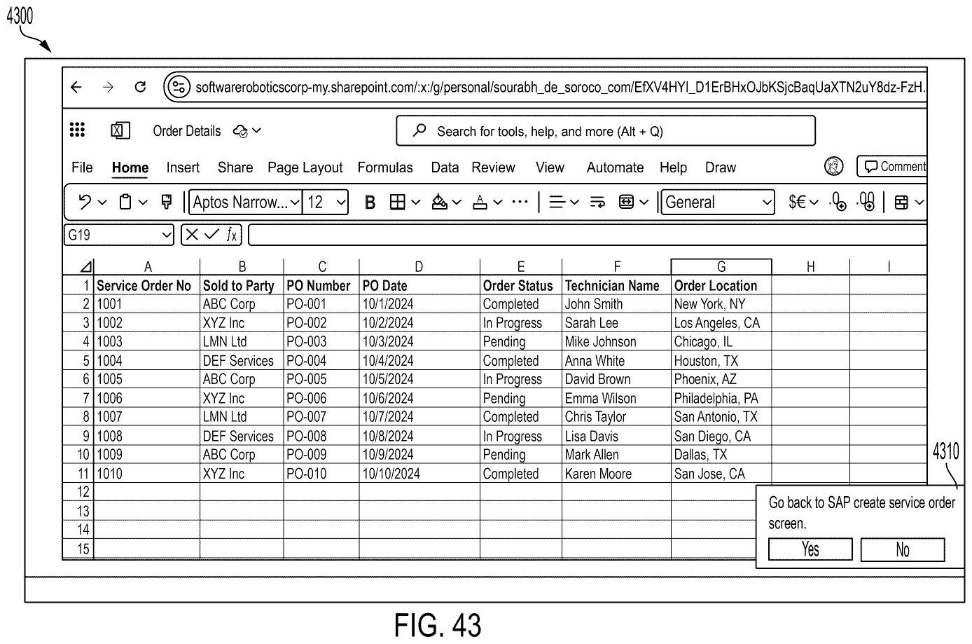

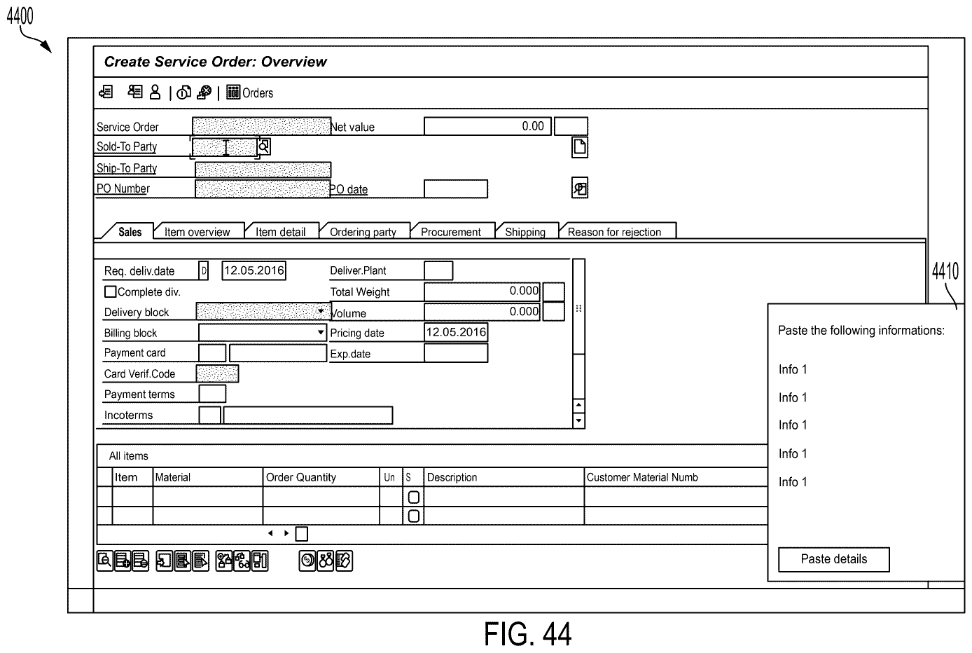

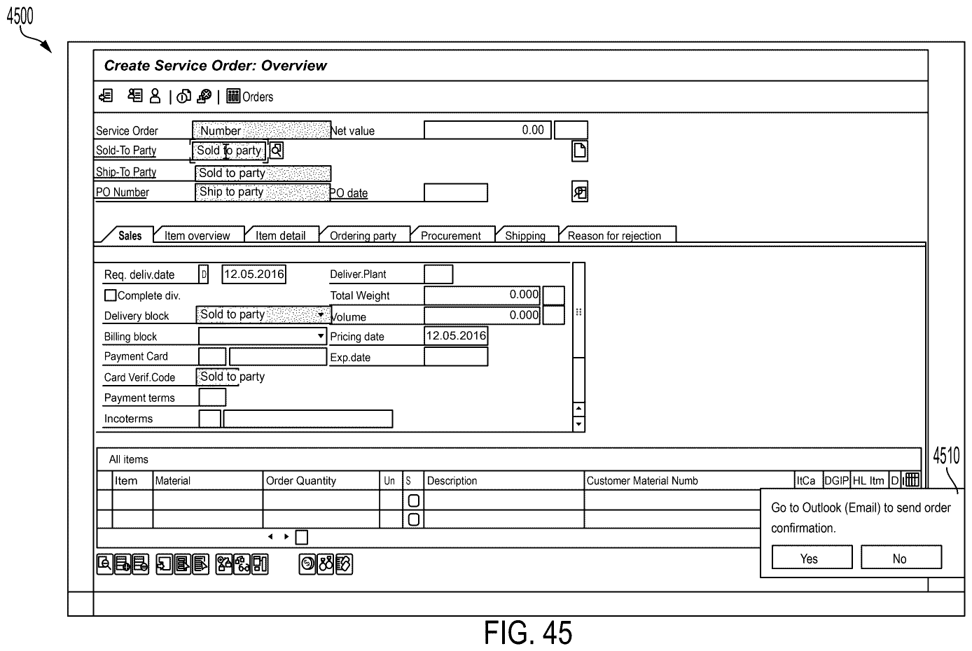

In some embodiments, the user can be guided step-by-step to perform the process more efficiently as shown in FIGS. 42-45. The step-by-step guidance may be provided via dialog boxes 4210, 4310, 4410, and 4510. Another form of guidance that can be provided to the user is providing information to fill fields on the screen. This information is derived from previous interactions with the GUI during a previous performance of the process, and the values of attributes that existed on the screen at that time. For example, a user may be reminded to fill in a “PO Number” field on the current screen with a value of the “PO Number” attribute being seen in a previous step on a previous screen. Providing the value to the user can lead to less mistakes in performing the process.

In some embodiments, determining that that the guidance is to be generated for the user performing the process comprises determining that the guidance is to be generated in response to the user requesting assistance in performing the process. For example, a user performing the process may get stuck while performing a process and may request assistance.

In some embodiments, determining that that the guidance is to be generated for the user performing the process comprises automatically determining that the guidance is to be generated in response to detecting that at least one guidance generation criterion is met. For example, the user performing the process may get stuck and take an unusually long time to perform the next step in the process. This may cause guidance to be automatically generated for the user. In some embodiments, the at least one guidance criterion may include, but not be limited to: a user taking at least a threshold amount of time to perform the process, at least a threshold number of time has elapsed between interactions performed by the user and the at least one application program, identification of at least one instance of the process within the historical digital interaction data (e.g., identifying an instance that is a more efficient way of performing the process), and/or other guidance criterion.

In some embodiments, the guidance may indicate one or more suggested acts for the user in furtherance of performing the process. For example, the user may be guided to perform the next series of steps in furtherance of performing the process. In some embodiments, the guidance may be provided in natural language, and the guidance as presented to the user may not include the steps they already performed.

To this end, in some embodiments, a language model may be prompted as follows. The prompt can provide a representation and a judge step, such as:
A user was performing the following series of steps:
Log in to CRM→Open “Opportunities”→Edit Opportunity→Add Contact→Save Record.
The user now needs assistance with the next steps to perform. We found other examples of their team performing similar series of steps, which are listed below. First, judge or verify whether the series of steps we found their team perform is related. Then, use those steps to suggest only the next series of steps that the user should perform, without repeating steps they've already completed:
   Example Steps 1: Log in to CRM→Open “Opportunities”→Edit Opportunity Add Contact→Save Record→Generate Quote→Send to Customer.
   Example Steps 2: Log in to CRM→Open “Leads”→Convert Lead→Create Opportunity→Add Products→Generate Quote.

The user may then be presented with the output of the LLM generated in response to the above prompt, in this example. The exact information provided with the steps and example steps, can be all or some part of the metadata shown in the table above listing attribute-value pairs.

### User Guidance Using Generative Model

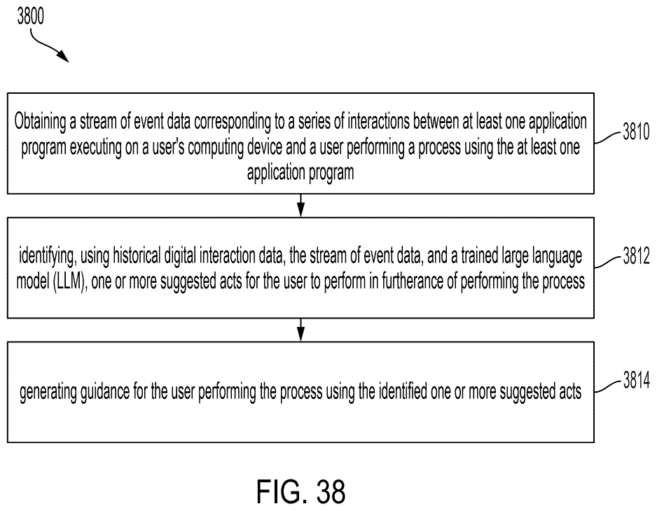

FIG. 38 is a flowchart of an illustrative method 3800 for guiding a user in performing a process based on historical digital interaction data of one or more users performing the process, in accordance with some embodiments of the technology described herein. At least some of the acts of method 3800 may be performed by any suitable computing device or devices, and, for example, may be performed by one or more of the computing devices 102 and/or central controller 104 shown in process tracking system 100 of FIG. 1.

In act 3810, a stream of event data may be obtained, the stream of event data corresponding to a series of interactions between at least one application program executing on the user's computing device and the user performing a process using the at least one application program. The events collected while the user interacts with the at least one application during performance of the process may be considered a stream of events sorted with respect to the time at which the events occurred during performance of the process. For each event, metadata associated with the event may be collected as described herein.

In act 3812, one or more suggested acts (e.g., next steps) for the user to perform in furtherance of performing the process may be identified using historical digital interaction data, the stream of events, and a trained language model. For example, the next series of steps that the user should perform may be obtained by training a decoder-only model on digital interactions that the team performs. This can be done using a supervised fine-tuning process on the digital interaction data as described below and then, seeding that model with a series of steps that the user is performing, and having the model generate the likely next series of steps.

In some embodiments, a prompt may be generated from the stream of event data, and a trained language model (e.g., large language model) may be prompted with the prompt generated from the stream of event data to obtain an output indicating one or more acts that the user could perform as part of performing the process. In some embodiments, the trained large language model may be trained by fine-tuning a baseline LLM with the historical digital interaction data, for example, by fine-tuning the baseline large language model with the historical digital interaction data using low-rank adaptors (LORA).

In some embodiments, the training data is generated from digital interaction data converted into a consistent schema:

DESCRIPTION=... | APPLICATION=... | SCREEN_NAME=... |
ELEMENT_NAME=... | TIME_SPENT=...

That training data is collected as users perform work on their computer. The training data can include all or some of the metadata shown in the table above listing attribute-value pairs.

In some embodiments, the decoder-only model may be an autoregressive transformer that generates text one token at a time, conditioning on data it has produced so far. In some embodiments, to specialize the model without retraining all of its weights, LoRA (low-rank adapters) may be used: small trainable low-rank matrices are inserted into attention and feed-forward projections, while the original backbone remains frozen. This greatly reduces the number of trainable parameters and memory footprint while providing strong task adaptation. Training is posed as supervised sequence modeling with teacher forcing, meaning the model is shown the correct target sequence (a single or multiple step interactions) during learning and is optimized to predict the next token at each step. To improve robustness to wording, the same supervision may be delivered via multiple paraphrased instructions, and the target outputs remain structured and easy to parse by using the same interaction schema. Prompts may follow a chat-style format to reinforce role semantics (user request versus assistant reply) during learning.

In some embodiments, at optimization a long-context setting may be used so the model can read rich prompts and produce complete sequences for lengthy workflows. LoRA adapters on attention and feed-forward projections may shape token-to-token dependencies and interaction step structure while keeping the core network stable and efficient. Training runs for multiple passes (˜2-3 epochs) over the data with evaluation on a held-out split to gauge generalization.

In one example, the following model and LoRA settings were used:
Base model: Llama3.1-8B
Context length used during training: 32,256 tokens
LoRA rank (r): 16
LoRA alpha: 32
LoRA dropout: 0.0

An example of generating the likely next series of interactions is provided as follows. The model may be prompted with a series of digital interactions, and then model may generate the next likely digital interaction. That digital interaction can then be placed in a window to continuously generate more interactions. The benefit of this is that the model can learn from the series of interactions and attention to certain interactions from training, to the generate the next likely digital interaction.

Consider the following example prompt.
Given the following series of digital interactions, produce the next likely digital interaction.
   The user is “Working on document” with the application named “word” open with screen name “Document_Activation”.
   The user is “Switching from word to desktop view” with the application named “explorer” open with screen name “Desktop workspace”.
   The user is “Working on desktop” with the application named “explorer” open with screen name “Desktop workspace”.
   The user is “Switching from desktop view to email” with the application named “outlook” open with screen name “Inbox”.
   The user is “Working in email application” with the application named “outlook” open with screen name “Inbox”.
   The user is “Switching from email to team workspace” with the application named “teams” open with screen name “Team Forms”.
   The user is “Viewing Team Forms” with the application named “teams” open with screen name “Team Forms”.
   The user is “Viewing Regional Team workspace” with the application named “teams” open with screen name “Regional Team workspace”.
   The user is “Editing field(s) in Team Forms” with the application named “teams” open with screen name “Team Forms”.

In response, the model may respond as follows:
<|im_start|>assistant
The user is “Submitting updated form data” with the application named “teams” open with screen name “Form Submission Confirmation”.

As can be appreciated from the foregoing, in this example, the model generated a description of the next interaction step:
The user is “Submitting updated form data” with the application named “teams” open with screen name “Form Submission Confirmation”.

To then generate a series of digital interactions, the newly generated digital interaction may be added to the window, and the language model may be prompted to generate another digital interaction.

Referring back to FIG. 38, in act 3814, guidance for the user performing the process may be generated using the identified one or more suggested acts. In some embodiments, the user may be presented with the one more suggested acts that the user could perform as part of the performing the process. The one or more suggested acts may include the next series of steps output by the language model. In some embodiments, the presenting comprises providing the user with a textual or graphical description of the one more suggested acts that the user could perform.

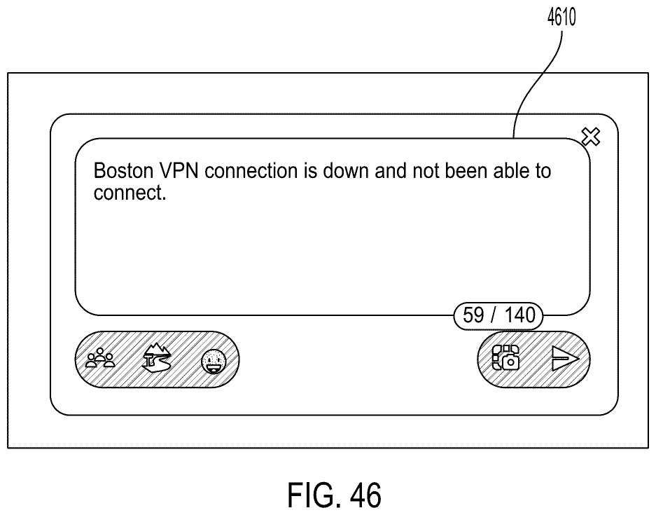

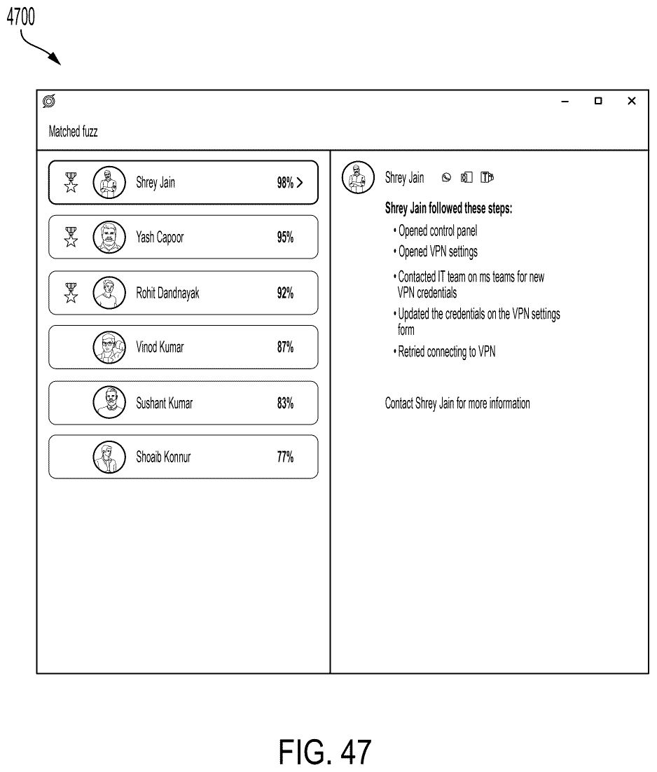

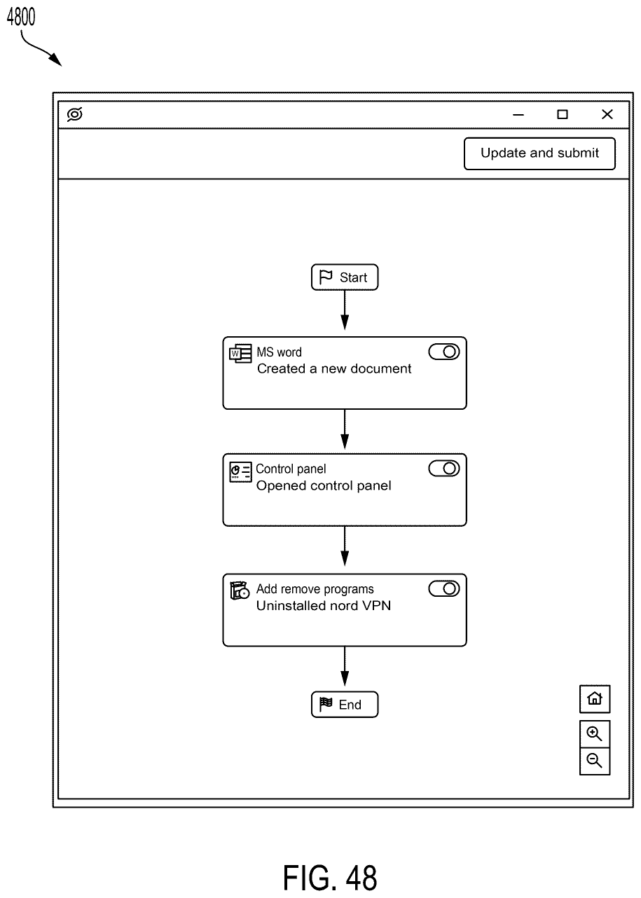

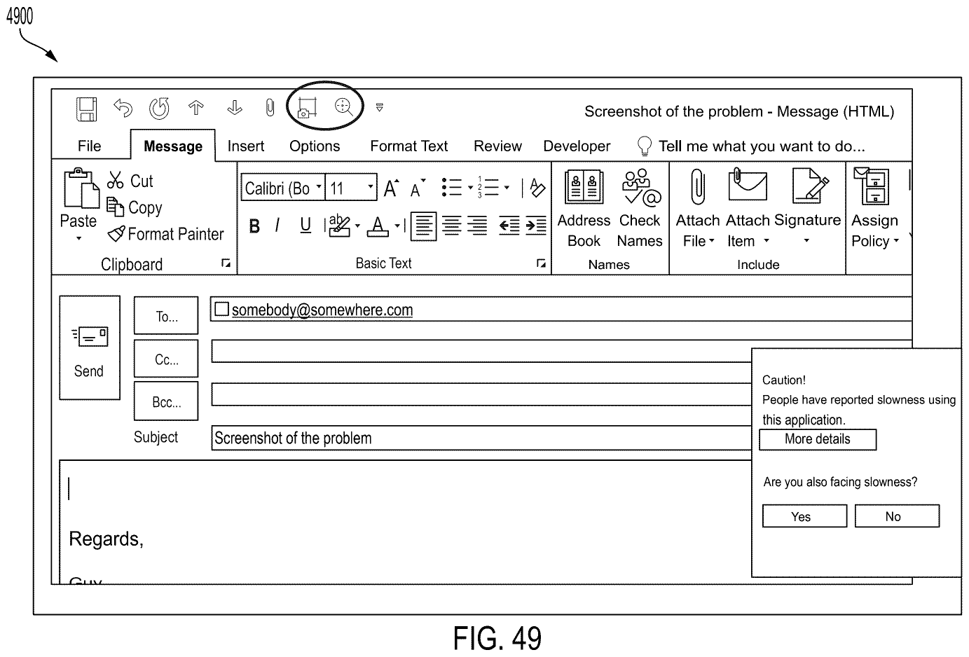

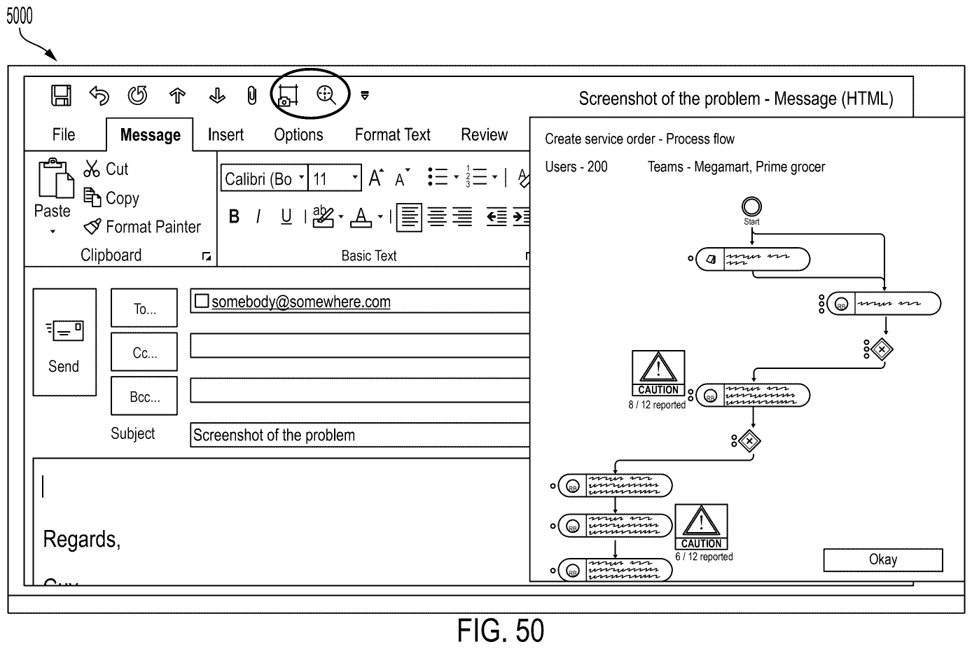

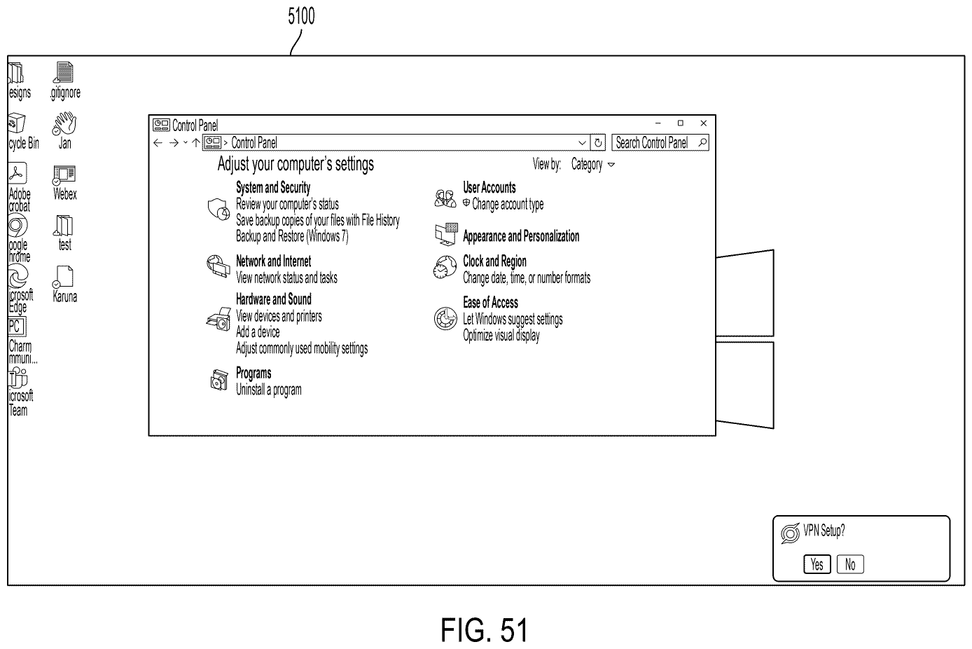

One additional example of applying the techniques described herein relates to assisting a user experiencing technology-related issues. For example, as shown in FIG. 46, a user experiencing a VPN issue may observe an error message 4610 indicating that the VPN connection is down when trying to connect. Other users in the team may have experienced the issue previously. The historical digital interaction data can be searched to identify instances where a user had a similar VPN issue and the steps they performed to resolve the issue. FIG. 47 is a screenshot of GUI 4700 showing another teammate named “Shrey Jain” having experienced the issue and the steps he took to resolve the issue. FIGS. 48-51 are screenshots of additional example GUIs 4800, 4900, 5000, and 5100 showing other ways in which guidance may be presented to the user to help that user navigate the technical issue based on the prior experience of others.

FIG. 52 illustrates an example of providing real-time assistance to a user. The user can explicitly request help while performing a process using an application program, as shown on the left-hand side of FIG. 52. While the user is performing the process, a stream of event data may be collected, the stream of event data corresponding to a series of interactions between the application program executing on the user's machine and the user performing the process using the application program. For example, the series of interactions may include interactions with the “Active Window” shown in FIG. 52. Event data collection may be performed via: (i) application programming interface (API) calls to the application program, (ii) hooks in the operating system to call one or more functions when interactions are detected, and/or (iii) processing images of user interface screens. An object hierarchy may be employed to gather metadata associated with an interaction performed by the user. The object hierarchy may represent the state of the user interface at the time the user performed the interaction. The object hierarchy may comprise a set of one or more objects that correspond to graphical user elements of a user interface. Aspects of generating, accessing, refreshing and otherwise using object hierarchies are described in U.S. Pat. No. 10,474,313, titled “SOFTWARE ROBOTS FOR PROGRAMMATICALLY CONTROLLING COMPUTER PROGRAMS TO PERFORM TASKS,” published on Nov. 12, 2019, and PCT application WO2024/074891, titled “Systems and Methods for Identifying Attributes for Process Discovery,” published Apr. 11, 2024, each of which is incorporated herein by reference in their entirety.

In some embodiments, the stream of event data may correspond to a series of interactions occurring within a fixed window of time (e.g., last 10 seconds, last 30 seconds, last 5 minutes, etc.). A buffer of these series of interactions may be maintained on the user's machine. When a request for help is received, the buffered interactions can be used to search the historical digital interaction data to identify previously performed interactions associated with a user who ran into the same issue. These identified previously performed interactions may then be used to generate guidance for the user performing the process, where the guidance may include suggested acts to be performed to resolve the issue or help the user. The identification of previously performed interactions may be performed by a search service using a first approach that involves use of numeric representations of processes as described in section titled “User guidance using numeric representations of processes” (shown as option 1 in FIG. 52) or a second approach that involves use of generative models (e.g. large language models) that are trained on historical digital interaction data and sequences as described in section titled “User guidance using generative model” (shown as option 2 in FIG. 52).

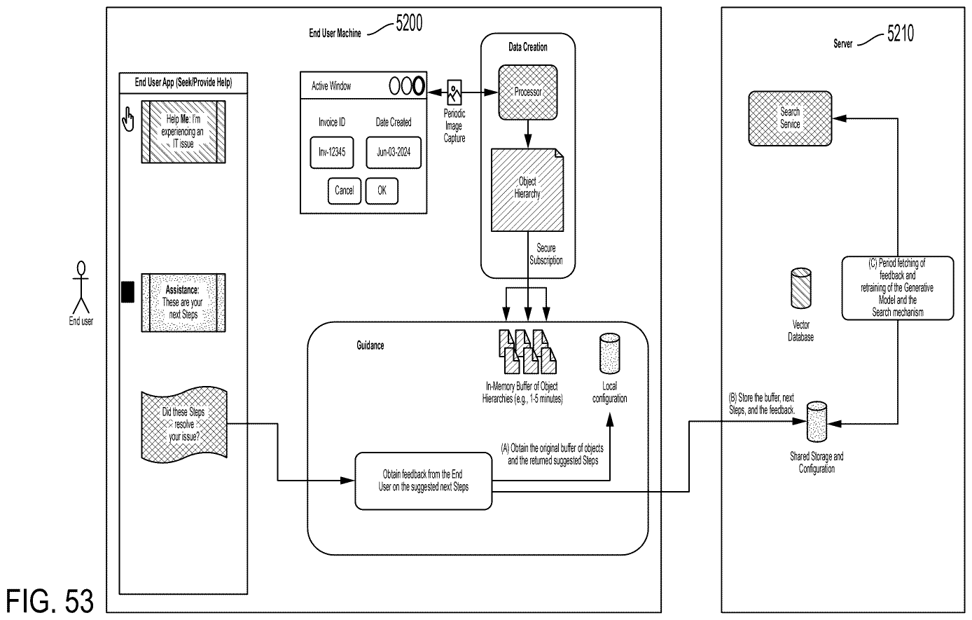

In some embodiments, feedback from the user regarding the guidance generated by a generative model may be used to further train the generative model, as shown in FIG. 53.

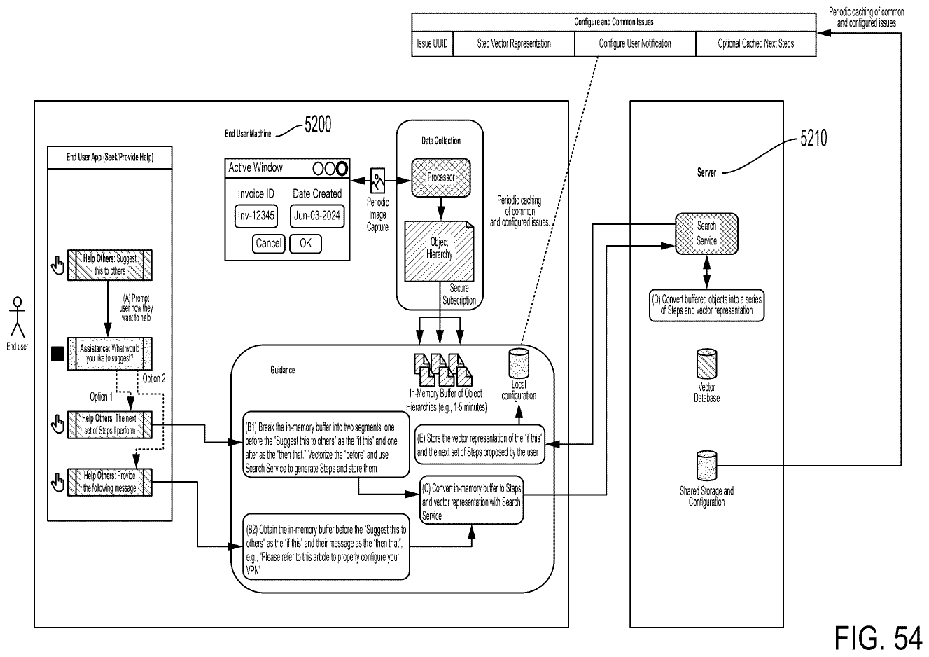

In some embodiments, when a user resolves a particular issue by performing a set of digital interactions or steps, the user may want to collaborate and help other users by configuring the system to store this set of digital interactions and use this stored information to guide users experiencing the same issue by generating a set of next steps to be performed to resolve the issue or an alert that would help them resolve the issue, as shown in FIG. 54.

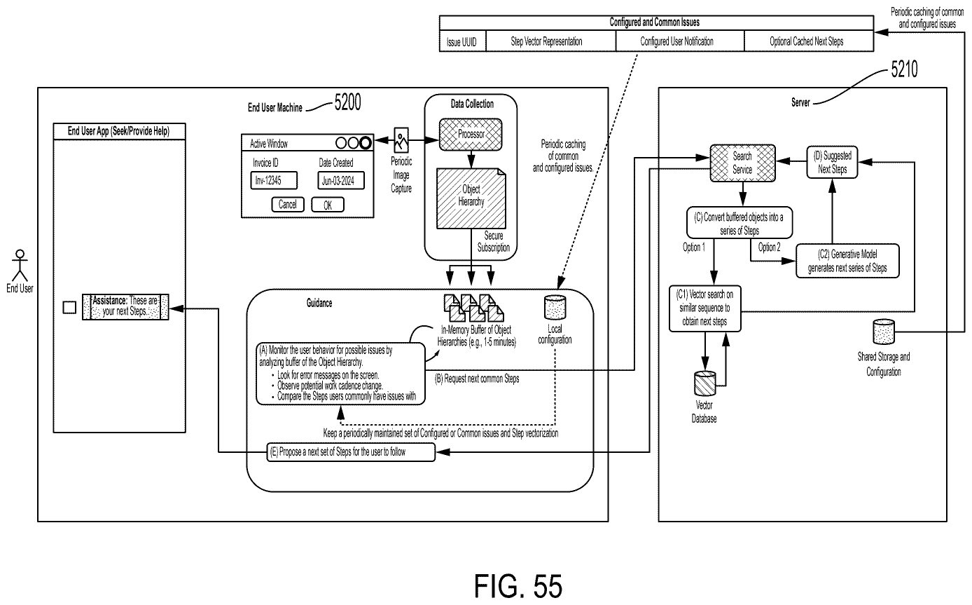

In some embodiments, the resolution can be provided to the user without an explicit configuration, as shown in FIG. 55. In these embodiments, user interactions are monitored for common error messages or common issues that users experience. That can be done by looking for error messages on the screen, observing slowdowns in their work, or comparing the user interactions or steps to other previously performed interactions or steps that users have reported common issues with. When those are detected, guidance may be generated for the user including suggesting next steps or resolutions to the problem. Identification of previously performed interactions may be performed by a search service using a first approach that involves use of numeric representations of processes as described in section titled “User guidance using numeric representations of processes” (option 1 in FIG. 55) or a second approach that involves use of generative models (e.g. large language models) that are trained on historical digital interaction data and sequences as described in section titled “User guidance using generative model” (shown as option 2 in FIG. 55).

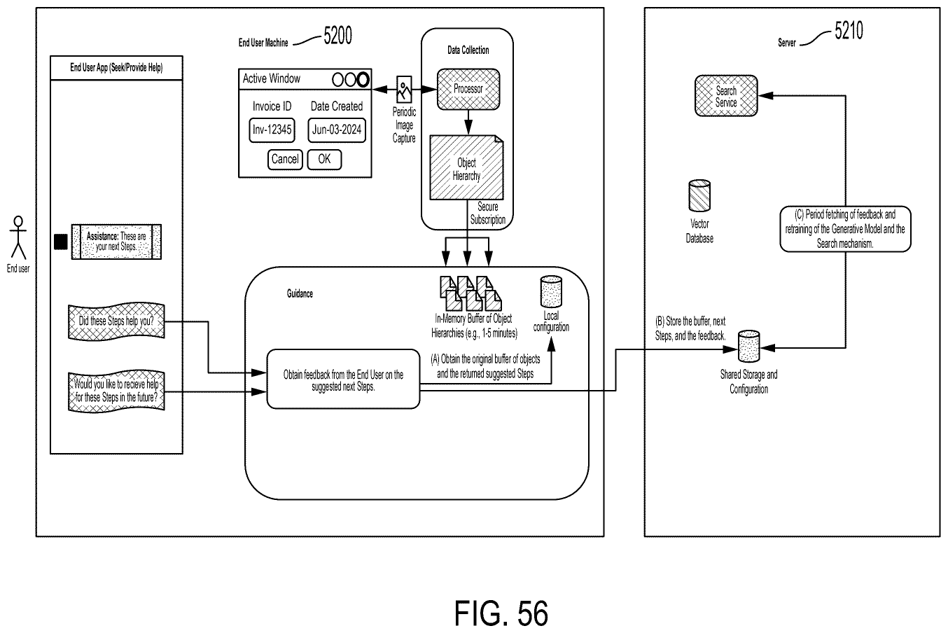

In some embodiments, feedback from the user regarding the guidance generated by a generative model may be used to further train the generative model as shown in FIG. 56.

FIGS. 52-56 show an illustrative architecture for implementing the guidance technology as described herein. In the example shown in these figures, some functionality is performed on an end user's machine 5200, which some functionality is performed remotely from the end user's machine, for example on server 5210. The functionality performed on the end user's machine 5200 may include collecting data about a user's interactions and providing guidance to the user, whereas functionality performed on the server may include searching for processes similar to the process the user is performing based on data collected about a user's interactions and model training.

### Other Implementation Details

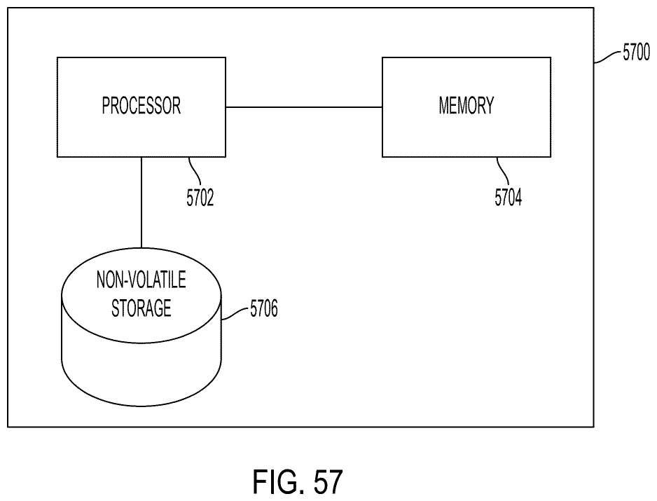

An illustrative implementation of a computer system 5700 that may be used in connection with any of the embodiments of the disclosure provided herein is shown in FIG. 57. For example, any of the computing devices described above may be implemented as computing system 5700. The computer system 5700 may include one or more computer hardware processors 5702 and one or more articles of manufacture that comprise non-transitory computer-readable storage media (e.g., memory 5704 and one or more non-volatile storage devices 5706). The processor 5702(s) may control writing data to and reading data from the memory 5704 and the non-volatile storage device(s) 5706 in any suitable manner. To perform any of the functionality described herein, the processor(s) 5702 may execute one or more processor-executable instructions stored in one or more non-transitory computer-readable storage media (e.g., the memory 5704), which may serve as non-transitory computer-readable storage media storing processor-executable instructions for execution by the processor(s) 5702.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

There is a number of documents incorporated by reference herein. However, to the extent that any aspect of a document incorporated by reference conflicts with the present disclosure, the present disclosure controls.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of using natural language to identify instances of a process in multiple streams of event data, each particular stream of event data, from among the multiple streams, corresponding to a series of interactions between one or more application programs executing on particular computing device and a particular user performing the process using the one or more application programs, the method comprising:
using at least one computer hardware processor to perform:
(A) receiving natural language input describing the process;
(B) generating a process representation at least in part by using a language model to process the natural language input;
(C) identifying, using the process representation and from among the multiple streams of event data, multiple candidate instances of the process;
(D) selecting, based on user input, at least one of the multiple candidate instances; and
(E) storing the selected at least one candidate instance as at least one confirmed instance of the process.

2. The method of claim 1, wherein receiving the natural language input comprises receiving the natural language input from a user via a graphical user interface.

3. The method of claim 1, wherein the natural language input describes the process in part by identifying one or more application programs used to perform the process and one or more activities performed using the one or more applications programs in furtherance of the process.

4. The method of claim 1, wherein the process representation indicates a set of activities and relationships among activities in the set of activities, the relationships indicating an order in which at least some of the activities in the activities are to be performed as part of the process.

5. The method of claim 4, wherein the process representation, further indicates, for each particular activity in the set of activities: an identifier, a natural language description of the activity, and a set of one or more application programs used to perform the activity.

6. The method of claim 5, further comprising:
generating a workflow graph visualization of the process representation, the workflow graph visualization comprising a graph with nodes representing activities in the set of activities and edges representing the relationships among the activities in the set of activities; and
displaying the workflow graph visualization of the process representation in a graphical user interface (GUI).

7. The method of claim 6, wherein the GUI comprises a chatbot interface, the method further comprising:
receiving, via the chatbot interface, further natural language input from the user indicating one or more modifications to make to the process representation;
modifying the process representation in accordance with the further natural language input from the user to obtain an updated process representation;
generating an updated workflow graph visualization of the updated process representation; and
displaying the updated workflow graph visualization in the GUI.

8. The method of claim 4, wherein identifying, using the process representation and from among the multiple streams of event data, the multiple candidate instances of the process, comprises:
generating weighted finite-state automaton (WFSA) from the process representation, the WFSA comprising states, edges between pairs of states, and weights associated with the edges, the states comprising a respective state for each of the activities in the process representation; and
identifying the multiple candidate instances of the process using the WFSA.

9. The method of claim 8,
wherein each particular stream of the multiple streams of event data comprises a respective sequence of interaction steps performed by a respective particular user,
wherein identifying the multiple candidate instances of the process using the WFSA, comprises:
determining step-activity scores, the determining comprising, for each particular sequence of interaction steps among at least some of the sequences of interaction steps in the multiple streams of event data:
determining a step-activity score for each pair of an interaction step from the particular sequence of interaction steps and an activity represented by a state in the WFSA; and
identifying, using dynamic programming, the multiple candidate instances using the step-activity scores and the weights associated with the edges of the WFSA.

10. The method of claim 9,
wherein the at least some sequences of interaction steps comprises a first sequence of interaction steps, the first sequence of interaction steps comprising a first interaction step,
wherein the WFSA comprises a first state associated with a first activity, and
wherein determining the step-activity scores comprises determining a first step-activity score for the first interaction step and the first activity at least in part by:
determining a semantic similarity score for the first interaction step and the first activity;
determining a symbolic score for the first interaction step and the first activity;
determining a cross-encoder similarity score for the first interaction step and the first activity; and
determining the first step-activity score as a weighted combination of the semantic similarity score, the symbolic score, and the cross-encoder similarity score.

11. The method of claim 10, wherein determining the semantic similarity score comprises:
generating a textual description for the first interaction step by:
generating interaction text data by aggregating textual labels and metadata associated with: (i) the first interaction step, and (ii) interaction steps related to the first interaction step; and
providing the interaction text data as input to an LLM to obtain the textual description for the first interaction step;
embedding the textual description for the first interaction step using a trained text embedding model to obtain a first embedded vector;
embedding a textual description of the first activity using the trained text embedding model to obtain a second embedded vector; and
determining the semantic similarity score using the first embedded vector and the second embedded vector.

12. The method of claim 10, wherein determining the symbolic score comprises determining the symbolic score using a measure of similarity between an application associated with the first interaction step and one or more applications associated with the first activity.

13. The method of claim 9, wherein identifying the multiple candidate instances of the process using the WFSA, further comprises:
after identifying, using dynamic programming, the multiple candidate instances using the step-activity scores and the weights associated with the edges of the WFSA,
ranking the multiple candidate instances based on their respective average step-activity scores; and
selecting a number of candidate instances based on their ranking.

14. The method of claim 9, wherein identifying the multiple candidate instances of the process using the WFSA, further comprises:
after identifying, using dynamic programming, the multiple candidate instances using the step-activity scores and the weights associated with the edges of the WFSA,
generating a measure of confidence and textual workflow summary for at least some of the multiple candidate instances.

15. The method of claim 1,
wherein the language model is a large language model (LLM), and
wherein generating the process representation comprises prompting the LLM with the natural language input to obtain an output indicating a sequence of interaction steps, the output indicating for each interaction step in the sequence: a description of an interaction, an application used to perform the interaction, a screen name, an element name, and/or an indication of time spent during the interaction.

16. The method of claim 15,
wherein prompting the LLM with the natural language input comprises:
generating a prompt using the natural language input and a schema specifying format of output to be generated by the LLM; and
providing the prompt as input to the LLM,
wherein the method further comprises training the LLM at least in part by:
accessing a baseline LLM model;
generating training data comprising pairs of natural language input and corresponding outputs, the generating comprising:
selecting, at random, interaction sequences part of the multiple streams of event data;
using the baseline LLM model to generate, as inputs, natural language prompts from the selected interaction sequences; and
using the selected interaction sequences as outputs in the training data corresponding to the natural language prompts; and
fine-tuning the baseline LLM model using the generated training data to obtain the LLM model.

17. The method of claim 1, further comprising generating a visualization of the at least one confirmed instance of the process.

18. The method of claim 1, further comprising:
identifying, using the at least one confirmed instance of the process and from among the multiple streams of event data, multiple further candidate instances of the process.

19. A system, comprising:
at least one computer hardware processor; and
at least one non-transitory computer-readable storage medium storing instructions that, when executed by the at least one computer hardware processor cause the at least one computer hardware processor to perform a method of using natural language to identify instances of a process in multiple streams of event data, each particular stream of event data, from among the multiple streams, corresponding to a series of interactions between one or more application programs executing on particular computing device and a particular user performing the process using the one or more application programs, the method comprising:
(A) receiving natural language input describing the process;
(B) generating a process representation at least in part by using a language model to process the natural language input;
(C) identifying, using the process representation and from among the multiple streams of event data, multiple candidate instances of the process;
(D) selecting, based on user input, at least one of the multiple candidate instances; and
(E) storing the selected at least one candidate instance as at least one confirmed instance of the process.

20. At least one non-transitory computer-readable storage medium storing instructions that, when executed by at least one computer hardware processor cause the at least one computer hardware processor to perform a method of using natural language to identify instances of a process in multiple streams of event data, each particular stream of event data, from among the multiple streams, corresponding to a series of interactions between one or more application programs executing on particular computing device and a particular user performing the process using the one or more application programs, the method comprising:
(A) receiving natural language input describing the process;
(B) generating a process representation at least in part by using a language model to process the natural language input;
(C) identifying, using the process representation and from among the multiple streams of event data, multiple candidate instances of the process;
(D) selecting, based on user input, at least one of the multiple candidate instances; and
(E) storing the selected at least one candidate instance as at least one confirmed instance of the process.
